(19) United States
(12) Patent Application Publication
(10) Pub. No.: US 2026/0307578 A1
(43) Pub. Date: Oct. 8, 2026

(54) RECONFIGURABLE VEHICLE

(71) Applicant: Re:Car Inc., Troy, MI (US)

(72) Inventors: Jamie Standring, Beverly Hills, MI (US); Rodney Romain, II, Clay, MI (US); Stefan Strohbach, Troy, MI (US); David Fifer, Grosse Ile, MI (US); Kevin Richards, Mooresville, NC (US); Aaron Gould, Grosse Pointe Park, MI (US); Chris Nichols, Detroit, MI (US); Scott Anderson, Commerce Twp., MI (US); Luis Soni, Mexico City (MX); Kirill Ponomarenko, Huntington Woods, MI (US); Mark Stubbs, Laguna Beach, CA (US); Gustavo Bizyk, Los Angeles, CA (US); Henri Kavaja, Laguna Niguel, CA (US); Julien Fesquet, Beverly Hills, CA (US); Revathy Dasan Muthiah, Novi, MI (US); Vijay Rathinam, South Lyon, MI (US); Brent Rupert, Essex, OH (US); Loren Trotter, Linden, MI (US); David Johnson, Grosse Pointe Park, MI (US); David McFarland, Shelby Twp., MI (US); Ryan Reed, New Baltimore, MI (US); Vijayaparthiban Alagurathinam, South Lyon, MI (US); Raja Vasamsetty, Farmington Hills, MI (US); Nathan Werner, Farmington Hills, MI (US)

(21) Appl. No.: 19/642,294

(22) Filed: Apr. 8, 2026

Related U.S. Application Data
(60) Provisional application No. 63/785,542, filed on Apr. 8, 2025.
(60) Provisional application No. 63/788,545, filed on Apr. 14, 2025.
(60) Provisional application No. 63/792,518, filed on Apr. 22, 2025.

(51) Int. Cl. B60P 3/42; B60K 1/02; B60K 1/04; B60N 2/005; B60R 21/13; B62D 21/02; B62D 25/04; B62D 25/20; B62D 27/06; B62D 33/023; B62D 65/02; B62D 65/14

(52) U.S. Cl. CPC B60P 3/42; B60K 1/02; B60K 1/04; B60N 2/005; B60R 21/13; B62D 21/02; B62D 25/04; B62D 25/2009; B62D 27/065; B62D 33/023; B62D 65/024; B62D 65/14

(57) ABSTRACT

A vehicle reconfigurable between a pickup truck configuration and a sport utility vehicle (SUV) configuration, the vehicle includes a vehicle frame including a plurality of preexisting frame fastening devices installed during original manufacture of the vehicle; one or more batteries supported by or coupled to the vehicle frame and configured to provide power to one or more motors; and a rear enclosure assembly configured to attach directly to the plurality of preexisting frame fastening devices to reconfigure the vehicle from the pickup truck configuration to the SUV configuration without permanently modifying the vehicle frame, the rear enclosure assembly including a roll bar assembly comprising a hoop structure including a pair of spaced-apart pillars and an upper cross bar connecting upper regions of the pillars; and one or more rear passenger seats configured for attachment to the roll bar assembly.

### CROSS-REFERENCE TO RELATED APPLICATIONS

This application claims priority to U.S. 63/785,542 filed on Apr. 8, 2025, U.S. 63/788,545 filed on Apr. 14, 2025, and U.S. 63/792,518 filed on Apr. 22, 2025, the entireties of which are all hereby incorporated by reference herein for all purposes.

### FIELD

These teachings relate generally to vehicles, and more particularly to a vehicle architecture that allows a vehicle to be reconfigured between different vehicle configurations.

### BACKGROUND

Conventional vehicle architectures generally lack structures configured to facilitate reliable reconfiguration of a vehicle body between different vehicle configurations.

Some vehicle enthusiasts have attempted to convert or reconfigure a pickup truck into an SUV, or vice versa. However, such conversions are typically highly customized and both cost-and labor-intensive. For example, such conversions are generally only feasible for individuals with access to, and knowledge of, specialized fabrication tools, such as grinders, cutters, welders, and other metal-fabrication equipment. Moreover, such vehicle conversions are typically permanent due to the destructive nature of cutting, grinding, or welding vehicle structures, which may prevent the vehicle from being reconfigured or returned to its original configuration.

In some cases, such vehicle conversions may not adequately account for structural integrity and passenger safety considerations, such as vehicle structural strength and occupant restraint systems (e.g., including a seat belt and retractor).

Accordingly, there remains a need for a vehicle that can be quickly, easily, and reliably reconfigured between a first vehicle configuration and a second vehicle configuration, preferably without destructive modification of the vehicle structure, while maintaining structural integrity and passenger safety.

### SUMMARY

In accordance with various aspects of the present teachings, a vehicle is provided that is reconfigurable between different vehicle configurations. In some embodiments, the vehicle may be reconfigured between a pickup truck configuration and a sport utility vehicle (SUV) configuration.

In some embodiments, the vehicle can be reconfigured by removing one or more vehicle structures from the frame and/or by attaching one or more vehicle structures to the frame.

The vehicle and/or vehicle frame architecture comprises one or more preexisting frame fastening devices that enable reliable, safe, and efficient removal and attachment of one or more vehicle structures.

For example, a rear enclosure assembly can be removed from the vehicle or vehicle frame via the one or more preexisting frame fastening devices to reconfigure the vehicle. For example, a rear enclosure assembly can be attached to the vehicle or vehicle frame using one or more preexisting frame fastening devices to reconfigure the vehicle.

The vehicle architecture disclosed herein advantageously enables the vehicle to be converted between these configurations in a reliable, safe, and efficient manner, preferably without destructive modification of the vehicle or vehicle structure. Such a configuration may allow a vehicle operator to selectively adapt the vehicle to different functional uses while maintaining structural integrity and safety features.

The frame or frame assembly may include a forward subassembly, a rearward subassembly, and an intermediate subassembly between the forward subassembly and the rearward subassembly. The vehicle frame assembly or architecture may be configured to support both a pickup truck configuration and a sport utility (SUV) configuration and allow reconfiguration between both.

The intermediate subassembly may be adapted for supporting one or more batteries to supply power to one or more motors (e.g., motors may be adapted to propel the vehicle). The support for the batteries may also or instead supported by, on or with at least one of the forward subassembly and/or the rearward subassembly.

The forward subassembly may include at least two spaced apart frame rails (e.g., preferably longitudinally oriented towards the front of the vehicle). The forward subassembly may optionally include at least one collapsible cradle assembly configured to be detachably coupled with the frame rails during a frontal impact. The frame may also include a front region that is located proximate (e.g., over) a pair of front wheels of the vehicle.

The rearward subassembly may include at least two spaced apart frame rails preferably longitudinally oriented toward the rear of the vehicle. The at least two spaced frame rails may include an open and hollow rear end and may define the rear region of the vehicle body. The rear subassembly may also include a rear region that is located proximate (e.g., over) a pair of rear wheels of the vehicle. The rear region may include a pair of opposing bed walls and a rear floor. The frame may include one or more preexisting frame fastening devices (e.g., one or more threaded fastening elements installed during original equipment manufacture of the vehicle, vehicle frame, etc.).

The vehicle may include a rear enclosure assembly. The rear enclosure assembly may be configured to attach to the frame via one or more preexisting frame fastening devices on the frame to reconfigure the vehicle from the pickup truck configuration to the SUV configuration. The rear enclosure assembly may include a roll bar assembly having a hoop structure with spaced pillars connected by an upper cross bar connected to upper regions of the hoop structure. The hoop structure may be configured for secure attachment to the frame via one or more preexisting frame fastening devices. The hoop structure may be configured for secure attachment to the opposing bed walls and/or the rear floor of the frame.

One or more rear passenger seats may be configured for secure attachment to the roll bar assembly, hoop structure, and/or frame.

These teachings provide a method of reconfiguring a vehicle between a first vehicle configuration and a second vehicle configuration. The method may include one or more steps. The one or more steps may include removing one or more vehicle structures from the vehicle; and attaching one or more features to the frame via one or more frame fasteners. The one or more features may include a rear enclosure assembly, a roll bar assembly comprising a hoop structure having a pair of spaced apart pillars, an upper cross bar connected to upper regions of the pillars, and optionally a lower cross bar connected to lower regions of the pillars; and one or more rear passenger seats configured for attachment to the roll bar assembly and/or vehicle frame.

The vehicle disclosed herein may be a vehicle for transporting passengers. The vehicle may be a vehicle for transporting cargo. The vehicle may be a passenger and cargo vehicle for transporting both passengers and cargo. In some configurations, the vehicle and/or the teachings herein may be applied to vehicles such as a motor home, train, airplane, boat, golf cart, all-terrain vehicle (ATV), personal mobility vehicle, and/or off-road vehicle.

A vehicle reconfigurable between a pickup truck configuration and a sport utility vehicle (SUV) configuration is disclosed. The vehicle comprises a vehicle frame configured to support both the pickup truck configuration and the SUV configuration and to allow reconfiguration therebetween, the vehicle frame including: at least two spaced-apart frame rails extending longitudinally toward a rear of the vehicle; a rear region proximate a pair of rear wheels, the rear region including opposing bed walls and a rear floor; and a plurality of preexisting frame fastening devices installed during original manufacture of the vehicle; one or more batteries supported by or coupled to the vehicle frame and configured to provide power to one or more motors; and a rear enclosure assembly configured to attach directly to the plurality of preexisting frame fastening devices to reconfigure the vehicle from the pickup truck configuration to the SUV configuration without permanently modifying the vehicle frame, the rear enclosure assembly comprising: a roll bar assembly comprising a hoop structure including a pair of spaced-apart pillars and an upper cross bar connecting upper regions of the pillars; and one or more rear passenger seats configured for attachment to the roll bar assembly.

The plurality of preexisting frame fastening devices comprise threaded fasteners, weld nuts, threaded bores, or combinations thereof installed prior to reconfiguration of the vehicle. The rear enclosure assembly is attachable to the vehicle frame without welding, bonding, cutting, drilling, or grinding the vehicle frame. The rear enclosure assembly is removable from the vehicle frame to return the vehicle to the pickup truck configuration using the plurality of preexisting frame fastening devices.

Each of the pillars includes: a first attachment interface coupled to at least one of the plurality of preexisting frame fastening devices at or near a top surface of the bed walls; and a second attachment interface coupled to at least one of the plurality of preexisting frame fastening devices at the rear floor.

A method of reconfiguring a vehicle from the pickup truck configuration to the sport utility vehicle configuration is disclosed. The method includes removing one or more components associated with the pickup truck configuration to expose at least a portion of the vehicle frame; positioning the roll bar assembly relative to the vehicle frame; attaching the roll bar assembly to at least one of the plurality of preexisting frame fastening devices without permanently modifying the vehicle frame; installing the one or more rear passenger seats in structural association with the roll bar assembly; attaching the rear enclosure assembly to at least one of the roll bar assembly and the vehicle frame using the plurality of preexisting frame fastening devices; and enclosing a rear passenger area of the vehicle with one or more panels of the rear enclosure assembly, the roll bar assembly and the one or more rear passenger seats are installed such that seat loads are transferred from the one or more rear passenger seats to the vehicle frame via the plurality of preexisting frame fastening devices, lower cross bar, seat brackets, or a combination thereof. The attaching the roll bar assembly comprises engaging threaded fasteners with factory-installed threaded apertures of the vehicle frame (e.g., preexisting fastening devise).

### BRIEF DESCRIPTION OF THE DRAWINGS

FIG. 1A is a front perspective view of a vehicle configured or reconfigured in a pickup truck configuration.

FIG. 1B is a rear perspective view of a vehicle configured or reconfigured in a pickup truck configuration.

FIG. 2 is a front perspective view of a frame of the vehicle.

FIG. 3 is a front perspective view of a vehicle configured or reconfigured in a sport utility vehicle (SUV) configuration.

FIG. 4 is a flow diagram of a method according to these teachings.

FIG. 5A illustrates a step of the method according to these teachings.

FIG. 5B illustrates a step of the method according to these teachings.

FIG. 6A illustrates a step of the method according to these teachings.

FIG. 6B illustrates a step of the method according to these teachings.

FIG. 7A illustrates a step of the method according to these teachings.

FIG. 7B illustrates a step of the method according to these teachings.

FIG. 8 illustrates a step of the method according to these teachings.

FIG. 9 illustrates a step of the method according to these teachings.

FIG. 10 illustrates a step of the method according to these teachings.

FIG. 11 illustrates a step of the method according to these teachings.

FIG. 12 illustrates a step of the method according to these teachings.

FIG. 13 illustrates a step of the method according to these teachings.

FIG. 14 illustrates a step of the method according to these teachings.

FIG. 15 illustrates a step of the method according to these teachings.

FIG. 16A illustrates a step of the method according to these teachings.

FIG. 16B illustrates in exemplary floor panel.

FIG. 17A illustrates a step of the method according to these teachings.

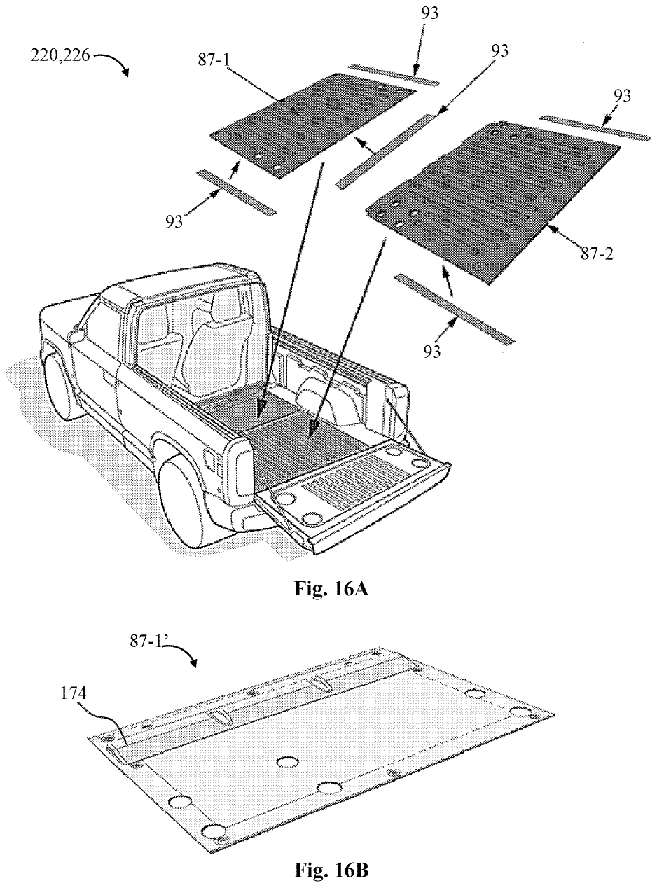

FIG. 16B illustrates a hoop structure of the roll bar assembly.

FIG. 18A is a perspective view of a rear passenger seat, pillar, lower cross bar, and second flange or bracket.

FIG. 18B is a perspective view of a pillar, lower cross bar, and second flange or bracket.

FIG. 19A illustrates a step of the method according to these teachings.

FIG. 19B illustrates a hoop structure of the roll bar assembly.

FIG. 19C illustrates attachment of a pillar.

FIG. 20A illustrates a step of the method according to these teachings.

FIG. 20B illustrates attachment of the lower cross bar and pillar.

FIG. 21A illustrates a step of the method according to these teachings.

FIG. 21B illustrates a longitudinally rail of the roll bar assembly.

FIG. 22A illustrates a step of the method according to these teachings.

FIG. 22B illustrates an interior panel.

FIG. 23A illustrates a step of the method according to these teachings.

FIG. 23B illustrates a step of the method according to these teachings.

FIG. 23C illustrates the rear seats.

FIG. 23D illustrates the rear seats.

FIG. 24 illustrates a step of the method according to these teachings.

FIG. 25A illustrates a step of the method according to these teachings.

FIG. 25B illustrates a step of the method according to these teachings.

FIG. 25C illustrates a step of the method according to these teachings.

FIG. 26 illustrates a step of the method according to these teachings.

FIG. 27 illustrates a rear window assembly.

FIG. 28A illustrates a step of the method according to these teachings.

FIG. 28B illustrates components of a rear window assembly.

FIG. 29A illustrates a step of the method according to these teachings.

FIG. 29B illustrates a center console.

FIG. 29C illustrates a center console.

FIG. 30 illustrates the vehicle in an open air configuration.

FIG. 31 illustrates a vehicle chassis and/or one or more batteries, the front end unit and the rear end unit of the vehicle.

FIG. 32A illustrates the rear end unit.

FIG. 32B illustrates the rear end unit.

FIG. 33 illustrates an article carrier attached to the vehicle.

FIG. 34 illustrates an article carrier attached to the vehicle.

FIG. 35 illustrates part of an article carrier attached to the vehicle.

FIG. 36 illustrates part of an article carrier attached to the vehicle.

FIG. 37 illustrates part of an article carrier attached to the vehicle.

FIG. 38 illustrates an article carrier attached to the vehicle.

FIG. 39 illustrates an article carrier attached to the frame of the vehicle.

FIG. 40 illustrates an article carrier attached to the frame of the vehicle.

FIG. 41 illustrates a front region of the frame of the vehicle.

FIGS. 42A and 42B illustrate a wrap edge receiving channel on one or more panels of the vehicle.

FIGS. 43A-43C illustrate a wrap sheet on a panel of the vehicle.

FIG. 44 illustrates the frame or frame assembly of the vehicle.

FIG. 45 illustrates the frame or frame assembly of the vehicle.

FIG. 46 illustrates the frame or frame assembly of the vehicle.

FIG. 47 is bottom perspective view of a frame of the vehicle.

FIG. 48 is a perspective view of the one or more batteries and motor.

### DETAILED DESCRIPTION

The description herein pertains to vehicles. Preferably it pertains to a vehicle that can be reconfigured from a first vehicle configuration to a second vehicle configuration. The vehicle can be reconfigured back to the first vehicle configuration. In other words, the vehicle has a reversible configurable structure or architecture.

The vehicle may be a passenger vehicle for transporting passengers. The vehicle may be a cargo vehicle for transporting cargo. The vehicle may be a passenger and cargo vehicle for transporting both passengers and cargo. In some configurations the teachings herein may be applied to other vehicles such as a motor home, train, airplane, boat, golf cart, all-terrain vehicle (ATV), personal mobility vehicle, and/or off-road vehicle.

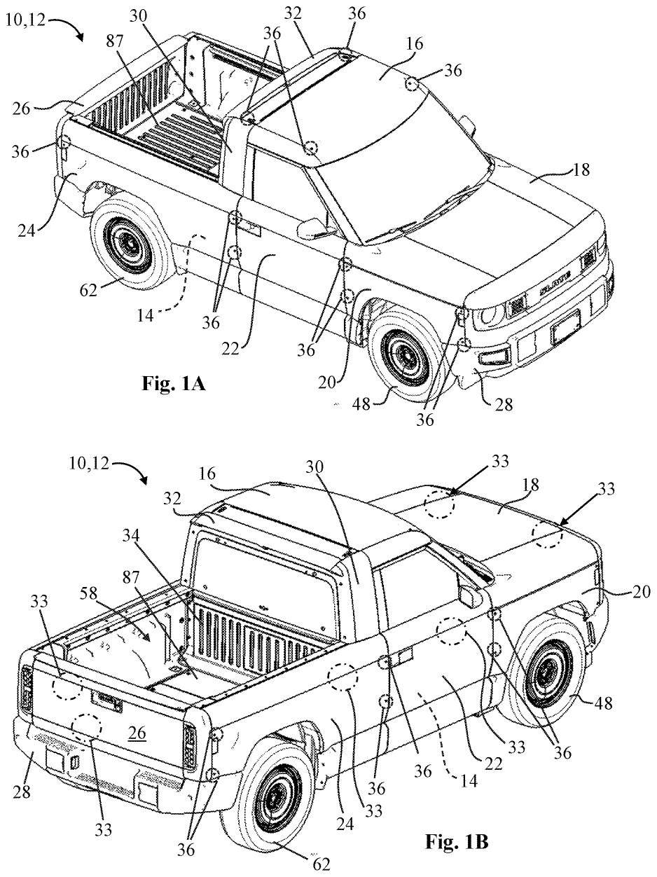

FIGS. 1A and 1B illustrate a vehicle 10 in a pickup truck configuration 12.

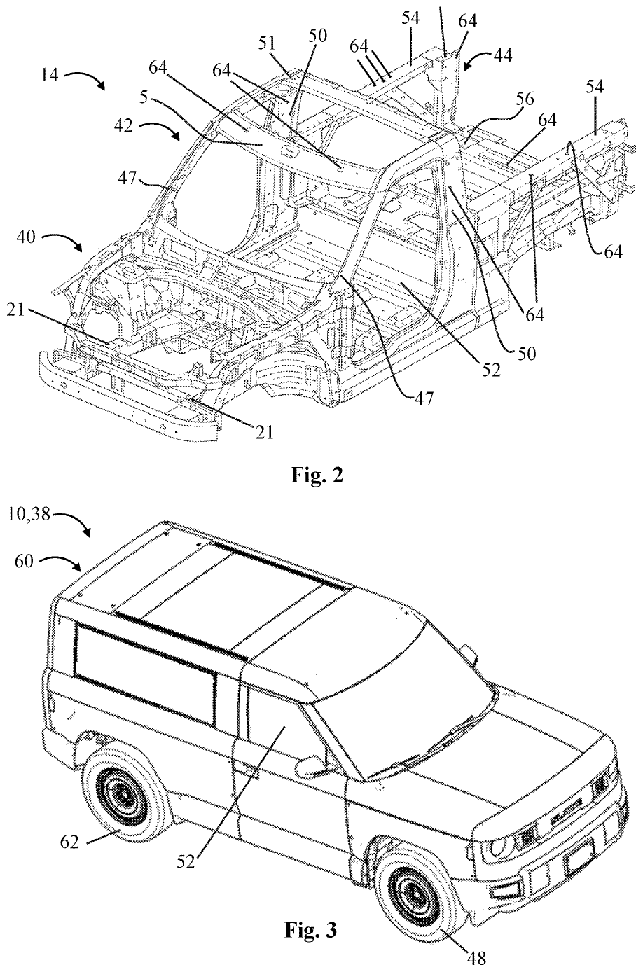

The vehicle 10 comprises an underlying vehicle frame 14 (See also FIGS. 2, 22-27).

One or a plurality of vehicle body panels or structural elements may be attached or supported on or by the vehicle frame 14. An exemplary list of vehicle body panels and/or structural elements may include: one or more roof panels 16, a front hood panel 18, a pair of front fenders 20, a pair of door panels 22, a pair of rear fenders 24, a tailgate 26, front and rear bumper covers 28, B-pillar panels or appliques 30, a vehicle cab spoiler 32, a rear cab bulkhead panel 34, rear glass assembly, rear halo and backlight assembly, one or more bed floor panels 87, etc. One or more of the body panels may include one or more wrap edge receiving channels 33 (See also FIGS. 42A-43C). One or more structural elements such as a rear enclosure assembly, tire carrier, utility rack, or a combination thereof may be attached or supported on or by the vehicle frame 14.

One or more vehicle body panels may include one or more body panel fasteners 36. A body panel fastener 36 may be configured to engage, cooperate with, and/or co-act with one or more preexisting frame fastening devices on the frame 14 to attach, connect, or secure one or more vehicle body panels to the frame 14. In some configurations, a body panel fastener 36 may also or may instead engage or connect to another vehicle body panel. In such a configuration, the body panel fastener 36 may directly or indirectly engage the vehicle frame for attaching, securing, or connecting one or more vehicle body panels to the frame or vehicle.

A body panel fastener 36 may include one or more mechanical fastening devices configured to secure one or more vehicle body panels or other structural elements to a vehicle frame, support structure 14, or preexisting frame fastening device. For example, the body panel fastener 36 may be a screw, bolt, M6 bolt, M8 bolt, M10 bolt, threaded fastener, stud, nut, push-pin, rivet (e.g., blind rivet), clip, retainer, doghouse-type fastener, snap-fit feature, barb, detent, spring clip, quarter-turn fastener, panel fastener, Christmas-tree fastener, or combinations thereof. In some configurations, the body panel fastener 36 may also include reusable or non-reusable fastening elements and may be configured to provide a semi-permanent or removable attachment between the body panel and the vehicle frame, which may enable serviceability or replacement of one or more vehicle body panels.

Some body panel fasteners 36 may be positioned such that they are accessible from an exterior surface of the vehicle, from an interior region of the vehicle, or are concealed from both. In some configurations, one or more body panel fasteners 36 may be located on a B-side of a vehicle panel and coupled to the frame, and may only be accessed after removal of one or more overlying vehicle panels or structures. In other configurations, body panel fasteners 36 may be covered or concealed by a cap, cover, trim element, or other structure that is removable to permit access.

In some embodiments, one or more body panel fasteners 36 are configured to be accessible to facilitate installation, removal, or servicing of a vehicle body panel. For example, fasteners 36 may be accessible from an exterior A-surface to allow engagement with a tool, or from an interior region of the vehicle. In configurations including a cap, cover, or trim element, such components may provide a finished appearance while remaining removable to enable access to the underlying fastener 36.

In some configurations, one or more body panel fasteners 36 may be exposed or otherwise accessible from the interior and/or exterior of the vehicle to facilitate removal and attachment of vehicle body panels to the frame 14. This accessibility may enable rapid replacement of damaged panels (e.g., following an accident) and interchangeability with alternative panels for customization, including flared fenders, different bumper covers, or other stylistically or functionally distinct components.

In the event that a vehicle body panel becomes damaged, worn, or otherwise unsuitable for continued use, a vehicle body panel may be removed from the vehicle frame and replaced with a new or replacement body panel. In some instances, a user may wish to replace an existing body panel with a different body panel for aesthetic, functional, or customization purposes. In such cases, a body panel may be detached from the frame or vehicle by disengaging one or more body panel fasteners 36, and a replacement body panel may be attached to the frame or vehicle using the same or additional body panel fasteners 36. This arrangement allows vehicle body panels to be selectively removed, replaced, repaired, or upgraded without destructive modification to the vehicle structure and without the need for destructive or customizing processing to do so.

One or more of the vehicle body panels may be removed or separated from the vehicle or frame 14 during the conversion of the vehicle 10 from the pickup truck configuration 12 to a sport utility vehicle (SUV) configuration 38 (FIG. 3). One or more of the vehicle body panels may be removed or separated from the vehicle or frame 14 during the conversion of the vehicle 10 from the sport utility vehicle (SUV) configuration 38 to the pickup truck configuration 12.

One or more of the body panel fasteners 36 may also or may instead be used to attach or secure one or more accessories to the vehicle 10, such a cargo carrier or ladder rack to the top or roof of the vehicle.

Referring now to FIG. 2, the frame 14 may comprise the skeletal, architectural, or structural shell of the vehicle. The frame 14 may generally comprise a front region 40 or forward subassembly, a middle region 42 or intermediate sub assembly, and a rear region 44 or rearward sub assembly.

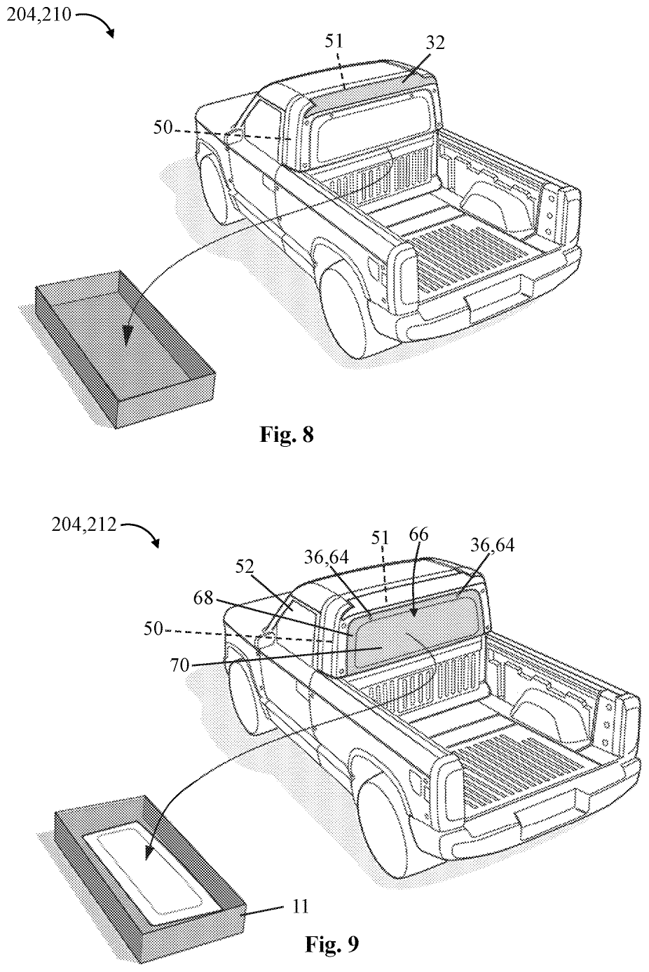

The front region or forward sub assembly 40 of the frame 14 may comprise the structural or architectural elements of the frame 14 that are located at, near, and/or forward of the A-pillar 47 of the frame 14. When the vehicle 10 is in the pickup truck configuration 12 (FIGS. 1A, 1B) and/or the SUV configuration 38 (FIGS. 3, 8), the front region 40 of the frame 14 may be located generally over and/or in a region of the front wheels 48 of the vehicle 10.

The front region or forward subassembly 40 may comprise two spaced apart frame rails 21, that are, preferably, longitudinally oriented toward the front of the vehicle, and optionally being configured to be detachably coupled with at least one collapsible cradle assembly, and also including a front region that is located proximate, and preferably over, a pair of front wheels 48 of the vehicle 10. A frunk may be located at or in the front region of the frame or vehicle.

The middle region 42 of the frame 14 may comprise the structural or architectural elements of the frame 14 that are located at, near, and/or between the A-pillar 47 and the B-pillar 50 of the frame 14. An upper cross member or rail 51 may extend between the opposing B-pillars 50. When the vehicle 10 is in the pickup truck configuration 12 and/or the SUV configuration 38, the middle region 42 of the frame 14 may be in a region where of the vehicle cockpit 52 is located, for example, where the front driver and passenger seats and dashboard are located.

The middle region 42 or intermediate subassembly may include a support for the one or more batteries to supply power to one or more motors, the intermediate subassembly being supported by, on or with at least one of the forward subassembly and/or the rearward subassembly, the motors being adapted to propel the vehicle.

The rear region 44 of the frame 14 may comprise the structural or architectural elements of the frame 14 that are located at, near and/or rearward of the B-pillar 50 of the frame 14 and may comprise opposing bed walls or bed rails 54 and the rear floor 56. When the vehicle 10 is in the pickup truck configuration 12, the rear floor 56 is generally located in a region where the bed or cargo area 58 of the pickup truck configuration 12 is located, that may be used for storing and/or transporting cargo.

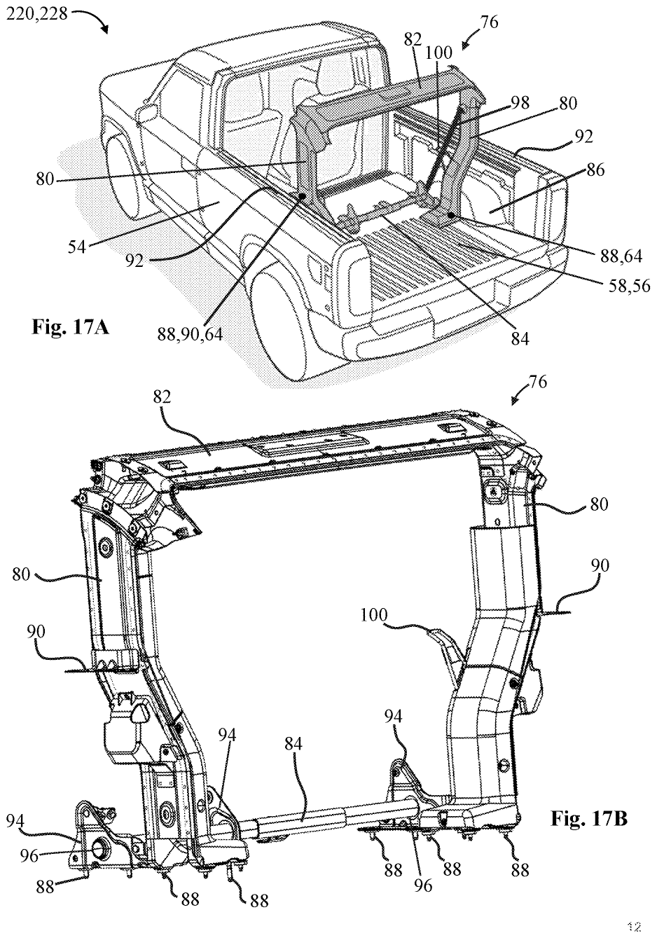

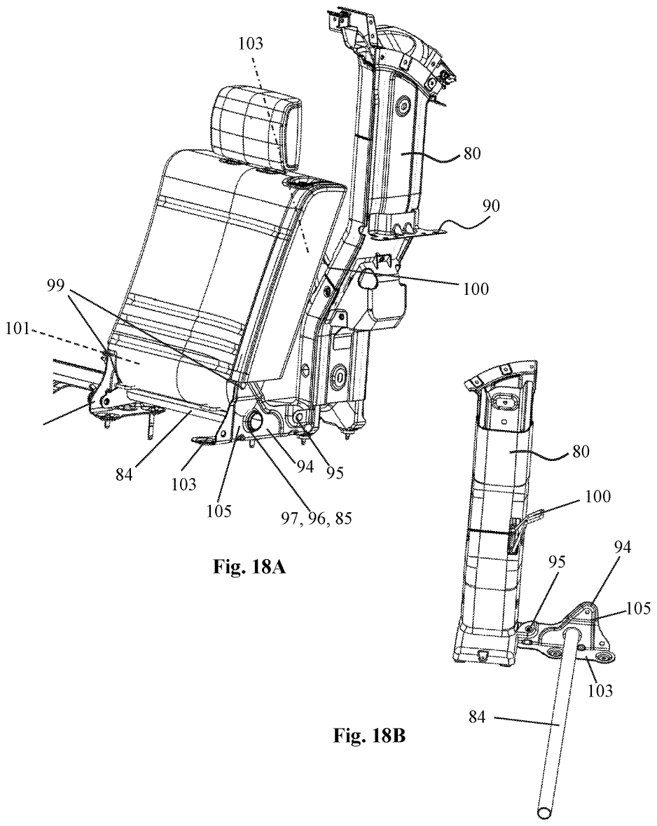

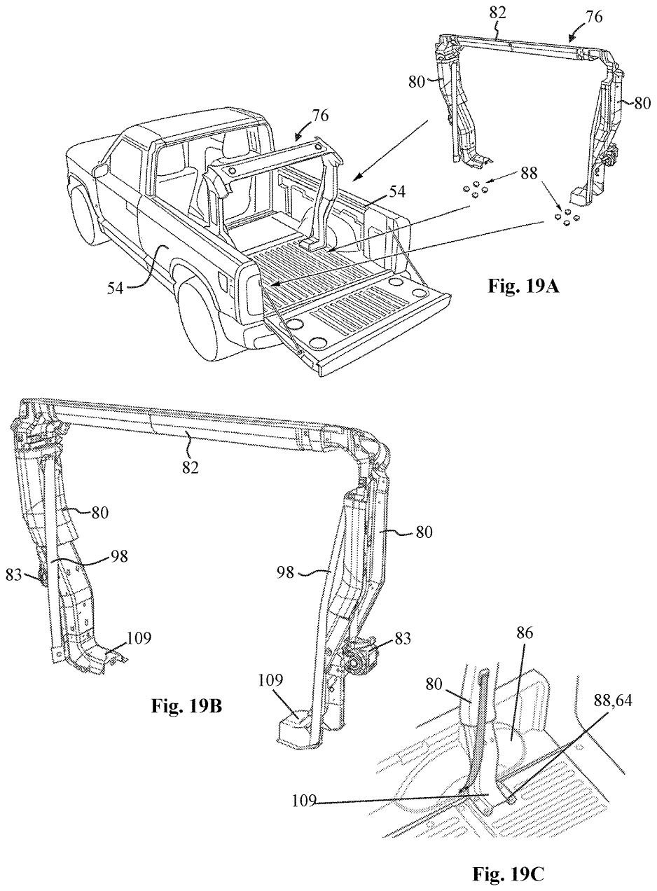

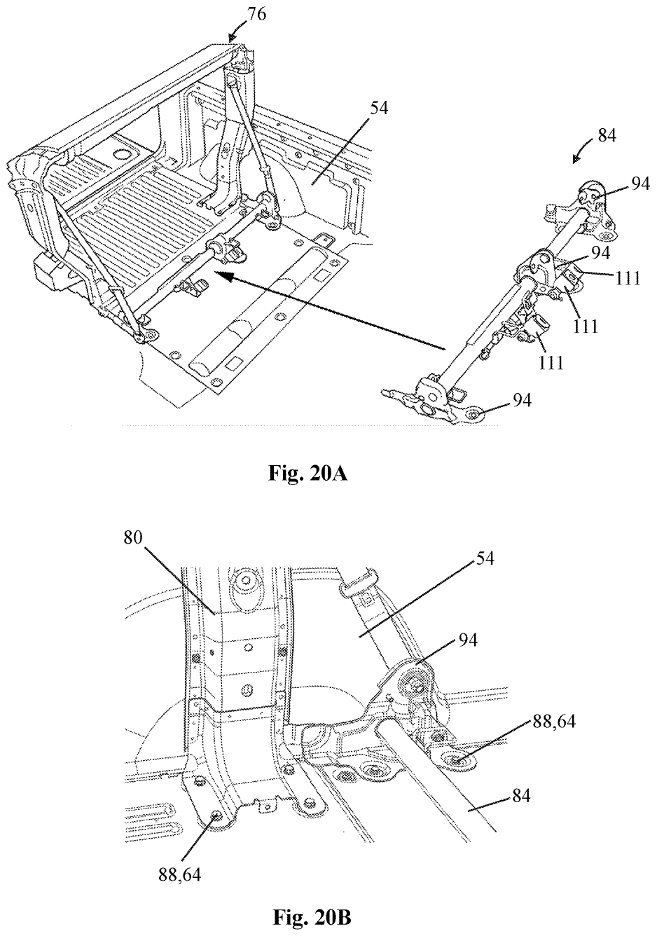

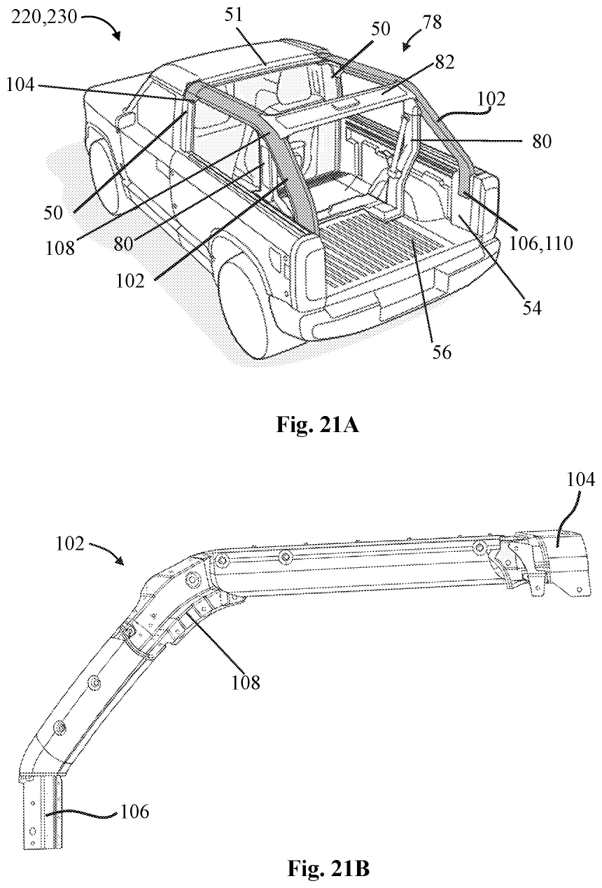

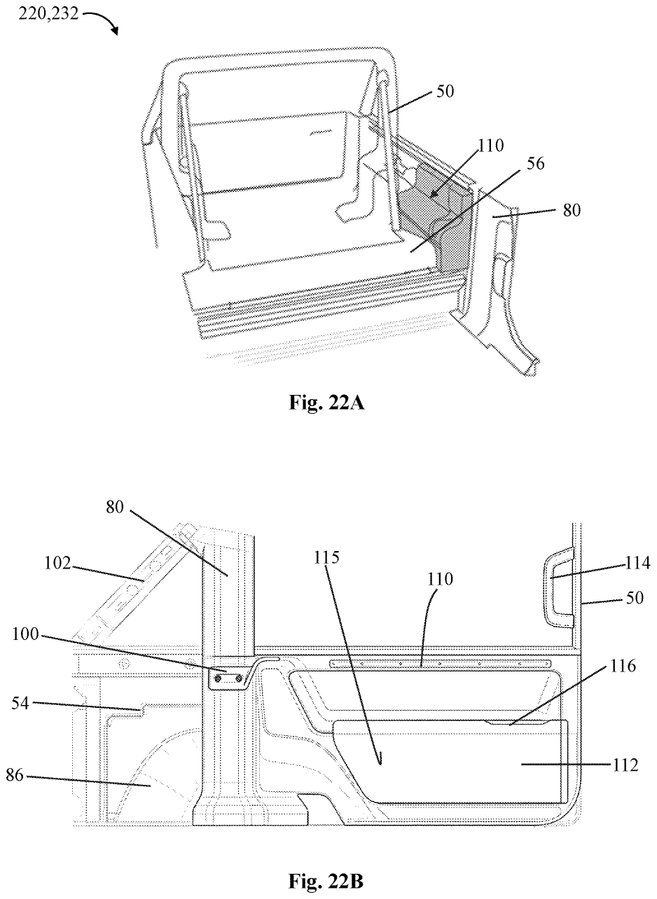

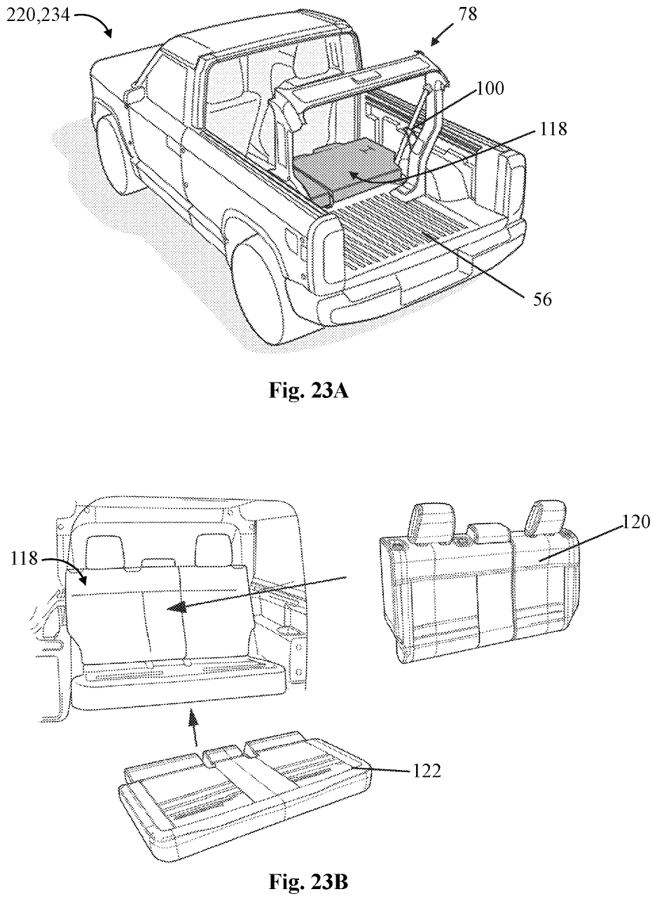

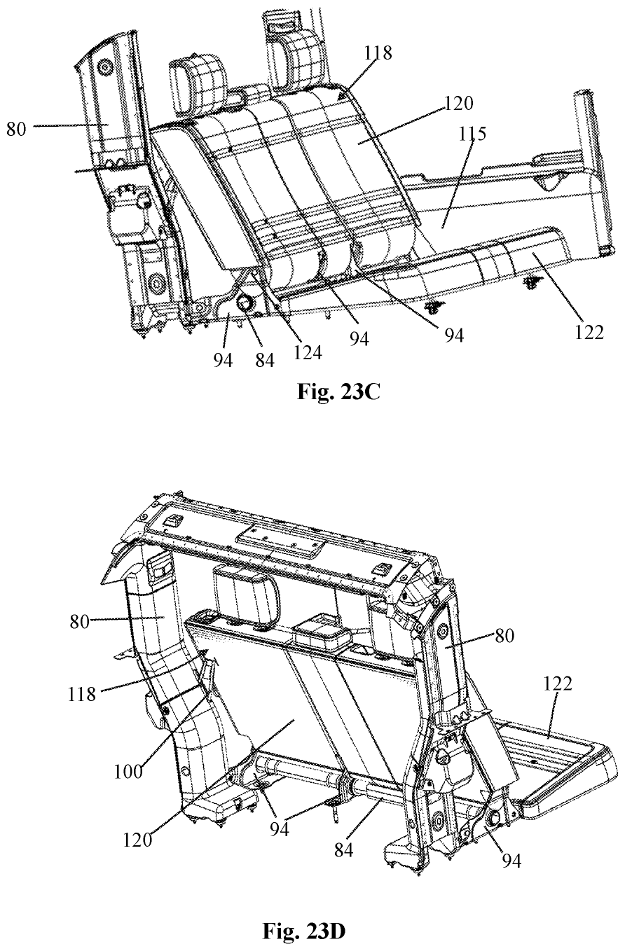

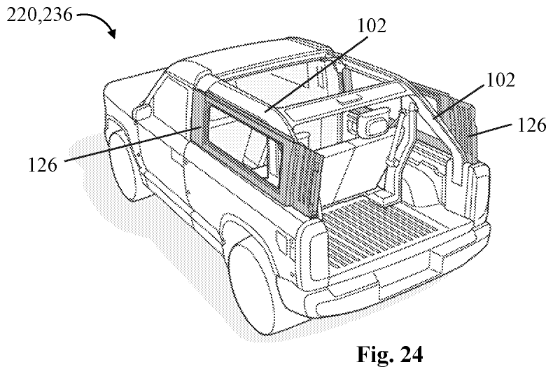

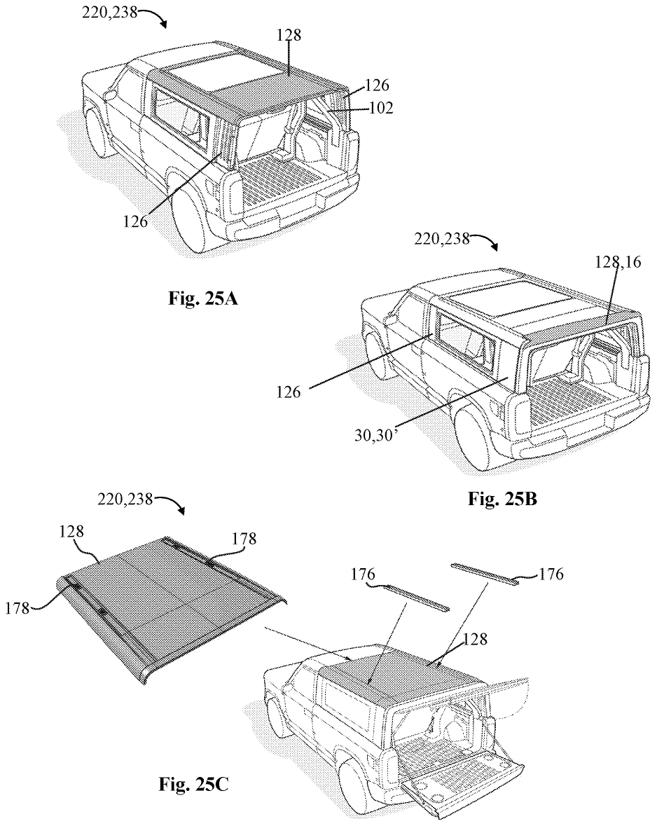

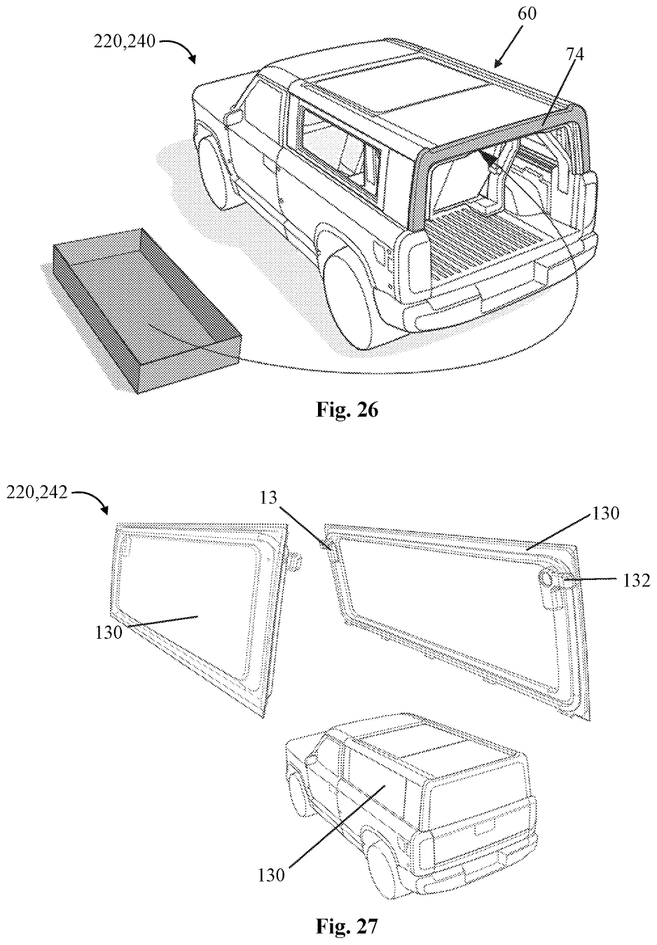

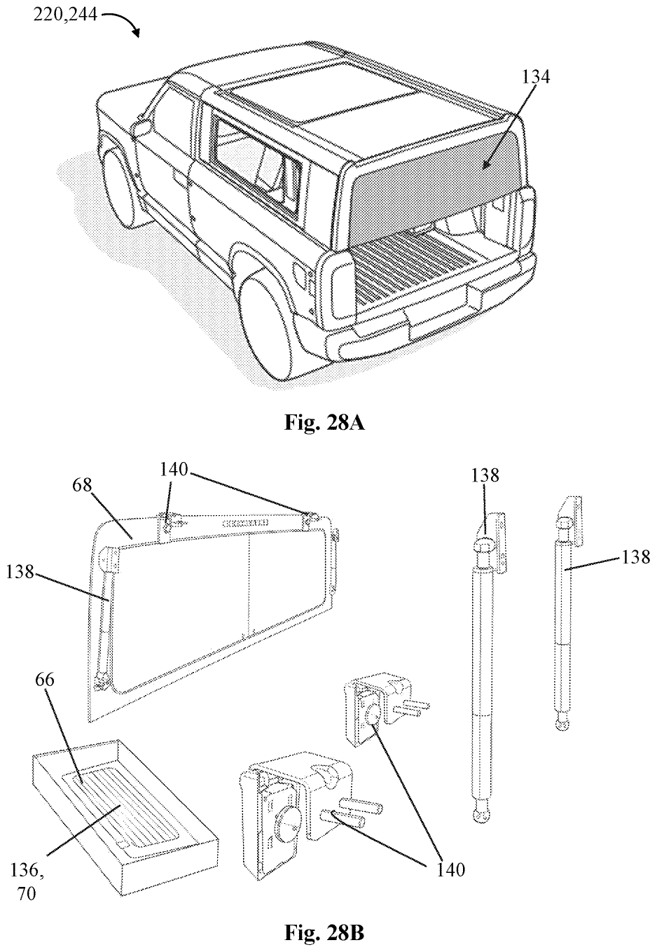

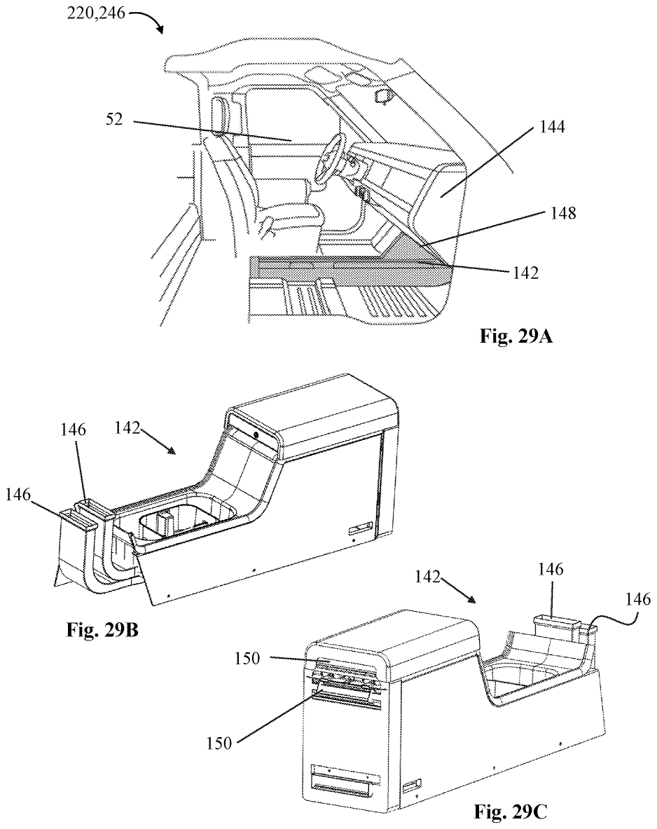

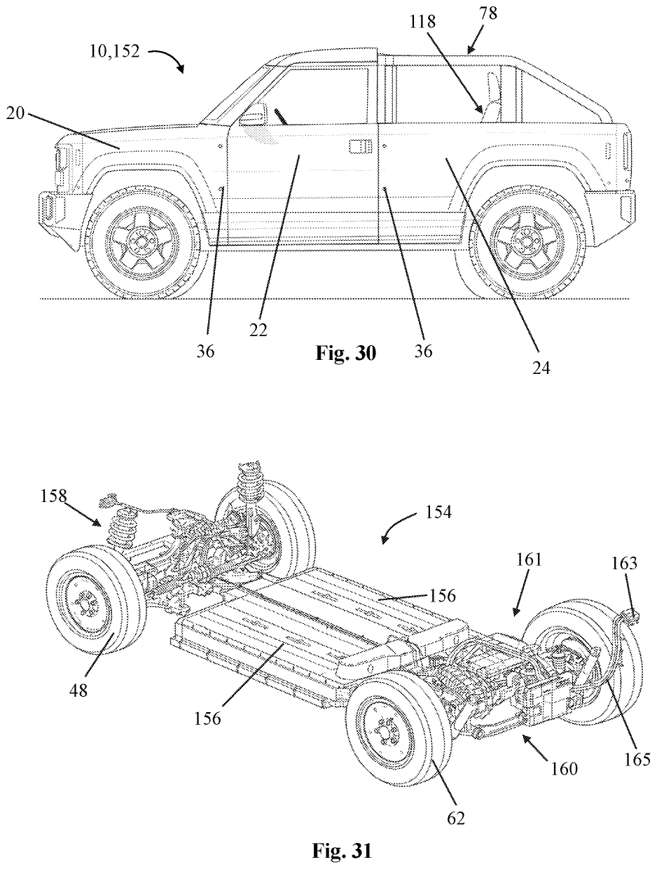

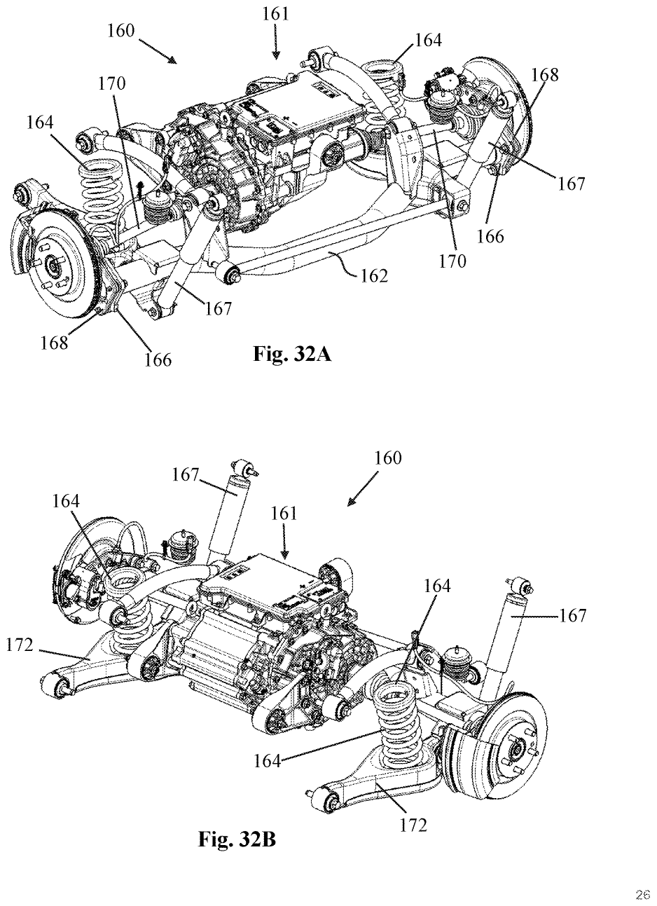

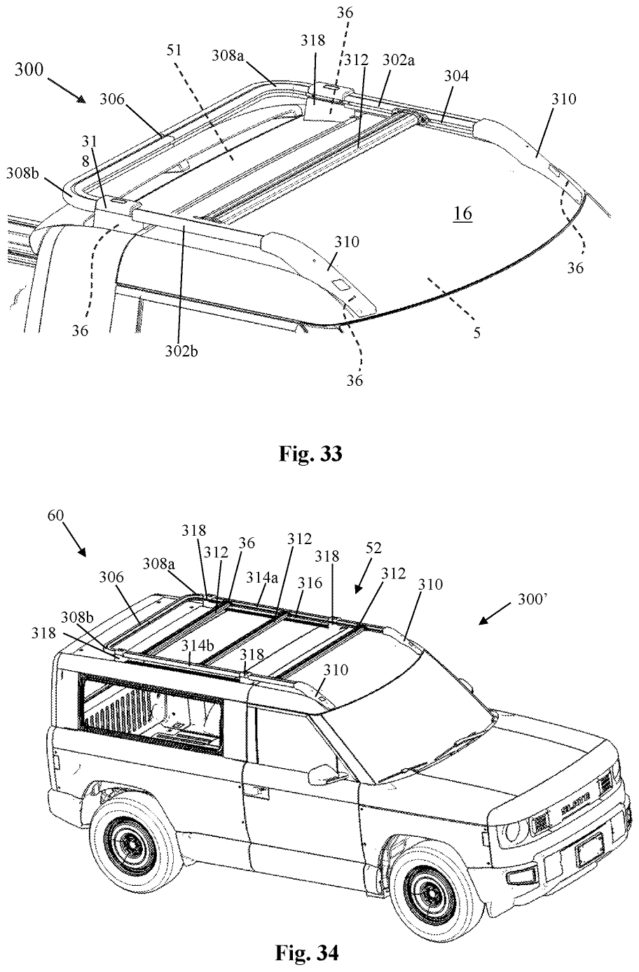

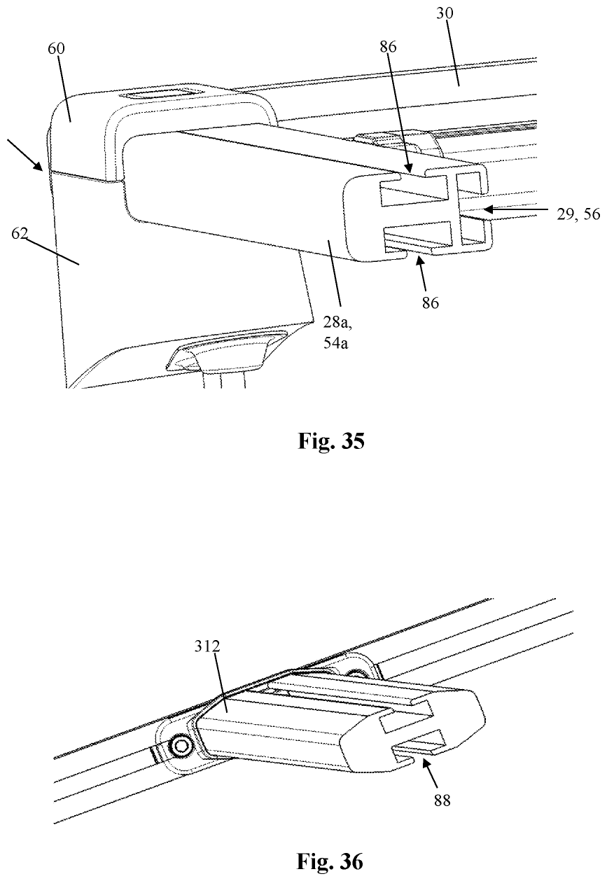

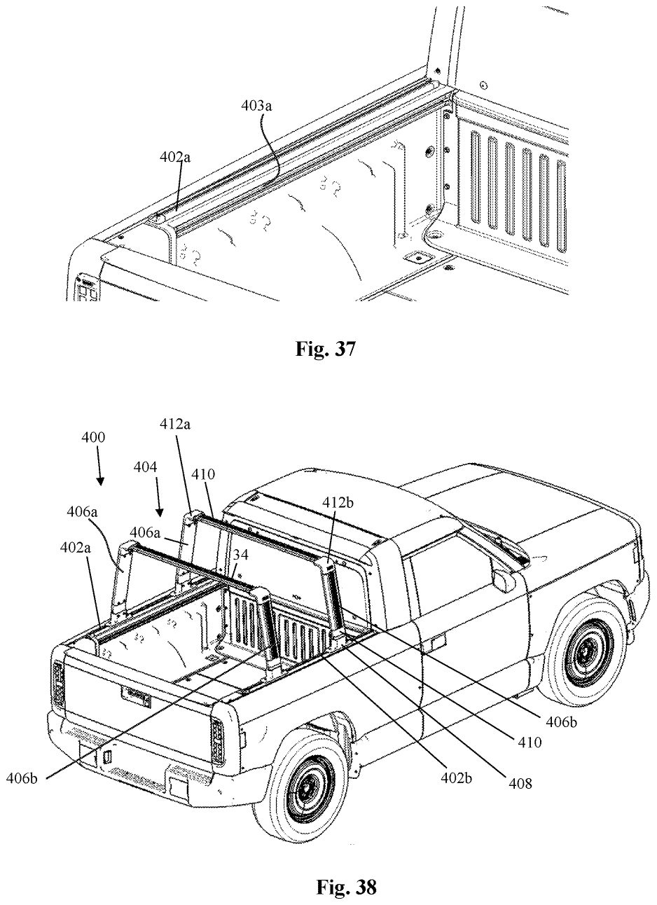

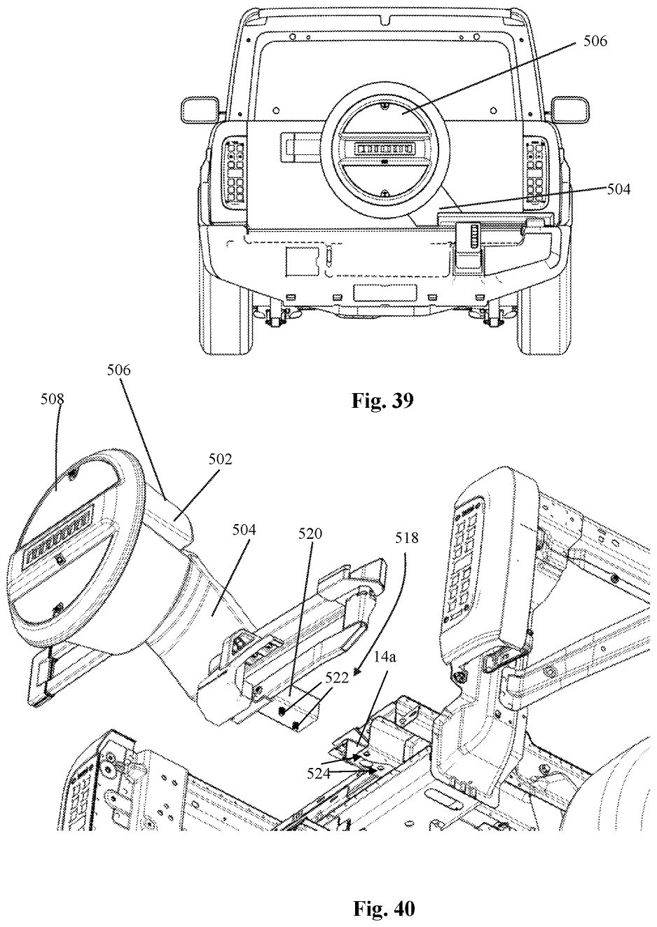

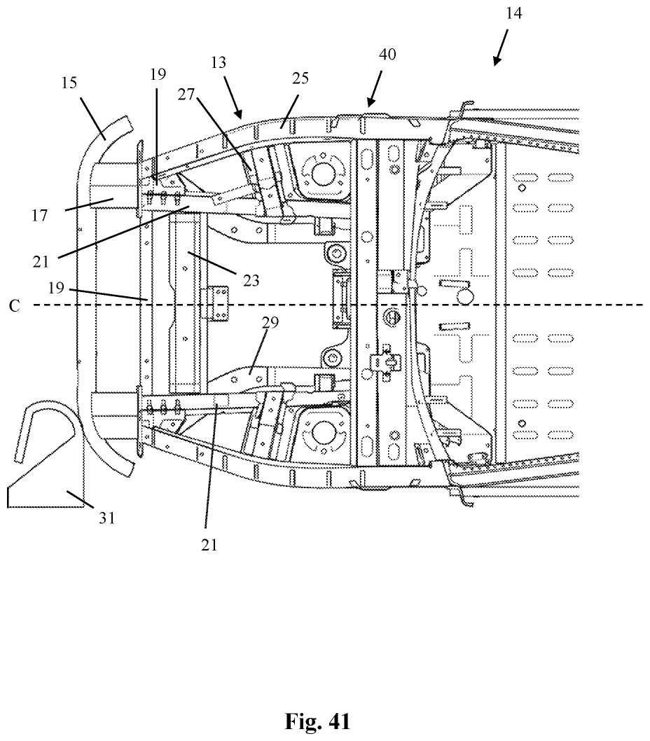

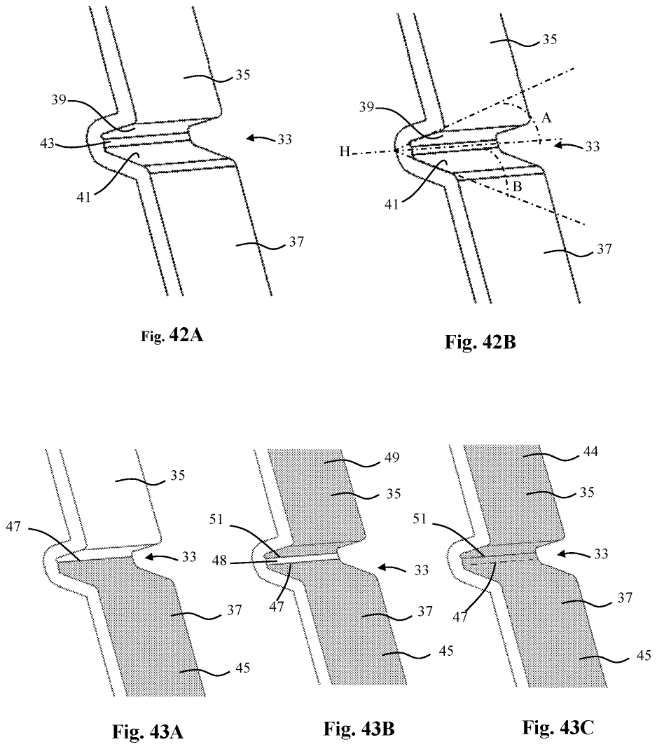

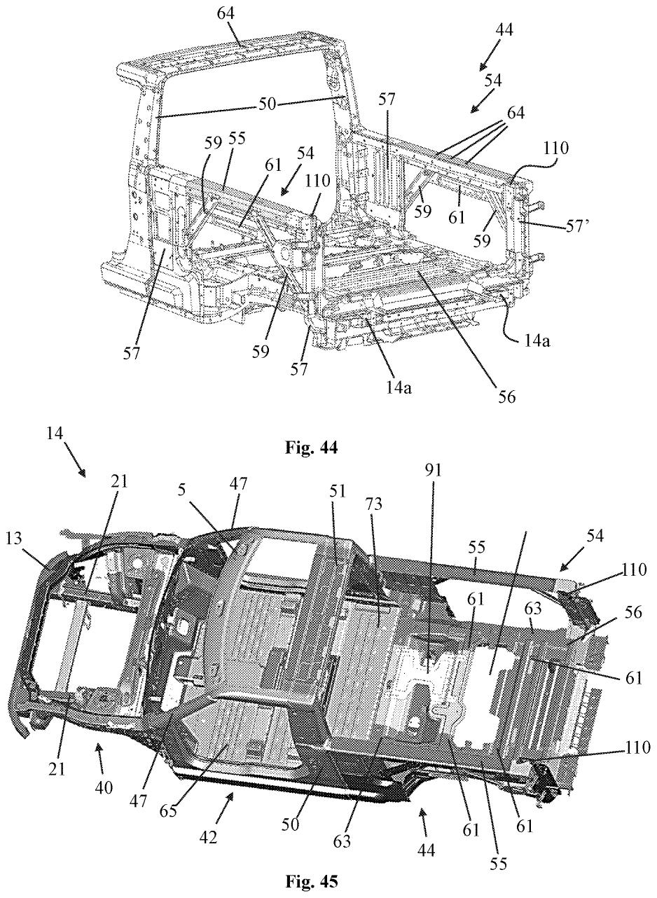

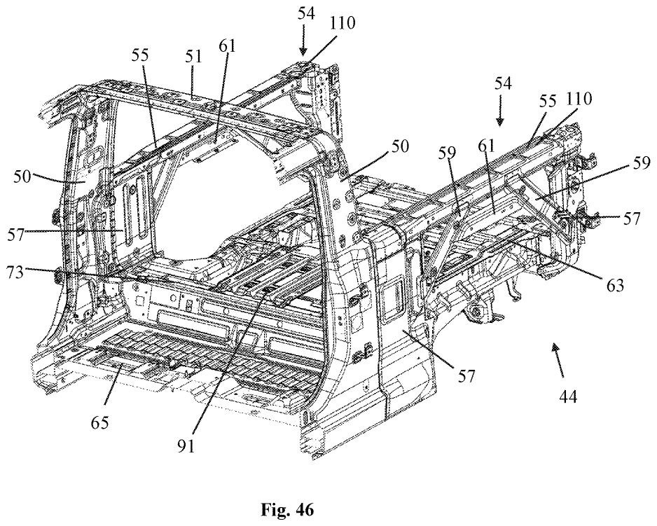

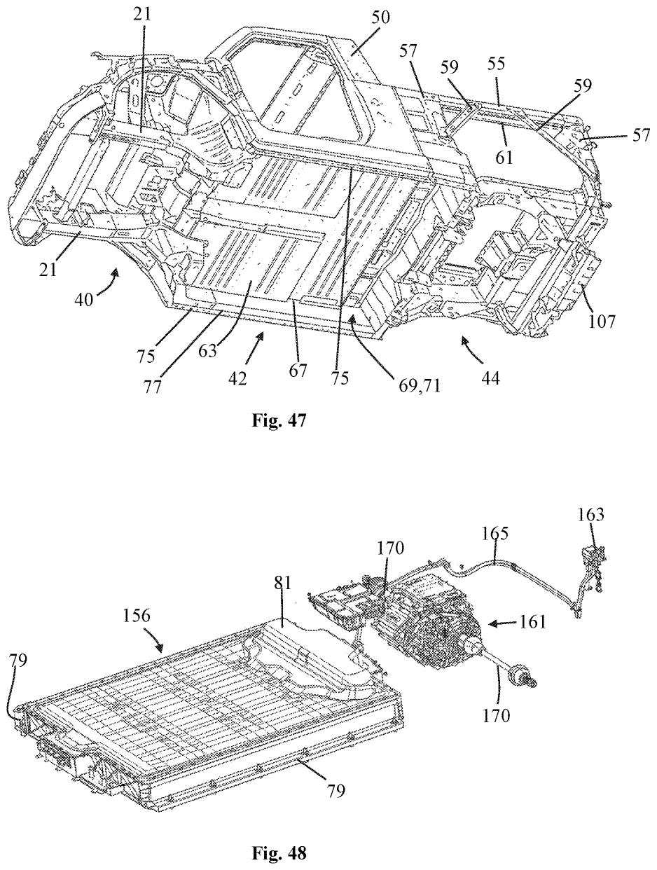

The rearward subassembly or rear region 44 may include at least two spaced apart frame rails, preferably longitudinally oriented toward the rear of the vehicle, the at least two spaced apart frame rails including an open and hollow rear end, and also including rear region that is located proximate, and preferably over, a pair of rear wheels of the vehicle, the rear region having a pair of opposing bed walls and a rear floor, wherein frame comprises one or more preexisting fasteners. The hollow rear end may be adapted to receive an article carrier, such as the one illustrated and described in FIGS. 17 and 18 herein.

The frame, the rearward subassembly, the forward subassembly, the intermediate subassembly, or any reinforcing member thereof may be formed from one or more structural materials, such as metal materials (e.g., steel, high-strength steel, aluminum, or metal alloys), sheet metal, composite materials, fiber-reinforced polymers (e.g., carbon fiber or glass fiber composites), engineered plastics, or combinations thereof.

After the vehicle 10 is converted or transformed into the SUV configuration 38 (FIG. 3), the rear region 44 of the frame 14 may be at least partially covered by and support a rear enclosure assembly 60. When the vehicle 10 is in the pickup truck configuration 12 (FIGS. 1A, 1B) and/or the SUV configuration 38 (FIG. 3), the rear region 44 of the frame 14 may be located generally over and/or in a region of the rear wheels 62 of the vehicle 10.

The frame 14 may include one or more preexisting frame fastening devices 64.

A preexisting frame fastening device 64 may be configured to mate with, engage, or otherwise cooperate with one or more mating fastening devices, such as one or more body panel fastening devices 36, to attach or secure one or more vehicle body panels and/or vehicle accessories to the vehicle or frame 14.

A preexisting frame fastening device 64 may be configured to mate with, engage, or otherwise cooperate with one or more fastening devices to connect or attach one or more elements of the rear enclosure assembly to the vehicle or frame 14. For example, as discussed further below, one or more elements of the hoop structure, roll bar assembly, lower cross bar, rear seats, and/or rear enclosure body panels may be attached to the vehicle or frame via the one or more preexisting frame fastening devices 64.

The one or more frame fastening devices 64 may be one or more preexisting fastening elements on the frame 14. Preexisting in the contact herein means that the one or more frame fastening devices are added or incorporated in or on the frame 14 by the original vehicle manufacturer during original manufacture, construction, and/or assembly of the frame 14 or vehicle before the vehicle or frame is placed into service, purchased by a dealer or end user, or a combination thereof.

In some embodiments, some frame fastening devices 64 may be added to the frame 14 by an end user or dealer after the frame 14 and/or vehicle 10 is constructed, assembled, placed into service, or made available to an end user. Such frame fastening devices 64 can be added at the direction of the OEM or original manufacturer of the rear enclosure assembly in specific regions of the frame that are identified by the OEM or original manufacturer of the rear enclosure assembly via a template or other instructions or diagrams and can therefore be referred to herein as preexisting (in the context of a preexisting intent to include the frame fastening devices in a specific location or orientation on the frame). Such frame fastening devices 64 can be added at the direction of an aftermarket accessory manufacturer or supplier in specific regions of the frame that are identified by the aftermarket accessory manufacturer or supplier via a template or other instructions or diagrams and can therefore be referred to herein as preexisting (in the context of a preexisting intent to include the frame fastening devices in a specific location or orientation on the frame). Such preexisting fasteners are in contrast frame fastening devices added to the frame by an end user in locations that are not expressly contemplated by the original vehicle manufacturer or original manufacturer of the rear enclosure assembly or by an aftermarket accessory manufacturer or supplier.

The one or more preexisting frame fastening devices 64 may include or provide a removable connection (e.g., a removable, semi-permanent, or non-permanent connection) to accommodate a bolt-on and/or bolt-off attachment scheme of the one or more vehicle panels and/or accessories to the vehicle frame.

For example, the preexisting frame fastening devices 64 may enable attachment of one or more interior and/or exterior vehicle body panels, one or more accessories (e.g., cargo carrier, space tire holder, and/or one or more elements of the rear enclosure assembly (e.g., elements of the hoop structure, roll bar assembly, rear seats, or rear enclosure body panels) to the vehicle 10 or frame 14. Such removable fastening arrangements may advantageously allow a user to quickly and easily attach and/or detach one or more vehicle components to reconfigure the vehicle without requiring custom fabrication of attachment features, such as welding, cutting, grinding, bonding, or similar operations.

The one or more preexisting frame fastening devices 64 may be provided in specific areas on the frame 14 or structural elements thereof that are designed and built to accommodate such attachment, so that, advantageously, an end user is not left to decide or speculate if the frame 14 will support the feature to be attached. The one or more frame fastening devices 64 may be provided in specific areas on the frame 14 or structural elements thereof that will not impact vehicle safety and/or jeopardize the structural integrity of the vehicle or frame.

The location of the one or more preexisting frame fastening devices 64 may function as a guide, template, roadmap, or poka-yoke feature to help a user locate and properly position one or more components for attachment to the vehicle 10 or frame 14, such as elements of the rear enclosure assembly 60, rear passenger seats, cargo carrier, tire carrier, etc.

The one or more preexisting frame fastening devices 64 may include one or more male fastening elements and/or female fastening elements configured to engage, receive, or otherwise mate with a body panel fastener 36 to secure a body panel or accessory to the vehicle frame or structure. For example, the one or more preexisting frame fastening devices 64 may comprise one or more bolts, threaded studs, screws, pegs, projections, posts, pins, lips, flanges, weld nuts, threaded inserts, U-clips, C-clips, spring clips, retainers, latches, clamps, hooks, quick-connect fasteners, quarter-turn receptacles, bores, slots, apertures, keyed openings, threaded bores or threaded slots, or any combination thereof.

In some configurations, the preexisting frame fastening device 64 may define a receiving feature (e.g., a bore, slot, aperture, or threaded opening) configured to receive a corresponding portion of the body panel fastener 36. In other configurations, the preexisting frame fastening device 64 may include a projecting feature (e.g., a stud, post, pin, or barb) configured to be received within or engaged by the body panel fastener 36. The frame fastening device 64 and the body panel fastener 36 may cooperate to form a removable, semi-permanent, or permanent connection, including threaded engagement, interference fit, snap-fit engagement, or clip-based retention.

In certain implementations, a frame fastening device 64 may be integrally formed with the vehicle frame, or may be separately attached thereto (e.g., via welding, bonding, mechanical attachment, or overmolding). The arrangement and selection of the frame fastening devices 64 may vary depending on the desired retention force, assembly sequence, serviceability, and manufacturing considerations.

In some configurations, a frame fastening device 64 may be a bracket, flange, cantilever, bar, rod, plate, or other structural element that is integrally formed with the frame or attached to the frame via one or more other frame fastening devices or other attachment means such as welding for example.

One or more of any of the fastening devices disclosed herein (including the frame fastening devices 64) may include fasteners formed from metal, plastic, composite materials, or combinations thereof.

In some embodiments, one or more of the fastening devices may be reusable. As used herein, the term “reusable” refers to a fastener that can be repeatedly installed, removed, and reinstalled while retaining sufficient structural integrity to securely engage and retain the component that it is configured to hold or attach. For example, a plastic fastener may be reused until it undergoes sufficient plastic deformation that it can no longer properly engage or retain the associated component. Similarly, a metal fastener may be reused until deformation, wear, or damage (e.g., stripped threads or a rounded engagement feature) prevents the fastener from properly engaging or retaining the component.

The one or more preexisting frame fastening devices 64 may cooperate with and/or engage one or more mating fastening devices disclosed herein, including, but not limited to, rear glass or window fastening devices, roof panel fastening devices, B-pillar panel fastening devices, halo or backlight fastening devices, rear cab bulkhead fastening devices, hoop structure fastening devices, frame rail fastening devices, interior panel fastening devices, roll bar assembly fastening devices, rear side panel fastening devices, article carrier fastening devices, rear seat fastening devices, B-pillar fastening devices, spoiler fastening devices, bed floor panel fastening devices, or combinations thereof.

The one or more preexisting frame fastening devices 64 may be located at an interior region of the frame 14 (e.g., located inside of the frame structure or extending inwardly from the frame structure) and/or exterior region of the frame 14 (e.g., located outside of the frame structure or extending outwardly from the frame structure).

FIG. 3 illustrates a vehicle 10 in the SUV configuration 38. The vehicle 10 has been converted or transformed from the pickup truck configuration 12 to the SUV configuration 38 in accordance with the teachings herein.

Briefly stated, the rear enclosure assembly 60 has been attached to the vehicle 10 and frame 14 to convert the vehicle into the SUV configuration. The rear enclosure assembly 60 can be used to close out the bed region of the vehicle or pickup truck to provide a covered region in the vehicle. One or more vehicle seats may be added to the vehicle in the enclosure assembly to add additional seating to the vehicle. In other configurations, a user may wish to not include any rear seating in the rear enclosure assembly and instead have a region that can be used for dry or covered storage. In some instances, the rear passenger seating can be removed and installed as desired, depending on the desired use of the vehicle.

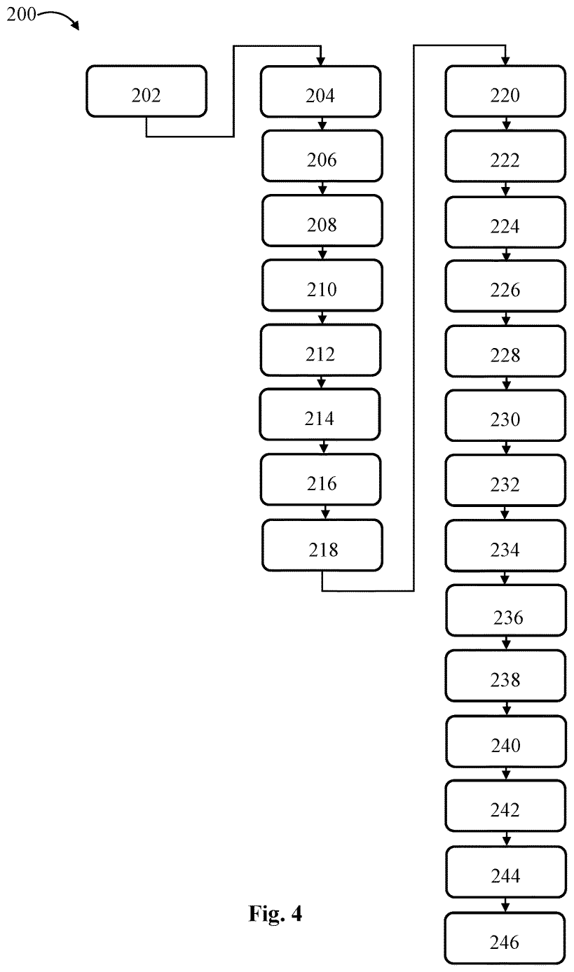

FIG. 4 illustrates a method 200 for converting the vehicle 10 from the pickup truck configuration 12 to the SUV configuration 38.

It is understood that certain method steps disclosed herein may be performed in a different order or sequence. It is understood that some method steps may be combined with one or more other method steps. It is understood that some method steps may be split or divided into two or more method steps. It is understood that some method steps may be omitted or duplicated (e.g., repeated or performed more than once).

Conversion of the vehicle from the pickup truck configuration 12 to the SUV configuration 38 (or from the SUV configuration 38 to pickup truck configuration 12) may take about 12 or less hours, preferably about 8 or less hours, more preferably about 6 or less hours, even more preferably about 4 or less hours.

Conversion of the vehicle from the pickup truck configuration 12 to the SUV configuration 38 (or from the SUV configuration 38 to the pickup truck configuration 12) may be performed by 4 users or fewer, preferably 3 users or fewer, more preferably 2 users or fewer, and even more preferably by a single user or operator.

The conversion of the vehicle from the pickup truck configuration 12 to the SUV configuration 38 (or from the SUV configuration 38 to the pickup truck configuration 12) may be accomplished using one or more tools that are generally available to an ordinary user. For example, the tools may include one or more wrenches, ratchets, screwdrivers or driver bits, pliers, trim sticks, suction cups, or similar tools. In some embodiments, one or more of the tools may be provided as part of a kit associated with the rear enclosure assembly disclosed herein. In other embodiments, the tools may be provided in a tool kit supplied by the vehicle manufacturer or by a manufacturer or supplier of the rear enclosure assembly. Alternatively, one or more of the tools may be obtained or supplied by the user prior to or during the conversion or transformation process.

In other words, conversion of the vehicle from the pickup truck configuration 12 to the SUV configuration 38 (or from the SUV configuration to the pickup truck configuration) does not require specialized fabrication tools that would typically be found in a mechanic's or fabricator's garage or shop, such as welders, grinders, plasma cutters or other fuel-powered cutting devices, mills, lathes, and the like. The conversion also does not require a user to fabricate custom brackets, panels, electrical harnesses, wiring, or similar components, as the rear enclosure assembly may be provided with the parts required for the conversion. Moreover, because elements of the vehicle, frame, and/or rear enclosure assembly are not permanently destroyed or modified during the conversion process, the vehicle may be reconfigured between vehicle configurations (e.g., the pickup truck configuration and the SUV configuration) any number of times or multiple times.

The method 200 may include a step of obtaining a rear enclosure assembly 60. The rear enclosure assembly may be obtained from the original equipment manufacturer (OEM) or from an aftermarket source, supplier, or manufacturer. In some embodiments, the rear enclosure assembly may be included with the purchase of the vehicle, while in other embodiments the rear enclosure assembly may be purchased or obtained as an option after the vehicle has been purchased. The rear enclosure assembly may be packaged and shipped to a user or residence via standard parcel shipping services (e.g., FedEx, UPS, USPS, or similar carriers), and preferably does not require freight shipping. However, in some configurations, freight shipping may be required to deliver some or all of the required components of the rear enclosure assembly. The rear enclosure assembly may include the structures and components necessary to convert the vehicle from the pickup truck configuration 12 to the SUV configuration 38 and vice versa.

The rear enclosure assembly 60 may be packaged in one or more packages or boxes. In some embodiments, the packages or boxes may be formed from recyclable cardboard. In other configurations, the packages or boxes may comprise plastic packaging that can be recycled or returned to the OEM or supplier after use. Preferably, the rear enclosure assembly need not be shipped or transported on a pallet. Advantageously, this may facilitate easier handling of the rear enclosure assembly prior to installation onto the vehicle or vehicle frame.

One or more of the packages or boxes may be used for storing one or more vehicle body panels and/or components that are removed from the vehicle during the conversion process. This may ensure the removed panels or structures are protected and not otherwise damaged when not in use.

The method 200 may include one or more steps 202 of preparing the vehicle 10 for conversion or transformation from the pickup truck configuration into the SUV configuration.

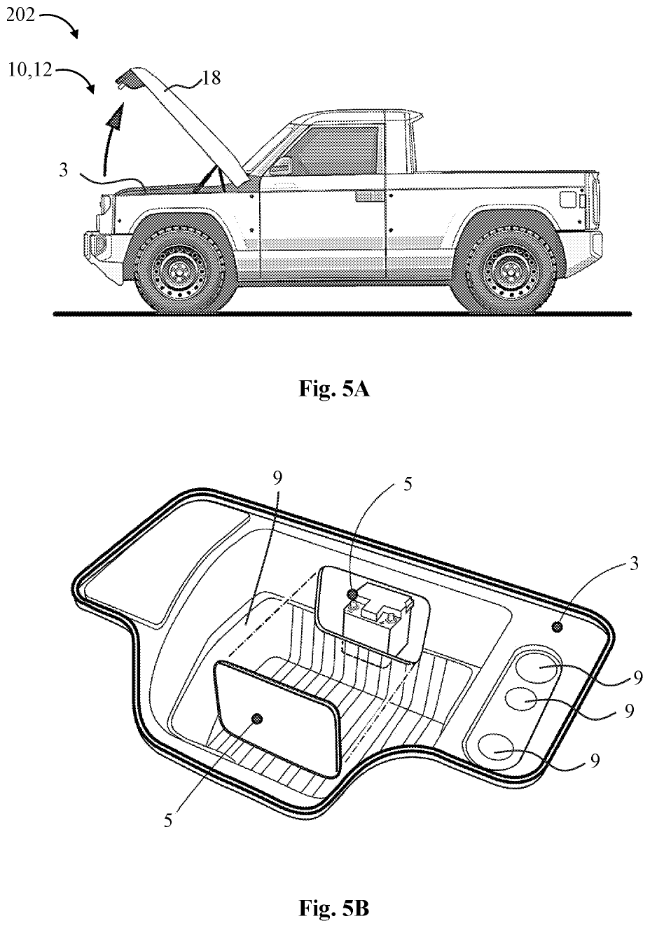

Referring to FIG. 5A, the preparation step 202 may include a step of parking or positioning the vehicle 10 in the pick-up truck configuration 12 on a substantially flat surface or grade. This step 202 may include applying a vehicle park brake to prevent the vehicle from moving or rolling away. This step 202 may include opening the vehicle hood 18 to gain access to the front region of the vehicle, such as the frunk 3. This step 202 may include inserting or removing the vehicle key or FOB into or from the dashboard or vehicle 10. This step may include informing or notifying the vehicle computer or telematics system of the upcoming assembly or reconfiguration. For example, the step 202 may include placing the vehicle and/or the vehicle computer or telematics system into a configuration mode to facilitate installation of the rear enclosure assembly or reconfiguration of the vehicle. This step may include flashing or informing the vehicle computer or telematics of the upcoming assembly or reconfiguration. In some configurations, the vehicle computer or telematics can be flashed or made aware of the assembly or reconfiguration after completion. In some configurations, the vehicle computer or telematics can be automatically informed or understand that the rear enclosure assembly or reconfiguration has taken place, for example by way of the electrical connections in the rear enclosure assembly to the vehicle or for example after the rear seat of the vehicle is installed in the vehicle and/or electrically connected to the vehicle circuitry.

The preparation step 202 may include disconnecting one or more of the vehicle batteries. Referring to FIG. 5B, a cover or trim panel 5 in the frunk 3 region of the vehicle may be removed or manipulated to expose a battery. Step 202 may include removing the black or negative battery cable 5 from the battery. Step 202 may include placing a cap or cover on the negative terminal of the battery. The hood 18 may be left open or may be closed during step 202 and/or the subsequent steps of the method. In some configurations, the battery or negative cable to be disconnected in step 202 may be located in another region of the vehicle, such as in the cabin, below one or more of the seats, behind the dashboard, in the truck bed, etc.

The frunk 3 may include one or more cup holders or other storage areas, bins, or recesses 9 for holding or storing items, such as cups, tools, luggage, boxes, bags, groceries, clothes, etc.

The method 200 may include one or more steps of disassembling or removing 204 one or more vehicle body panels, elements, structural components, and/or decorative components from the vehicle 10 and/or frame 14.

Unless otherwise expressly indicated, the disassembly or removal of one or more vehicle body panels, elements, structural components, and/or decorative components may be performed in any suitable order, sequence, or combination of steps, and is not limited to the specific order or sequence illustrated and/or described herein. For example, certain components may be removed before, after, or concurrently with other components depending on accessibility, fastening arrangements, or user preference. In some embodiments, one or more preparatory steps (e.g., releasing fasteners, disconnecting electrical connections, or repositioning adjacent components) may be performed prior to removal, while in other embodiments such steps may be omitted, combined, or performed in a different sequence.

Moreover, unless otherwise expressly indicated, the disassembly or removal of the vehicle body panels, elements, structural components, and/or decorative components may be performed as part of a single step, multiple discrete steps, or grouped operations. In some embodiments, two or more components may be coupled, fastened, or otherwise joined together to define a subassembly, such that the subassembly may be removed or disassembled as a unit. In this regard, even if the method is described herein as removing or disassembling individual components separately, such components may alternatively be removed together as part of a common assembly. Conversely, components described as part of an assembly may be separated and removed individually. Accordingly, the described steps should not be construed as requiring independent or sequential removal of each component, but rather encompass any suitable combination, grouping, or subdivision of removal operations.

One or more tools may be used during the one or more disassembling steps 204. For example, the tools may include wrenches, ratchets, screwdrivers or driver bits, trim sticks, suction cups, or other suitable tools. In some embodiments, one or more of the tools may be provided as part of a kit associated with the rear enclosure assembly. In other embodiments, the tools may be included in a tool kit supplied by the vehicle manufacturer. Alternatively, one or more tools may be obtained or supplied by the user performing the conversion or transformation. The tools used during the disassembling steps 204 may be the same as, or different from, the tools used during the one or more installation or assembly steps 220 described below.

In some configurations, one or more of the disassembling steps 204 may be performed without the use of tools. For example, depending on the configuration of the attachment structures, body panel fastening devices, preexisting frame fastening devices, or combinations thereof, a user may push, pull, slide, or otherwise manipulate a panel or structure to remove, reposition, or prepare the component for subsequent reconfiguration and assembly as described herein.

In any event, the one or more tools are free of tools that would permanently affect or modify the frame or vehicle, such as welders, grinders, cut-off wheels, or similar material-removal or permanent-alteration tools.

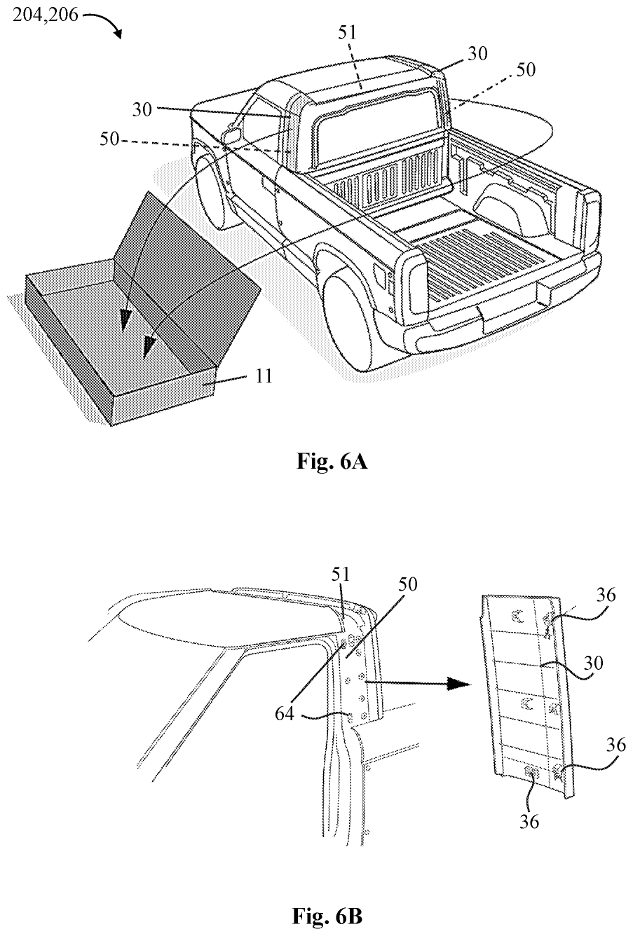

Referring to FIGS. 6A and 6B, one or more of the disassembling steps 204 may include one or more steps 206 of removing or separating one or more B-pillar panels or appliques 30 from the vehicle or vehicle frame. The one or more B-pillar panels or appliques 30 may be attached to the vehicle frame at the top and/or back region of the vehicle cockpit (e.g., may be attached to the frame B-pillar 50 and/or the frame cross rail 51 between the opposing B-pillars 50 and/or to a frame structure connected to and/or associated with the B-pillar 50, for example).

The one or more B-pillar panels or appliques 30 may be attached to the vehicle or vehicle frame via one or more B-pillar panel fastening devices 36. The one or more B-pillar panel fastening devices 36 may engage one or more preexisting frame fastening devices 64 to hold or secure the one or more B-pillar panels or appliques 30 at the frame 14.

The one or more B-pillar panel fastening devices may be located and/or accessed from inside the vehicle 10 (e.g., inside of the vehicle cockpit) and/or outside of the vehicle. The one or more B-pillar panel fastening devices may be one or more pins or clips. The step 206 may include removing or separating the one or more B-pillar panel fastening devices from the frame and storing the one or more B-pillar panels or appliques 30 and B-pillar panel fastening devices for later use, for example in the one or more packages or boxes 11. Ater the one or more B-pillar panels or appliques 30 are removed, the vehicle frame or B-pillars 50 may be at least partially exposed, accessible, or visible from outside of the vehicle. The one or more B-pillar panels or appliques 30 may be removed via one or more tools, such as one or more trim sticks. The one or more B-pillar panels or appliques 30 may be removed by pulling the one or more B-pillar panels or appliques 30 in a direction away from the vehicle or frame to disengage the one or more body panel fasteners 36 from the frame or preexisting frame fastening devices 64.

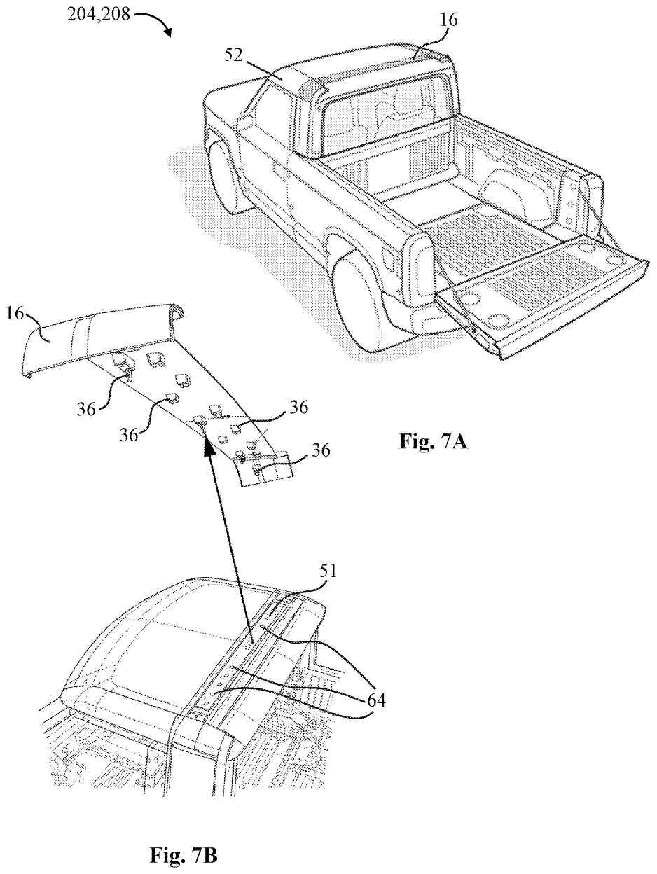

Referring to FIGS. 7A and 7B, the disassembling step 204 may include one or more steps 208 of removing or separating one or more panels from the vehicle or frame. The one or more panels may be one or more roof panels 16. The one or more roof panels 16 may be attached to the vehicle frame at the top and/or back region of the vehicle cockpit 52 (e.g., may be attached to the frame B-pillar and/or the cross rail 51 between the opposing frame B-pillars and/or to a frame structure connected to and/or associated with the B-pillar, for example).

The one or more roof panels 16 may be attached to the vehicle or vehicle frame via one or more roof panel fastening devices 36 that engage one or more preexisting frame fastening devices 64. The one or more roof panel fastening devices 36 may be located and/or accessed from inside the vehicle 10 (e.g., inside of the vehicle cockpit 52 and/or outside of the vehicle). The one or more roof panel fastening devices 36 may be separated from the one or more preexisting frame fastening devices 64 via one or more tools. In other configurations, the roof panel 16 can be removed from the vehicle or frame by pulling up on the panel 16 until the fastening devices or clips 36 disengage the slots, apertures, or preexisting frame fastening devices 64. In some configurations, the roof panel 16 may be removed or separated from the vehicle before the B-pillar panels or appliques are removed (e.g., step 206). In some configurations, the one or more B-pillar panels or appliques and the roof panel may be a single integral structure or assembly that is removed as a single element or assembly.

The step 208 may include removing or separating the one or more roof panel fastening devices from the frame and storing the one or more roof panels 16 and roof panel fastening devices for later use. For example, the one or more roof panels may be stored in the one or more packages or boxes 11. Ater the one or more roof panels 16 are removed, the cross member or rail 51 may be exposed or visible from outside of the vehicle.

Referring to FIG. 8, the disassembling step 204 may include one or more steps 210 of removing or separating a vehicle cab spoiler 32 from the vehicle or vehicle frame. The vehicle cab spoiler 32 may be attached to the inside or outside of the vehicle frame at the top and/or back of the vehicle cockpit (e.g., may be attached to the B-pillar 50, cross member or rail 51, and/or to a frame structure connected to and/or associated with the B-pillar 50, for example). The vehicle cab spoiler 32 may be attached to the vehicle frame via one or more cab spoiler fastening devices that engage one or more preexisting frame fastening devices. The cab spoiler fastening devices may be located inside and/or outside of the vehicle.

The vehicle cab spoiler 32 may be removed from the vehicle before, during, or after the one or more roof panels and/or B-pillar panels or appliques (Steps 206, 208) are removed from the vehicle or frame. In some configurations, the vehicle cab spoiler 32, B-pillar panels or appliques, and/or the roof panel may be a single integral structure or assembly that is removed as a single element or assembly.

The step 210 may include removing or separating the one or more vehicle cab spoiler fastening devices from the frame and storing the vehicle cab spoiler 54 and the vehicle cab spoiler fastening devices in the one or more packages or boxes for later use.

In some configurations, the vehicle cab spoiler 32 may be or may include a bi-plane spoiler. A bi-plane spoiler may provide a decorative and/or functional aerodynamic feature of the vehicle. For example, the bi-plane spoiler may include a first spoiler element and a second spoiler element that are vertically spaced from one another, such as an elevated member positioned above one or more roof panels and supported by one or more brackets, uprights, or stanchions. In such configurations, air or wind may flow over the elevated member, under the elevated member, and between the spaced spoiler elements during vehicle operation, which may influence airflow, reduce turbulence, and/or improve aerodynamic stability or downforce. The spacing, orientation, and geometry of the spoiler elements may vary depending on styling and performance considerations. In some configurations, the vehicle cab spoiler 32, including the bi-plane spoiler, may be integrated with the one or more roof panels such that it is installed and/or removed together with the roof panels.

Referring to FIG. 9, the method 200 or disassembling step 204 may include one or more steps 212 of removing or separating one or more portions of the vehicle located in a region of the vehicle cab or cockpit 52. For example, this step may involve removing or separating the rear glass or window assembly 66 from the vehicle or vehicle frame. The rear glass or window assembly 66 may comprise a rear glass or window frame 68 that supports or at least partially surrounds the rear glass or window 70.

One or more decorative and/or structural panels or claddings located inside or outside of the vehicle may be removed before or during this disassembling step to gain access to the rear glass or window assembly 66, the frame 68, and/or the window 70. The rear glass or window frame 68 may be attached to the inside or outside of the vehicle frame at the back region of the vehicle cockpit 52 (e.g., may be attached to the B-pillar 50 and/or the upper cross rail 51 between the opposing B-pillars 50 and/or to a frame structure connected to and/or associated with the B-pillar 50, for example).

The rear glass or window frame 68 may be attached or secured to the vehicle frame via one or more rear glass or window fastening devices 36 that engage one or more preexisting frame fastening devices 64. The fastening devices 36,64 may be located and/or accessible from inside the vehicle 10 (e.g., inside of the vehicle cockpit 52) and/or from outside of the vehicle. The step 212 may include removing or separating the rear glass or window frame fastening devices 36 from the frame 14 and storing the rear glass or window assembly 66 and rear glass or window frame fastening devices 36 for later use or installation.

The rear glass or window 70 may be removed or separated from the frame 68 before the frame 68 is removed or separated from the vehicle frame. Or the rear window 70 and the frame 68 may be removed or separated from the vehicle frame together as a unitary assembly.

The rear glass or window assembly 66 and/or fastening devices 36 may be stored in one or more packages or boxes 11. The one or more packages or boxes 11 may be those in which one or more elements of the rear enclosure assembly are shipped or obtained by the user. Accordingly, the one or more packages or boxes 11 in which one or more elements of the rear enclosure assembly are shipped or packages may be used or reused in the assembly or reconfiguration process or method disclosed herein. One or more elements of the rear enclosure assembly 60 may be removed or separated from one or more of the packages or boxes 11 before or during the disassembling step(s) 204.

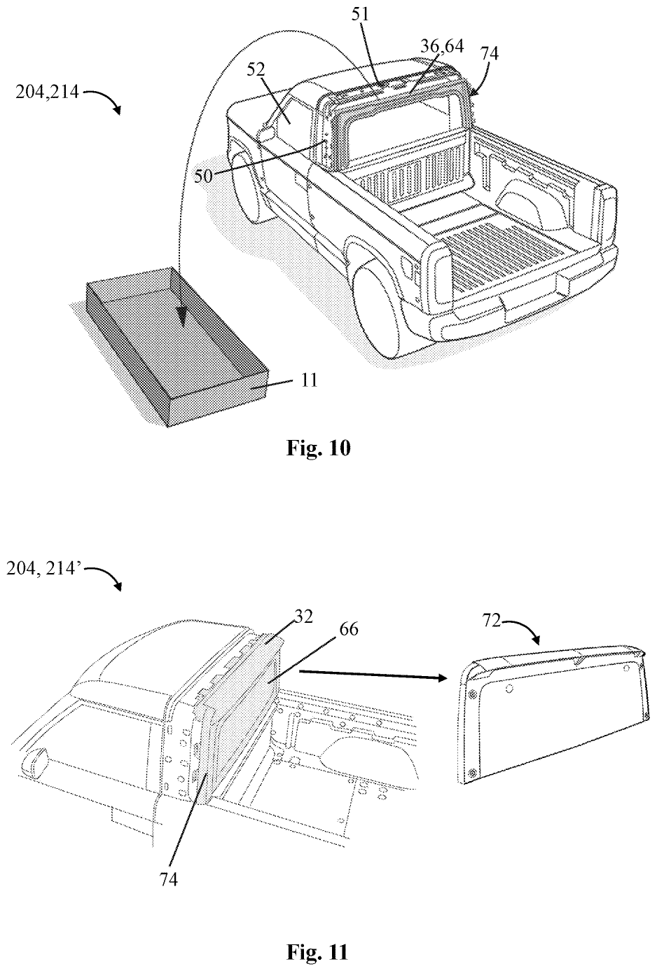

Referring to FIG. 10, the disassembling step 204 may include one or more steps 214 of removing or separating a halo and backlight frame 74 from the vehicle or vehicle frame. The halo and backlight frame 74 may be or comprise a back trim or support structure and backlight (e.g., third brake like, CHIMSL, etc.) at the back end of the vehicle cockpit 52. The halo and backlight frame may provide the support structure onto which the back end of the vehicle cockpit 52 is attached. The halo and backlight frame may be part of the middle or Intermediate region or subassembly of the vehicle frame. The rear window or glass, the one or more roof panels, the CHIMSL, or a combination thereof may be attached or fastened to the halo and backlight frame. In some configurations, the halo and backlight frame 74 may be removed or separated before, during, or after the step or removing or separating the rear glass or window assembly 66 from the vehicle or vehicle frame.

The halo and backlight frame 74 may be attached to the inside or outside of the frame at the top and/or back of the vehicle cockpit 52 (e.g., may be attached to the B-pillar, cross bar or member 51, and/or to a frame structure connected to and/or associated with the B-pillar, for example). The halo and backlight frame 74 may be attached to the frame 14 via one or more halo and back light fastening devices 36 that engage one or more preexisting frame fastening devices 64 of the vehicle frame. The fastening devices may be located inside and/or outside of the vehicle 10. The step 214 may include removing or separating the one or more halo and backlight frame fastening devices from the frame and storing the halo and backlight frame 74 and halo and backlight frame fastening devices in the one or more packages or boxes 11 for later use.

The step 214 may also include disconnecting electrical power from the electrical wiring system (EWS) between the backlight (e.g., 3^{rd} brake light, CHIMSL, etc.) and the vehicle 10. This may include separating or disconnecting one or more electrical sockets, plugs, or connectors from the vehicle wiring to cease providing electrical power or signals to the 3^{rd} brake light or CHIMSL. CHIMSL may stand for Center High-Mounted Stop Lamp.

In some configurations, two or more of the vehicle panels or devices may be separated or removed as an assembly. For example, referring to FIG. 11 and step 214′, the vehicle cab spoiler 32, the rear glass or window assembly 66, and/or the halo and backlight frame 74 may be removed or separated from the vehicle frame as a single assembly 72. Advantageously, this may reduce the number of disassembly steps required during the conversion method 200, may ensure the rear glass is not damaged during disassembly and/or handling. Other parts may be added to the assembly, including the B-pillar appliques, roof panels, etc. one or more components of the single assembly 72 or all of the components of the single assembly 72 may be re-used during construction of the SUV configuration, for example in steps 240, 244, etc.

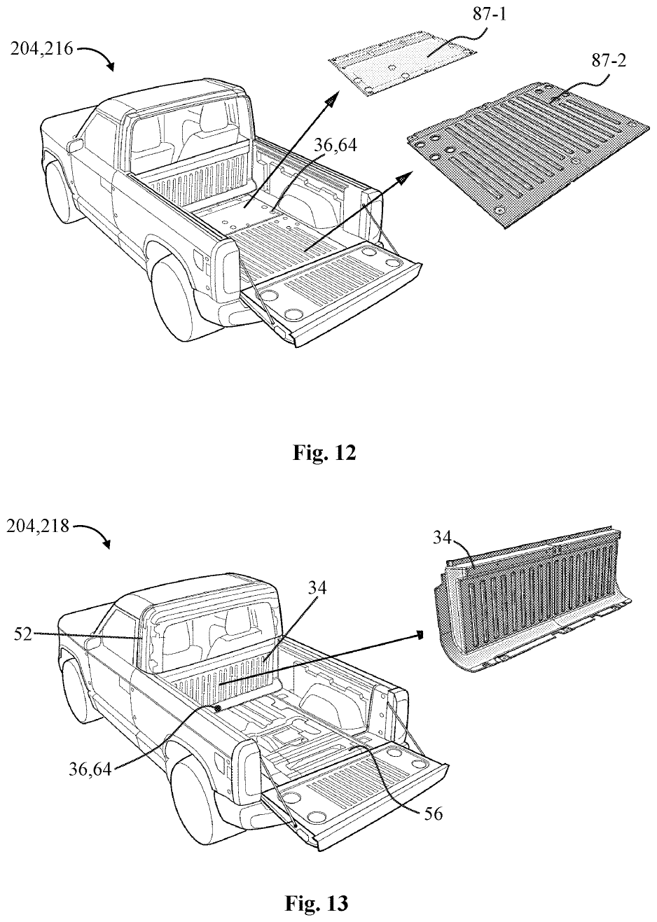

Referring to FIG. 12, the disassembling step 204 may include one or more steps 216 of removing one or more bed floor panels 87-1, 87-2 from the vehicle or vehicle frame. The one or more bed floor panels may be removed by removing one or more bed floor fasteners 36 that are configured to engage one or more frame fastening devices 64 located in a rear region of the vehicle or frame. Ater the one or more bed floor panels 87-1, 87-2 are removed, the vehicle frame may be exposed, accessible, or visible from outside of the vehicle. Ater the one or more bed floor panels 87-1, 87-2 are removed, a rear portion or rearward sub assembly of the vehicle frame may be visible or accessible from above. Ater the one or more bed floor panels 87-1, 87-2 are removed, one or more preexisting frame fastening devices 64 may be visible or accessible.

The one or more bed floor panels 87-1, 87-2 or bed floor fastening devices 36 may be removed via one or more tools. The one or more bed floor panels 87-1, 87-2 may be removed by pulling the one or more bed floor panels 87 in a direction up and away from the vehicle or frame to disengage the one or more bed floor panel fasteners 36 from the frame or preexisting frame fastening devices 64.

The one or more bed floor panels 87-1, 87-2 may be re-installed in the vehicle after disassembly and/or during the reconfiguration process.

In some configurations, one or more of the bed floor panels 87 may be replaced with a different or modified bed floor panel that is specifically configured for use in the SUV configuration. For example, a replacement bed floor panel may include an outer covering, such as carpet, fabric, polymeric layers, or other decorative or ornamental surface finishes, which may provide an interior appearance more consistent with a passenger cabin environment. A replacement bed floor panel may further include one or more structural and/or functional features tailored for the SUV configuration. For example, the panel may include additional or repositioned mounting openings, attachment interfaces, brackets, preexisting frame fastening devices, or reinforced regions configured to support and secure components such as one or more seats, seat brackets, a roll bar or halo assembly, interior trim panels, or other interior structures. A replacement bed floor panel may also include one or more sealing features, such as gaskets, seals, isolators, or overlapping joints, that cooperate with adjacent panels or structures to reduce or inhibit the ingress of water, air, noise, dust, and debris into the vehicle interior. In this manner, the replacement bed floor panel 87 may improve occupant comfort, structural integration, and environmental sealing when the vehicle is in the SUV configuration. An example of a replacement bed floor panel is illustrated and described with reference to FIG. 16B.

Referring to FIG. 13, the disassembling step 204 may include one or more steps 218 of removing or separating one or more rear cab bulkhead panels 34 from the vehicle or vehicle frame. A rear cab bulkhead panel 34 may be attached to the vehicle frame at a rear portion of the vehicle cockpit 52, such as at or near the B-pillar and/or an intermediate frame structure associated therewith. In some configurations, the rear cab bulkhead panel 34 may also be attached to the rear floor 56 of the frame 14, which may be at least partially exposed after removal of one or more bed floor panels.

In a pickup truck configuration, the rear cab bulkhead panel 34 may separate the vehicle cockpit 52 from the cargo area and may define a boundary between frame subassemblies. The rear cab bulkhead panel 34 may be secured to the vehicle frame via one or more rear cab bulkhead fastening devices 36 that engage corresponding preexisting frame fastening devices 64. These fastening devices may be accessible from an interior and/or exterior of the vehicle. Step 218 may include removing the rear cab bulkhead fastening devices 36 to detach the rear cab bulkhead panel 34 from the frame, with the fastening devices optionally retained for later reuse.

After removal of the rear glass or window assembly and the rear cab bulkhead panel 34, the vehicle cockpit 52 may be open or exposed from a rear side of the vehicle, thereby providing access to the cockpit to/from the cargo area. The rear cab bulkhead panel 34 may be stored for later use, such as when converting the vehicle from an SUV configuration back to a pickup truck configuration.

In certain embodiments, the sequence of disassembly steps may vary. For example, the removal of the rear bulkhead panel 34 may be performed prior to removing one or more bed floor panels. Such sequencing may be influenced by the manner in which adjacent panels 34, 87 interface, mate, or overlap with one another, including any interlocking features, fastening dependencies, or structural relationships between the panels.

As described herein, one or more of the disassembling steps 204 may be performed without substantially or permanently destroying, cutting, or otherwise altering the vehicle frame and/or the one or more vehicle elements removed from the frame. In this manner, the disassembly process may be substantially non-destructive with respect to both the frame and the removed components. Rather than requiring destructive modification of vehicle structures, such a cutting, milling, grinding, etc, the one or more elements may be removed by loosening, disengaging, or removing one or more mechanical fasteners (e.g., screws, bolts, clamps, threaded fasteners, weld nuts, threaded bores, clips, or similar fastening devices) that engage the frame and/or the one or more preexisting frame fastening devices.

Accordingly, the removed vehicle elements and the vehicle frame may remain structurally intact and capable of being reinstalled at a later time. This non-destructive disassembly approach may enable the vehicle to be reconfigured between different configurations multiple times without requiring permanent modification, fabrication, or replacement of original vehicle structures. In some embodiments, the disassembly may be performed by an ordinary owner or user using commonly available tools, without requiring specialized equipment typically found in a mechanic's or fabrication shop. Additionally, one or more of the removed vehicle elements may be repurposed or reused in alternative vehicle configurations, which may reduce material waste and provide environmental benefits.

The method 200 may include one or more steps 220 of installing, assembling, and/or attaching one or more elements to the vehicle or vehicle frame. These steps may be performed in the order described, or in a different order, and may be combined into fewer steps or divided into additional steps depending on the implementation.

The method 200 may include one or more preparation sub-steps in which elements for the SUV configuration and/or rear enclosure assembly are removed from one or more packages, boxes, or containers (e.g., element 11 shown in the previous figures). In some embodiments, the one or more preparation steps may be performed prior to one or more disassembly steps 204, such as during preparation step 202, such that vehicle elements removed from the pickup configuration may be placed into the one or more boxes 11 for storage. Additionally, the one or more preparation steps may be performed prior to one or more assembly steps.

One or more tools may be used during one or more of the installing, assembling, and/or attaching steps 220. For example, such tools may include one or more wrenches, ratchets, screwdrivers or driver bits, trim sticks, suction cups, or similar hand tools. In some embodiments, the tools may be provided as part of a kit associated with the rear enclosure assembly. In other embodiments, the tools may be provided in a tool kit supplied by the vehicle manufacturer. Alternatively, one or more tools may be obtained or supplied by the user performing the conversion or transformation.

In certain embodiments, the tools used during the installing, assembling, and/or attaching steps 220 may be the same as, or different from, the tools used during one or more disassembling steps 204. Advantageously, the conversion process may be performed without requiring tools that permanently alter the structure of the vehicle frame or components, such as welding equipment, cutting tools, grinders, or similar fabrication equipment, thereby preserving the integrity of the original vehicle structure.

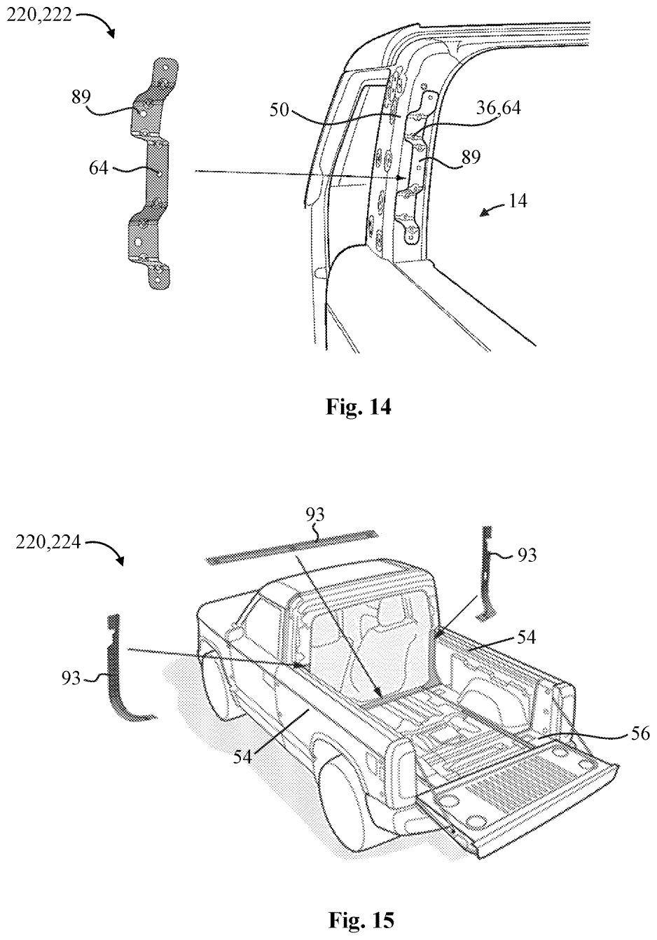

Referring to FIG. 14, the installing step 220 may include one or more steps 222 of installing one or more support brackets 89 to the vehicle frame 14. The one or more support brackets 89 may be configured to provide additional structural reinforcement, load distribution, and/or attachment locations relative to the vehicle frame 14. In some embodiments, the support brackets 89 may be secured to the vehicle frame 14 via one or more frame attachment devices 64 (e.g., threaded fasteners, bolts, weld nuts, clips, or other mechanical fastening interfaces), and may be positioned to supplement or augment existing frame mounting points. In this manner, the support brackets 89 may provide additional or alternative attachment devices 64 for securing one or more structural and/or functional elements to the frame 14 during conversion of the vehicle into another vehicle configuration.

In some configurations, the one or more support brackets may be configured as rigid or semi-rigid members (e.g., stamped metal, cast metal, extruded metal, composite structures, or reinforced polymer components) and may include one or more flanges, ribs, gussets, apertures, slots, or reinforcing features to enhance structural integrity and load-bearing capacity. The brackets 89 may be configured to interface with existing frame geometry, such as contours, rails, pillars, or cross-members, and may be shaped to conform to or mate with such structures. In certain implementations, the brackets 89 may be removable and non-destructively attached to the frame 14, thereby allowing installation and removal without permanent modification of the frame.

For example, a support bracket may be attached to the frame B-pillar 50 to provide additional structural support and/or attachment devices 64 for components of a rear enclosure assembly, such as pillar extensions, roof structures, side panels, or seating components. In other configurations, one or more support brackets may be attached to the frame at one or more bed walls, a bed floor, a rear region of the cockpit area, or any combination thereof. In some embodiments, corresponding brackets may be symmetrically or asymmetrically positioned on opposing sides of the vehicle (e.g., driver-side and passenger-side B-pillars 50) to provide balanced support and alignment for installed components.

In some implementations, the support brackets may further be configured to align, position, or index one or more vehicle components during installation. For example, the brackets 89 may include locating features such as pins, tabs, guides, or keyed interfaces that facilitate proper positioning of components relative to the frame 14. Additionally, the brackets may serve as intermediary mounting structures that decouple certain components from direct attachment to the frame 14, thereby enabling modular assembly, improved tolerance management, and ease of reconfiguration between vehicle configurations.

In certain embodiments, the installation of the support brackets may be performed as part of a reversible and non-destructive conversion process, such that the brackets 89 can be installed, removed, and/or repositioned without cutting, welding, or permanently altering the vehicle frame 14. This may allow the vehicle to be converted between configurations while maintaining structural integrity and enabling restoration to an original configuration if desired.

A support bracket 89 may be configured to provide one or more additional frame fastening devices to the vehicle frame and/or to relocate or reposition one or more existing frame fastening devices to accommodate conversion of the vehicle from one configuration to another.

Referring to FIG. 15, the installing step 220 may include one or more steps 224 of installing one or more sealing or closeout devices 93 at a transition region between a rear portion of the passenger cabin and an adjacent cargo or bed region. In the illustrated configuration, the sealing or closeout devices 93 may be arranged along a perimeter defined by a lower interface (e.g., a floor or bed interface), opposing side interfaces (e.g., pillar regions, side walls, or structural supports), and an upper interface (e.g., a roof panel, header, or cross-member region). In this manner, the sealing or closeout devices 93 may collectively define a continuous or substantially continuous boundary around an opening created by removal of a structural panel, such as a rear bulkhead.

The sealing or closeout devices 93 may include one or more seals, gaskets, trim panels, covers, compressible members, or overlapping structures configured to engage adjacent vehicle components. For example, the devices 93 may be secured to or supported by the vehicle frame, body panels, roll bar assembly, roof panels, or combinations thereof. In some configurations, the sealing or closeout devices 93 may be configured to compress, overlap, interlock, or otherwise cooperate with adjacent structures to accommodate manufacturing tolerances and relative movement between components.

The sealing or closeout devices 93 may function to seal, close out, or otherwise block one or more gaps or voids at the transition region to reduce or prevent intrusion of wind, noise, dust, water, and/or debris into the passenger cabin. Additionally, the sealing or closeout devices 93 may improve acoustic performance, thermal insulation, and overall occupant comfort, while also providing a finished or aesthetically pleasing transition between the passenger cabin and the adjacent cargo or bed region.

In some embodiments, the sealing or closeout devices 93 may include a plurality of distinct components, such as: (i) a lower sealing member extending along a floor or bed interface; (ii) one or more side sealing members extending along opposing vertical regions (e.g., adjacent B-pillars or side wall structures); and (iii) an upper sealing member extending along a roof rail, header, or upper frame cross-member. These members may be separate components or may be combined into a partially or fully continuous sealing structure.

In the illustrated configuration, the lower sealing member may extend laterally across a rear floor or bed interface and may be configured to seal a junction between a bed floor 56 and a forward-facing cabin boundary. The one or more side sealing members may extend upward from the lower sealing member along opposing sides of the vehicle and may be positioned adjacent to, or coupled with, structural features such as B-pillars 50 or side frame rails. The upper sealing member may extend between upper portions of the side sealing members and may be coupled to a roof structure, header, or cross-member to define an upper boundary of the sealed region.

In some configurations, one or more of the sealing or closeout devices 93 may include multi-plane geometries. For example, a side sealing member may include a generally vertical portion and one or more transverse flange portions extending inward or outward relative to the vehicle, thereby enabling engagement with multiple adjacent surfaces. Similarly, the lower sealing member may include a horizontal portion and an upwardly extending lip or flange to interface with adjacent vertical structures. In certain embodiments, one or more of the sealing or closeout devices 93 may be formed as a unitary structure having a U-shaped, O-shaped, or perimeter frame configuration that defines a continuous sealing boundary.

The sealing or closeout devices 93 may be configured to cooperate with adjacent structural or trim components to define a substantially continuous sealing path. For example, the lower, side, and upper sealing members may overlap, abut, or interlock at corner regions to reduce or eliminate discontinuities. In some implementations, corner joints may include overlapping lips, compressible interfaces, or interlocking features to maintain sealing integrity across the perimeter.

The sealing or closeout devices 93 may be formed from one or more materials suitable for sealing and environmental isolation, including elastomeric materials (e.g., rubber, EPDM, silicone), polymeric materials, foam materials, or multi-material constructions. The devices 93 may be compressible and configured to deform when installed between adjacent structures to form a seal. In some embodiments, the devices 93 may be secured via mechanical fasteners, clips, adhesives, sealants, or interference-fit features, and may be removable to permit reconfiguration of the vehicle without permanent modification.

Referring to FIG. 16A, the installing step 220 may include one or more steps 226 of installing one or more floor panels 87-1, 87-2 and one or more sealing or closeout devices 93 within a cargo bed or rear vehicle region.

In the illustrated configuration, the one or more floor panels 87 may be positioned within the bed area of the vehicle to define a substantially continuous load-bearing surface extending across at least a portion of the cargo area. The floor panels 87 may be arranged as a plurality of discrete panel sections that are selectively positioned and secured relative to the vehicle frame 14 and/or relative to one another. In other configurations, a single floor panel 87 may be installed and secured to the vehicle frame 14 via one or more floor panel fastening devices that engage one or more preexisting frame fastening devices 64.

Each floor panel 87 may include one or more structural features, such as ribs, channels, corrugations, stamped reinforcements, or combinations thereof, configured to increase stiffness and load-carrying capability while reducing weight. The floor panels 87 may further include one or more apertures, openings, slots, or interface features configured to receive mechanical fasteners, alignment elements, or other attachment devices for securing the floor panels 87 to the vehicle frame 14, to the sealing or closeout devices 93, and/or to adjacent floor panels 87. The floor panels may be covered in cloth, material, or other layer to provide an aesthetically pleasing appearance.

The one or more sealing or closeout devices 93 may be positioned beneath, between, and/or adjacent to the floor panels 87 and may extend in a longitudinal and/or lateral direction relative to the vehicle. In some embodiments, the sealing or closeout devices 93 may be configured as elongated rails, beams, or cross-members that provide underlying structural support to the floor panels 87 and transfer loads to the vehicle frame 14. In some embodiments, the sealing or closeout devices 93 may additionally or alternatively function as sealing members configured to reduce or prevent intrusion of wind, noise, dust, water, and/or debris into the vehicle.

In certain embodiments, adjacent floor panels 87 may be arranged in an abutting, overlapping, interlocking, or otherwise interfacing configuration to reduce gaps and provide a more continuous surface. For example, edge regions of adjacent floor panels 87 may include stepped features, tongue-and-groove interfaces, mating flanges, or overlapping portions to improve alignment, sealing, and load distribution. In some implementations, one or more sealing or closeout devices 93 may be positioned between adjacent floor panels 87 and/or between the floor panels 87 and surrounding vehicle structures to further reduce intrusion of water, debris, or noise.

The one or more floor panels 87 and/or sealing devices 93 may include one or more floor panel fastening devices and/or sealing fastening devices that are configured to engage one or more frame fastening devices on the vehicle frame or any brackets attached thereto.

The floor panels 87 and the sealing or closeout devices 93 may be formed from one or more materials suitable for structural and/or sealing applications, such as metals (e.g., steel, aluminum), composite materials, reinforced polymers, elastomeric materials, or combinations thereof. In some embodiments, the floor panels 87 may be relatively thin and lightweight while relying on the structural features of the panels 87 and/or the support provided by the sealing or closeout devices 93 to achieve desired strength, rigidity, and durability.

Referring to FIG. 16B, in some configurations, one of the floor panels, such as the forward or front floor panel 87-1′, when arranged in the vehicle position, may include a raised structure 174 that extends partially or entirely across a width of the floor panel 87. The raised structure 174 may be integrally formed with the floor panel 87 or may be a separate component secured thereto (e.g., welded, fastened, bonded, or otherwise attached).

The raised structure 174 defines an elevated support surface relative to adjacent portions of the floor panel 87 and is configured to engage, support, or interface with a portion of a rear vehicle seat assembly (e.g., a seat base, seat frame, mounting bracket, or seat track). In this manner, the raised structure 174 positions the rear seat at a predetermined angle relative to the floor panel 87 and/or vehicle frame.

More specifically, the raised structure 174 may be configured to tilt or elevate a forward portion of the rear seat relative to a rearward portion (or vice versa), thereby orienting the seat base at an inclined angle. This angular positioning may inhibit or reduce a submarine effect, in which an occupant slides forward beneath a seatbelt during a vehicle event. By contrast, if the rear seat were mounted to a substantially planar floor surface without the raised structure 174, the seat may assume a flatter orientation that increases the likelihood of such forward sliding.

The raised structure 174 may include one or more contoured, sloped, stepped, or arcuate surfaces to achieve the desired seat angle. The height, width, and longitudinal position of the raised structure 174 may be selected based on seat geometry, occupant ergonomics, and/or safety requirements. In some configurations, the raised structure 174 may cooperate with one or more seat mounting features (e.g., apertures, studs, threaded inserts, brackets, or rails) to both position and secure the rear seat relative to the floor panel 87.

Accordingly, one or more of the floor panel includes a raised structure 174 defining an elevated support surface relative to an adjacent portion of the floor panel, wherein the seat assembly is supported by the raised structure such that a seat base of the seat assembly is oriented at an angle relative to the adjacent portion of the floor panel, and wherein the angle of the seat base is configured to inhibit forward sliding of an occupant relative to the seat assembly.

Referring to FIGS. 17A and 17B, the installing, assembling, and/or attaching step 220 may include one or more steps 228 of assembling a hoop structure 76 and/or installing or attaching a hoop structure 76 to the vehicle or vehicle frame.

The hoop structure 76 may form part of a roll bar assembly 78 (FIG. 21A).

The hoop structure 76 and/or roll bar assembly 78 may have a circular or substantially circular, O-shaped, hoop-shaped configuration that provides structural support and rigidity to the vehicle when the vehicle is in the SUV configuration. In some configurations, the hoop structure 76 and/or roll bar assembly 78 may have a C-shaped or U-shaped configuration that provides structural support and rigidity to the vehicle when the vehicle is in the SUV configuration.

The hoop structure 76 and/or roll bar assembly 78 may include a generally closed or partially open structural configuration, such as an O-shaped, C-shaped, or U-shaped structure, that provides rigidity and structural support when the vehicle is in the SUV configuration. The hoop structure 76 and/or roll bar assembly 78 may include one or more structural members, such as pillars and one or more cross members (e.g., upper and/or lower cross bars), that cooperate to form a load-bearing framework.

The hoop structure 76 and/or roll bar assembly 78 may be configured to interface with one or more preexisting frame fastening devices and/or structural regions of the vehicle to define one or more load paths. For example, loads imparted on the hoop structure 76 and/or roll bar assembly 78 during vehicle operation, cargo loading, or crash events may be transferred through the assembly and into the frame, chassis, or other load-bearing members. The hoop structure 76 and/or roll bar assembly 78 may further provide attachment interfaces for components such as rear enclosure panels, roof panels, seats, and/or accessories, while maintaining structural alignment and reducing deflection or vibration.

In some configurations, the hoop structure 76 and/or roll bar assembly 78 may enhance structural integrity of the vehicle and contribute to occupant protection during events such as impacts or rollover conditions. For example, the assembly may be configured to resist deformation and maintain a survival space within the passenger compartment by distributing vertical, lateral, and/or torsional loads away from the occupant area and into the vehicle frame. The assembly may also cooperate with other vehicle systems, such as floor structures, seats, and restraint systems, to transfer occupant loads in a controlled manner.

The geometry, material selection, attachment locations, and load paths of the hoop structure 76 and/or roll bar assembly 78 may be engineered to achieve target performance criteria associated with applicable safety standards (e.g., FMVSS relating to roof strength, rollover protection, and occupant safety). In this manner, the assembly may enable a reconfigured vehicle to maintain or achieve safety performance comparable to vehicles originally manufactured to comply with such standards, without requiring permanent modification of the underlying frame.

The disclosed hoop structure 76 and/or roll bar assembly 78 may be distinguished from conventional aftermarket or user-installed roll bars that are primarily decorative, minimally structural, and/or not designed or validated to meet applicable safety standards. For example, certain bolt-on roll bars may be secured only to non-structural body panels or localized mounting points and may not provide defined load paths capable of transferring crash or rollover loads into the vehicle frame. Other systems may rely on welding, cutting, or permanent modification of the vehicle structure or frame to achieve structural performance; however, such systems may still not be engineered, validated, or certified to satisfy rollover, roof strength, or occupant protection requirements. Moreover, systems that rely on such permanent modifications are not reconfigurable back to another vehicle configuration upon removal, as the vehicle frame may be compromised by the welding, cutting, or other permanent alterations.

In contrast, the disclosed hoop structure 76 and/or roll bar assembly 78 is configured as a bolt-on system that interfaces with preexisting frame fastening devices and/or reinforced structural regions of the vehicle that are intended and configured to provide defined load paths and structural performance consistent with applicable safety standards without requiring permanent modification of the vehicle.

The hoop structure 76 and/or roll bar assembly 78 described herein may be configured as a bolt-on, non-permanently attached system that interfaces with preexisting frame fastening devices and/or reinforced structural regions of the vehicle, while still providing a structurally integrated, load-bearing framework. The assembly may include defined attachment interfaces, reinforcement features, and structural members configured to distribute and transfer loads associated with crash events, rollover conditions, and occupant restraint forces in a predictable manner.

Accordingly, the disclosed assembly may provide structural and safety performance consistent with applicable safety standards while avoiding the need for welding, cutting, or other permanent alteration of the vehicle frame. This configuration distinguishes the disclosed system from both non-engineered bolt-on roll bars that lack structural performance and welded systems that require permanent modification of the vehicle.

The hoop structure 76 and/or roll bar assembly 78 may further support one or more accessories or auxiliary systems. For example, the hoop structure and/or roll bar assembly may support a roof rack, cargo carrier, lighting assemblies, antennas, sensors, or other equipment. Loads associated with such accessories may be transmitted through the hoop structure and into the vehicle frame or other structural members via one or more mounting locations.

The hoop structure 76 and/or roll bar assembly 78 may be structurally integrated with one or more seating components, such as one or more rear passenger seats. For example, one or more seat brackets or supports may be coupled to a portion of the hoop structure 76 (e.g., the lower cross bar and/or one or more pillars), such that loads associated with the seating system (e.g., occupant loads during normal operation or crash conditions) are transferred through the hoop structure 76 and into the vehicle frame.

One or more seat brackets or supports may be coupled directly or indirectly to the vehicle frame (e.g., via one or more seat brackets, lower cross bar, etc.) such that loads associated with the seating system (e.g., occupant loads during normal operation or crash conditions) are transferred directly to the vehicle frame. This arrangement may provide a robust and direct load path between the seating system and the vehicle frame. In other configurations, the loads associated with the seating system (e.g., occupant loads during normal operation or crash conditions) are transferred directly to the vehicle frame, or a rear portion of the vehicle frame via the one or more preexisting frame fastening devices, the lower cross bar, seat brackets, or a combination thereof.

The hoop structure 76 and/or roll bar assembly 78 may cooperate with one or more additional structural members, such as longitudinal rails, cross members, floor panels, bed walls, or vehicle pillars, to form a reinforced structural framework. Such a framework may increase torsional rigidity of the vehicle, improve durability, and reduce noise, vibration, and harshness (NVH) characteristics.

The hoop structure 76 and/or elements of the roll bar assembly 78 may be formed from materials similar to those used for the vehicle frame (e.g., high-strength steel), or from other suitable structural materials (e.g., aluminum alloys, composite materials, or combinations thereof). The materials, geometry, and attachment configuration of the hoop structure 76 and/or roll bar assembly 78 may be selected to achieve desired strength, stiffness, weight, and energy management characteristics.

The hoop structure 76 may comprise a pair of spaced-apart upright pillars 80, an upper cross bar 82, and a lower cross bar 84. The upper cross bar 82 may be attached or connected to upper regions of the two pillars 80, and the lower cross bar 84 may be attached to lower regions of the two pillars 80. When installed on the vehicle in the SUV configuration, the upright pillars 80 may function as, or form, the C-pillars of the vehicle.

In some configurations, the lower cross bar 84 may be omitted, such that the hoop structure 76 has a C-shaped or U-shaped configuration. In some configurations, the lower cross bar 84 may be attached to the frame of the vehicle and not to one or both of the pillars 80.

For example, in some configurations, the pillars 80 may be attached or secured to the frame via one or more preexisting frame fastening devices that are accessible through the one or more floor panels. The lower cross bar 84 may also be attached or secured to the frame via one or more preexisting frame fastening devices that are accessible through the one or more floor panels. The lower cross bar 84 may be attached to one or more both of the pillars 80. In some configurations, the lower cross bar 84 may not be directly attached or fastened to one or both of the pillars 80.

The lower cross bar 84 may be positioned rearward of one or both of the pillars 80 in vehicle position.

The lower cross bar 84 may be positioned forward of one or both of the pillars 80 in vehicle position.

The lower cross bar 84 may be aligned with one or both of the pillars 80 in vehicle position.

The hoop structure 76 may be partially or entirely preassembled when obtained by the customer or installer or before installing or attaching to the vehicle or vehicle frame or to one or more frame fastening devices. In a preassembled configuration, the elements of the hoop structure 76 may be connected via one or more removable fasteners (e.g., bolts) and/or via one or more permanent fasteners (e.g., welding). The hoop structure 76 may be preassembled by the rear enclosure assembly supplier and/or by the user. Alternatively, the hoop structure 76 may be built up or assembled onto the vehicle frame as individual elements or sub-assemblies.

The one or more frame fastening devices to which the hoop structure 76 may be secured may be located in the rear floor 56 of the frame, the bed walls or rails, and/or other regions or structural portions of the vehicle frame. The one or more frame fastening devices may be accessible through one or more openings defined in the one or more rear floor panels. The one more openings may be in one or more of the replacement floor panels. The one or more openings may be covered by one or more caps or plugs or knock-outs that must be removed in order to gain access to frame and/or one or more of the frame fastening devices.

For example, the two pillars 80 may be installed or attached to the vehicle or vehicle frame via one or more fasteners that engage one or more frame fastening devices, followed by installation of the upper cross bar 82 and then the lower cross bar 84. In other embodiments, the pillars 80 may be installed first, followed by the lower cross bar 84 and then the upper cross bar 82. In still other configurations, the lower cross bar 84 may be installed first, followed by installation of the pillars 80 and then the upper cross bar 82.

The method step 228 may include arranging or positioning the upright pillars 80 of the hoop structure 76 in the rear region of the vehicle frame (e.g., in the bed or cargo area 58 of the vehicle when the vehicle is in the pickup truck configuration). The step 228 may comprise arranging or positioning the pillars 80 between the walls or rails of the cargo area 58. The pillars 80 may be arranged or positioned upright and in between the rear wheel humps 86 of the vehicle.

In another configuration, one or both of the pillars 80 may be arranged or positioned forward or behind the rear wheel humps 86 in vehicle position. In another configuration, one or both of the pillars 80 may be arranged or positioned on top of the rear wheel humps 86 in vehicle position.

The hoop structure 76 may comprise one or more hoop structure fasteners 88. The one or more hoop structure fasteners 88 may engage, cooperate, or co-act with one or more frame fastening devices 64 to attach or connect the pillars 80 or hoop structure 76 to the vehicle frame 14.

For example, some of the hoop structure fasteners 88 may be located at bottom regions of the pillars 80 and/or the lower cross bar 84 to connect or attach to frame fastening devices 64 in the rear floor 56 of the frame or vehicle. The rear floor 56 of the frame or vehicle may be reinforced in this region to provide better support or more strength and rigidity in the region where the hoop assembly is installed. For example, the sheet metal may be reinforced or thickener in this region. Additionally or alternately, one or more brackets, cross bars, or other reinforcing structure may be provided at the rear floor 56 in this region to support the pillars and/or the hoop structure 76.

The frame fastening devices 64 located in the rear floor 56 of the frame may include one or more attachment features such as threaded bores, openings, weld nuts, posts, projections, or bolts. The hoop structure fasteners 88 may include one or more corresponding fasteners, such as bolts or other threaded fasteners, configured to cooperate with the frame fastening devices 64 to secure the hoop structure to the frame. In some configurations, one or more threaded bores, openings, or weld nuts may be provided on one or more elements of the hoop structure to receive the hoop structure fasteners 88.

The one or more pillars 80 may be attached to the one or more frame fastening devices located in the floor of the vehicle, in one or both of the side walls or bed walls of the vehicle, to top surfaces of one or more of the side walls or bed walls of the vehicle, to the one or more wheel humps, or any combination thereof.

The method may include a step of removing one or more bolts from threaded bores, openings, or weld nuts located in the floor 56 and subsequently using the removed bolts to secure the pillars, the lower cross bar, and/or the hoop structure to the floor 56. In some configurations, the vehicle may include one or more fasteners that are preinstalled in corresponding frame fastening devices in the floor and are configured to be removed and reused to secure the hoop structure to the vehicle frame.

Alternatively, the one or more bolts may be provided with the hoop structure for attaching to the rear floor 56 or vehicle frame.

In some configurations, the rear floor 56 of the frame may not include pre-formed fastening devices 64. In such configurations, installation instructions for the hoop structure or roll bar assembly may include a template or indicate one or more locations on the rear floor 56 or rear floor panel where holes may be drilled or knocked out to receive fasteners for securing the hoop structure or roll bar assembly to the floor. In some implementations, the drilling of such holes in the rear floor 56 does not prevent the vehicle from being subsequently returned to a pickup-truck configuration.

The hoop structure 76 may include one or more first attachment interface or first flanges or brackets 90, which may also be referred to as upper flanges or brackets 90. The first attachment interface or one or more upper flanges or brackets 90 may be configured to attach or connect the pillars 80 and/or the hoop structure 76 to the vehicle frame, such as to the one or more bed walls or rails 54. In some configurations, the one or more upper flanges or brackets 90 may be attached to outward-facing surfaces of the pillars 80. One or more hoop structure fasteners 88 may secure the one or more upper flanges or brackets 90 to corresponding frame fastening devices 64 located on the bed walls 54, for example at or near a top surface 92 of the bed walls 54 of the vehicle frame. In some configurations, the one or more hoop structure fasteners 88 may extend through bores in the one or more upper flanges or brackets 90 and into the bed walls or rails 54 to secure the pillars 80 and/or hoop structure 76 to the vehicle frame.

The hoop structure 76 may include one or more second attachment interfaces or second flanges or brackets 94, which may also be referred to as lower flanges or brackets 94. The one or more second attachment interfaces or lower flanges or brackets 94 may be positioned below the one or more first or upper flanges or brackets 90 when installed on the vehicle. The one or more lower flanges or brackets 94 may function to attach or connect the pillars 80, the lower cross bar 84, and/or the hoop structure 76 to the vehicle frame, such as to the floor 56 of the frame.

The one or more lower flanges or brackets 94 may be attached to forward-facing surfaces or regions of the pillars 80, for example via one or more fasteners. In some configurations, the one or more lower flanges or brackets 94 may also be attached to the lower cross bar 84. One or more hoop structure fasteners 88 may secure the one or more lower flanges or brackets 94 to corresponding frame fastening devices 64 located in the rear floor 56 of the vehicle frame to attach the pillars 80, the lower cross bar 84, and/or the hoop structure 76 to the floor 56 or vehicle frame.

The one or more lower flanges or brackets 94 may include one or more lower cross bar openings 96 through which the lower cross bar 84 may extend. The openings 96 and/or the lower cross bar 84 may have anti-rotation features (e.g., one or more flat surfaces and/or may be located or fastened together) to prevent movement of the lower cross bar 84.

The one or more lower flanges or brackets 94 may serve to attach the one or more pillars to the frame or floor of the vehicle, to attach the lower cross bar to the one or more pillars, to attach the lower cross bar to the vehicle frame or floor, or any combination thereof.

In some configurations, one or both of the flanges or brackets (the upper, the lower, or another flange or bracket) may attach one or both of the pillars to an inside wall of the bed walls and/or to the wheel humps 86 and/or a top or near a top surface of the bed walls.

One or more of the upper and lower brackets may be stampings or formed of sheet metal. One or more of the upper and lower brackets may be attached to the pillars via welding, removable fasteners, or both. In some configurations, one or more of the upper and lower brackets may be integrally formed with one or more of the pillars.

The upper and lower brackets or the first and second attachment interfaces couples to the preexisting frame fastening devices may function to transfer structural loads to the vehicle frame, into the bed walls and/or the rear floor of the vehicle frame and/or to vehicle frame.

In some configurations, the lower cross bar 84 may be removed, separated, or omitted from the hoop structure. In some configurations, the lower cross bar 84 may be separately installed in the vehicle after the pillars and upper cross bar are installed in the vehicle. In some configurations, the lower cross bar 84 may be separately installed in the vehicle after the pillars and upper cross bar are installed in the vehicle and not directly connected to either of the pillars. Instead, in some configurations, the lower cross bar may be secured to the vehicle frame.

In some configurations, electrical or other conductive wiring or connectors may pass from the driver side to the passenger side (or vice versa) through, under, or over the lower cross bar and/or the upper cross bar. In some configurations, electrical or other conductive wiring or connectors may pass from the driver side to the passenger side (or vice versa) through, under, or over one or more of the pillars. In some configurations, electrical or other conductive wiring or connectors or plugs may be provided in the one or more pillars, cross bars (upper and/or lower), for connecting or attaching electrical components to the vehicle, such as seat belt or seat sensors, auxiliary power or communication outlets (e.g., USB), lighting, or a combination thereof.

In some configurations, the lower cross bar 84 may be secured to the vehicle or frame before the pillars are attached or secured to the vehicle frame or lower cross bar.

One or both of the pillars 80 may have a square, rectangular, circular, or other cross-sectional shape. Similarly, the upper cross bar 82 and/or the lower cross bar 84 may have square, rectangular, circular, round, or other cross-sectional shapes. In some configurations, the cross-sectional shapes of the pillars 80, the upper cross bar 82, and the lower cross bar 84 may be the same, while in other configurations one or more of these components may have different cross-sectional shapes.

One or both of the pillars 80 may be substantially straight. In other configurations, one or both of the pillars 80 may include one or more bends along an upright portion thereof. For example, lower regions of the pillars 80 may be spaced closer together than upper regions of the pillars 80. In some configurations, the narrower spacing at the lower regions may accommodate structural features of the vehicle, such as wheel humps 86. Accordingly, starting from the rear floor 56, the pillars 80 may extend upwardly and bend outwardly such that upper regions of the pillars are spaced farther apart than the lower regions.

Accordingly, each of the pillars 80 includes a first attachment interface coupled to at least one of the plurality of preexisting frame fastening devices at or near a top surface of the bed walls; and a second attachment interface coupled to at least one of the plurality of preexisting frame fastening devices at the rear floor. The hoop structure 76 and/or the roll bar assembly 78 functions to or is configured to protect occupants during a rollover condition of the vehicle.

Accordingly, each of the pillars include a lower region, an upper region, and a bend along an upright portion thereof between the lower region and the upper region such that the pillar extends outwardly as the pillar extends upwardly. In vehicle position, the lower regions of the opposing pillars are spaced closer together than the upper regions of the opposing pillars.

The hoop structure 76 may include one or more rear seat belt devices 98. The one or more seat belt devices 98 may include seat belt hardware such as a belt, retractor mechanism, latch, buckle, or other restraint components, one or more sensors, at least a portion of which may be secured to one or more pillars 80 of the hoop structure 76. In some configurations, the one or more seat belt devices 98 may be configured to cooperate with a rear vehicle seat when the rear seat is attached to the hoop structure 76, the lower cross bar 84, one or more latches 100, or a combination thereof.

The hoop structure 76 may include one or more rear seat latching devices 100. A rear seat latching device 100 may be secured to one or both of the pillars 80. The rear seat latching device 100 may include a latch, hook, projection, protuberance, or other engagement feature. In some configurations, the rear seat latching device 100 may engage a seat back frame of one or more rear passenger seats to secure the rear seats to the hoop structure 76, the roll bar assembly 78, and/or the vehicle frame.

The step 220 may include tightening, securing, or torquing the one or more hoop structure fasteners 88 relative to the one or more frame fastening devices 64 to a predetermined or recommended tightness to secure the hoop structure to the vehicle frame.

One or more of the attaching steps may include tightening one or more fasteners to a predetermined or specified torque value. In some embodiments, the torque value may be selected based on one or more factors such as fastener size, thread pitch, material properties, joint stack-up, and/or anticipated load conditions (e.g., occupant loads, crash loads, and/or rollover loads).

Applying the specified torque may help establish a desired clamping force at the interfaces between the seating structure, the roll bar assembly, hoop structure, and the vehicle frame, thereby promoting reliable load transfer through defined structural load paths. In particular, loads imparted on the rear passenger seats (e.g., during normal use or a crash event) may be transferred directly into the vehicle frame via the preexisting fasteners, rather than being carried through non-structural body panels or dependent on the roll bar assembly or hoop structure as primary load-bearing pathways.

In some configurations, the torque requirements may be selected to meet or correspond with applicable safety, durability, and/or performance standards, such as rollover, roof strength, or occupant protection requirements. The specified torque values may be provided in installation instructions or service documentation and may be achieved using torque-controlled tools. In certain embodiments, one or more verification steps may be performed (e.g., torque audits, re-torque procedures, or use of torque-indicating features) to confirm that the intended clamping force and structural performance are achieved. Such audits may be performed via one or more sensors in the vehicle or at a service location.

With specific reference to FIGS. 18A and 18B, the second flange or bracket 94 may have a generally triangular shape. In other continuants, the second flange or bracket 94 may have a square, rectangle, oval, or oblong shape.

The second flange or bracket 94 may have a first or rear end 95 that is attached with one or more fasteners to a pillar 80; a middle region 97 having an opening 96 through which an end 85 of the lower cross bar 84 may extend; and an upper region 99 that is attached with one or more fasteners to a seat frame 101 of the rear vehicle seat.

The second flange or bracket 94 may extend in two planes and comprise a horizontal component 103 and a vertical component 105. The vertical component 105 may include the triangular shape with the rear end, middle region, and upper regions. The horizontal component 103 may be fastened to the frame or floor to attach the brackets and the hoop structure to the frame.

The hoop structure 76 and/or the roll bar assembly may include one or a plurality of the second flanges or brackets 94 for attaching the hoop structure to the floor, frame, pillars, and/or seats. However, in some configurations, only the outboard brackets 94 may be attached to the pillars 80. Any brackets 94 inboard or between the outboard brackets 94 can be attached to the seat frame 101 and the floor or frame of the vehicle.

Referring now to FIGS. 19A, 19B, and 19C, in some configurations, the hoop structure 76 may comprise the two pillars 80 and the upper cross bar 82 connected to the upper ends of the pillars 80. The hoop structure 76 may thus have a C-or U-shaped configuration. In this configuration, the hoop structure 76 may be free of the lower cross bar that was shown in the previous figures.

The lower portions or feet 109 of the pillars 80 may be secured to the frame via one or more hoop structure fastening devices 88 that engage one or more frame fastening devices 64 on the vehicle frame. lower portions or feet 109 of the pillars 80 may be arranged between the opposing bed walls 54 and/or the wheel humps of the vehicle.

One or both of the pillars 80 may comprise a seat belt device 98 comprising a retractor 83 fixed or attached thereto. An end of the seat belt device may be attached (at least temporarily) to the pillar 80 during transit and/or installation.

Referring now to FIGS. 20A and 20B, the lower cross bar 84 is illustrated as a separate structural member of the hoop structure and is positioned within a lower region of the vehicle, such as along a floor or bed interface. As shown, the lower cross bar 84 is secured to the vehicle frame via one or more hoop structure fastening devices 88 that engage corresponding frame fastening devices 64. In the illustrated configuration, the lower cross bar 84 is structurally independent from the pillars 80 and the hoop assembly and may be free of any direct mechanical attachment to either or both of the pillars 80. This independent mounting configuration may allow the lower cross bar 84 (and optionally any structure directly or indirectly attached to it, such as one or more vehicle seats) to transfer loads directly into the vehicle frame and/or bed structure without relying on the pillars 80. In some implementations, the lower cross bar 84 may be secured to one or more bed side walls, a floor panel, or other structural portions of the vehicle frame.

As further illustrated, the lower cross bar 84 may include one or more lower flanges or brackets 94 positioned at opposing ends and/or intermediate locations along the lower cross bar 84. The flanges or brackets 94 may be configured to interface with the vehicle frame and may include apertures or openings for receiving the hoop structure fastening devices 88. In some embodiments, the lower cross bar 84 may further support one or more seat belt buckles 111, each configured to receive and retain a corresponding seat belt latch plate. For example, a seat belt buckle 111 may be mounted to the lower cross bar 84 via a bracketed interface or integrated mounting feature, such that occupant restraint loads are transferred through the lower cross bar 84 into the vehicle frame. In this manner, the lower cross bar 84 may function both as a structural reinforcement member and as a mounting structure for one or more occupant restraint components.

The lower cross bar 84 may be situated forward of the pillars of the hoop assembly in vehicle position.

Referring to FIGS. 21A and 21B, the assembling step and/or attaching step 220 may include a step 230 of installing or attaching opposing longitudinal frame rails 102 to the hoop structure 76 and vehicle frame. The opposing frame rails 102 may be part of the roll bar assembly 78.

Each frame rail 102 may comprise one or more structural elements that extend between a front end 104 and a rear end 106 and have a middle region 108 therebetween.

One or more frame rail fastening devices may engage, cooperate or co-act with one or more frame fastening devices of the vehicle frame to attach or connect the frame rails 102 to the vehicle frame. The one or more frame rail fastening devices may cooperate or co-act with one or more hoop structure fastening devices to attach or connect the frame rails 102 to the hoop structure 76.

The one or more longitudinal rails 102 may be attached to the hoop structure such that loads are distributed between the longitudinal rails and the hoop structure and ultimately to the vehicle frame.

One or more frame rail fastening devices may cooperate with one or more frame fastening devices to attach or connect the front end 104 of the frame rails 102 to the B-pillar 50 and/or to the cross rail 51 and/or a flange or supporting bracket (e.g., bracket 89 at FIG. 14) attached to the B-pillar 50 (a forward attachment location). One or more frame rail fastening devices may cooperate with one or more hoop structure fastening devices to attach or connect the middle region 108 of the frame rails 102 to hoop structure 76, pillars 80, and/or upper cross bar 82.

The rear end 106 of the frame rail 102 may be received in a pocket or slot 110 defined in a rear region of the vehicle frame (a rear attachment location). In some configurations, the pocket or slot 110 may be formed in one or more of the bed walls or rails 54 and/or the rear floor 56 of the vehicle frame. One or more frame-rail fastening devices may secure the rear end 106 of the frame rail 102 within the pocket or slot 110. After installation in the pocket or slot 110, the rear end 106 of the frame rail 102 may form or define a D-pillar of the vehicle when the vehicle is configured in an SUV configuration. The pocket or slot 110 in the frame 14 can be seen in FIG. 2, FIG. 44, FIG. 45, FIG. 46, etc. The pocket or slot 110 may be an opening, pocket, slot, receptacle defined in a bed wall and inboard of the top surface of the bed wall. In some configurations, the pocket or slot 110 may be a stake pocket that is defined in a top surface of the bed wall. In other configurations, the pocket or slot 110 may be located inboard of such stake pockets.

The one or more frame rails 102 may include one or more airbags or curtain airbags. The one or more airbags or side curtain airbags may provide a possible soft restraint for backseat passengers in the event of a vehicular accident, such as side impact. In some configurations, an airbag or curtain airbag may be provided in one or more of the pillars, upper cross bar, and/or interior trim panels described below.

One or more elements of the roll bar assembly 78 (e.g., the frame rails 102 and/or the hoop structure 76) may include electrical wiring, one or more wiring harnesses, and/or one or more electrical connectors. For example, the electrical wiring, harnesses, and/or connectors may be located or routed in, on, or beneath the upper cross bar 82, the lower cross bar 84, one or both pillars 80, and/or one or both frame rails 102. In some configurations, the electrical wiring, harnesses, and/or connectors may be located on the passenger side and/or the driver side of the vehicle. The electrical wiring, harnesses, and/or connectors may be configured to connect with existing wiring of the vehicle 10 to supply electrical power to the rear enclosure assembly 38. Additionally or alternatively, the electrical wiring, harnesses, and/or connectors may communicate with a vehicle controller to indicate that the roll bar assembly and/or rear enclosure assembly is installed in the vehicle. In some configurations, the electrical wiring, harnesses, and/or connectors may electrically couple one or more airbags, seat belt systems, lights, sensors, speakers, and/or other electrical devices to the vehicle controller. In some configurations, the electrical wiring, harnesses, and/or connectors may provide electrical and/or power outlets to a rear portion of the vehicle.

The step 230 may include tightening or torquing the one or more frame rail fasteners to the one or more mating fastening devices to a predetermined or recommended tightness to structurally and rigidly connect the frame rails 102 to the frame 14 and/or hoop structure 76.

Referring to FIGS. 22A and 22B, the assembling step and/or attaching step 220 may include one or more steps 232 of installing or attaching one or more interior panels or side-impact energy absorbers 110 to one or more frame fastening devices and/or structural portions of the vehicle, such as the side walls 54 of the vehicle frame, the roll bar assembly 78, the B-pillar 50, and/or the floor 56.

The one or more interior panels or side-impact energy absorbers 110 may include or support one or more interior features such as an armrest 112, grab handle 114, hip bolster 115, and/or cup holder 116. In some configurations, the one or more interior panels 110 may include or support an airbag. The one or more interior panels 110 may be secured to the vehicle frame, roll bar assembly 78, B-pillar 50, floor 56, or other vehicle structures via one or more interior-panel fastening devices that cooperate with corresponding fastening structures of the vehicle frame or roll bar assembly. In some configurations, the interior panels 110 may function as side-impact energy absorbers. For example, the interior panels 110 may include structures configured to absorb impact energy and thereby reduce forces transmitted to rear-seat occupants during a side-impact event.

The one or more interior panels or side impact energy absorbers 110 may include one or more latches 100 (e.g., a first latch component). The one or more latches 100 may be connected to the side wall of frame or pillar or roll bar assembly.

Referring to FIGS. 23A, 23B, 23C, and 23D the assembling step and/or attaching step 220 may include one or more steps 234 of installing or attaching one or more rear passenger seats 118 in or to the vehicle, vehicle frame, hoop structure 76, and/or roll bar assembly 78. The one or more rear passenger seats are structurally supported by the hoop structure 76, roll bar assembly 78, and/or vehicle frame.

The one or more rear passenger seats 118 may be a bench seat, a 60/40 split seat, a 40/20/20 split seat, or two or more captain chairs with or without a space for a rear console or walkway therebetween. The one or more vehicle seats 118 may include a seat back having a seat back frame 120 and a seat bottom 122.

The seat back frame 120 may be connected to the roll bar assembly 78 and/or one or more pillars 80 and/or the lower cross bar via one or more seat fasteners.

The seat back frame 120 may be secured to one or more lower flanges or brackets 94. The seat back frame 120 may be attached or secured to the lower flange or brackets 94 via one or more rear seat fasteners 124.

In some configurations, the seat back frame 120 may also or may instead be coupled to the rear seat latching device 100, which may be secured to the pillars 80 and/or lower cross bar. The seat bottom 122 may be connected to the seat back frame 120, the floor 56, lower cross bar, and/or the roll bar assembly 78 via one or more seat fastening devices.

The one or more lower flanges or brackets 94 may be connected or attached to the floor 56, the frame of the vehicle, to the roll bar assembly 78, one or both of the pillars 80, and/or to the lower cross bar 84.

The one or more rear passenger or vehicle seats 118 may be configured for attachment, directly or indirectly, to the roll bar assembly 78, such as to one or more flanges or brackets 94 and/or the lower cross bar. The one or more rear passenger seats 118 may be coupled to the roll bar assembly 78 via one or more brackets fixed to the lower cross bar such that loads from the one or more rear passenger seats 118 are transferred into the hoop structure, roll bar assembly, and/or vehicle frame.

A seat back of the one or more rear passenger seats may be coupled to at least one of the pillars via one or more latching components or devices. The one or more rear passenger seats 118 may include a latching component or device 103 associated with the rear seat frame that is configured to interconnect with the side-impact energy absorber 110 and/or a latch 100 of the roll bar assembly. The latch component or device 103 and the latch 100 cooperate to secure the seat back 120 in an upright position.

If the seat back 120 is not properly latched to the latch 100, the seat back 120 may be permitted to fold, move, or pivot forward relative to the seat bottom 122. For example, referring to FIG. 23A, the seat back 120 may be biased forward by a spring or other biasing element such that, in an unlatched condition, the seat back 120 automatically folds or pivots toward or into contact with the seat bottom 122.

When the seat back 120 is properly latched to the latch 100, the biasing force is resisted, and the seat back 120 is retained in a substantially upright orientation. Conversely, if the latch 100 is disengaged or improperly connected, the biasing element forces or causes the seat back 120 to pivot forward toward the seat bottom 122.

This automatic forward movement of the seat back 120 provides a passive visual and/or mechanical indication that the seat back 120 is not properly latched. In this manner, the arrangement may function as a poka-yoke mechanism that reduces the likelihood of improper installation or incomplete latching of the seat back 120.

The seat bottom 122 may include one or more latches or catches to attach to the lower cross bar, the roll bar assembly, frame, pillar, side wall, etc. This may prevent or reduce the seat bottom from submarining or diving forward during an aggressive braking event or front impact. This may be in addition to, or instead of, the raised structure 194 on the floor panel that is illustrated and described at FIG. 16B above.

Referring now to FIG. 24, the assembling step and/or attaching step 220 may include one or more steps 236 of attaching or installing one or more rear enclosure panels of the rear enclosure assembly to the vehicle 10, the vehicle frame 14, and/or the roll bar assembly 78. The one or more rear enclosure panels may include one or more rear side panels 126.

The one or more rear side panels 126 may include one or more rear side panel fastening devices. The rear side panel fastening devices may be configured to cooperate or co-act with one or more corresponding frame fastening devices and/or roll bar fastening devices to attach and secure the rear side panels 126 to the vehicle 10. For example, the rear side panels 126 may be secured to the frame 14, the roll bar assembly 78, one or both longitudinal rails 102, one or more B-pillars, one or more brackets associated with the B-pillars, or a combination thereof.

A side panel 126 may extend substantially along a corresponding side of the vehicle 10. For example, a side panel 126 may extend from a region adjacent a B-pillar in a rearward direction toward a rear portion of the vehicle, such as a region proximate rear tail lights, a rear fender region, and/or a D-pillar region defined by one or more of the longitudinal rails 102. In some configurations, the side panel 126 may be formed as a unitary structure. In other configurations, the side panel 126 may include two or more panel portions that are coupled together. The one or more side panels 126 may extend along, cover, and/or attach to the vehicle frame 14 in a region where one or more B-pillar covers or appliques were previously positioned and subsequently removed.

The one or more side panels 126 may define a substantially continuous outer surface along the side of the vehicle 10. In some configurations, a side panel 126 may be substantially solid and free of openings. In other configurations, a side panel 126 may include one or more openings, such as one or more window openings, vent openings, access openings, or a combination thereof.

Each side panel 126 may be formed from a suitable material. For example, the side panel 126 may be formed from a plastic or polymeric material (e.g., similar to materials used for front and/or rear fenders and/or door panels and/or hood panel). In other configurations, the side panel 126 may be formed from a flexible material, such as a canvas or fabric material, for example in a soft-top or soft-side configuration.

Referring briefly to FIG. 25B, in some configurations, one or more B-pillar panels or appliques 30 removed from the vehicle during step 206 may be reused as one or more D-pillar panels or appliques 30′. The one or more panels or appliques 30, 30′ may be attached to the one or more side panels 126 and/or to one or more elements of the roll bar assembly 78. In other configurations, a D-pillar cover or applique may be integrally formed with the side panel 126.

Referring now to FIGS. 25A, 25B, and 25C, the one or more rear enclosure panels may include one or more rear panels 128 and/or one or more roof panels 128. The assembling step and/or attaching step 220 may include one or more steps 238 of attaching or installing the one or more rear and/or roof panels 128 to the vehicle 10, the frame 14, the roll bar assembly 78, one or more longitudinal rails 102, one or more side panels 126, or any combination thereof.

The one or more roof panels 128 may include one or more roof panel fastening devices. The one or more roof panel fastening devices may be configured to cooperate or co-act with one or more corresponding frame fastening devices, roll bar fastening devices, and/or side panel fastening devices to attach and secure the one or more roof panels 128 to the vehicle 10, the frame 14, the roll bar assembly 78, the longitudinal rails 102, the side panels 126, or any combination thereof.

The one or more roof panels 128 may be formed from a suitable material. For example, the roof panels 128 may be formed from a plastic or polymeric material (e.g., similar to materials used for front and/or rear fenders). In other configurations, one or more of the roof panels 128 may be formed from a flexible material, such as a canvas or fabric material, for example in a soft-top configuration.

In some configurations, one or more of the roof panels 128 may include a sunroof or moonroof panel configured to be repositioned to allow additional air and/or light to enter the vehicle. One or more of the roof panels 128 may be rigid panels or structures, while one or more of the roof panels 128 may be flexible, tarp-like materials that can be rolled, folded, or otherwise repositioned to provide an open-top configuration.

In some configurations, one or more of the roof panels 128 may include one or more panels that were removed from an upper portion of the vehicle in the pick-up truck configuration 12, for example during steps 208 and/or 210. One or more of the roof panel fastening devices previously used to attach such panels in the pick-up truck configuration may be reused to attach the one or more roof panels 128 to the vehicle 10, the frame 14, and/or the roll bar assembly 78.

One or more of the roof panels 128 may be selectively removable from the vehicle 10 and/or the rear enclosure assembly to provide an open-air configuration (e.g., a safari mode). For example, one or more of the roof panels 128 may include one or more attachment devices, such as levers, latches, cam locks, and/or quarter-turn fasteners, configured to selectively lock and unlock the roof panels relative to the frame 14 and/or the roll bar assembly 78 to facilitate installation and removal of the roof panels.

One or more roof rails 176 may be attached to the one or more roof panels 128. For example, a roof rail 176 may be configured to support, secure, and/or attach cargo to an upper portion of the rear enclosure assembly 60 and/or the one or more roof panels 128.

The one or more roof rails 176 may be coupled to the roof panels 128 via one or more roof panel fastening devices 178 defined in the roof panels 128. The roof panel fastening devices 178 may be configured to cooperate or co-act with corresponding structural elements of the vehicle, such as one or more portions of the roll bar assembly 78, one or more longitudinal rails 102, and/or other structural members, to transfer loads from the roof rails 176 through the roof panels 128 to the underlying vehicle structure.

In some configurations, the roof rails 176 may be directly attached to the roof panels 128. In other configurations, the roof rails 176 may be indirectly coupled to the roof panels 128 via the roof panel fastening devices 178 such that loads applied to the roof rails 176 are distributed across the roof panels 128 and into the vehicle frame.

The one or more roof rails 176 may extend partially or entirely along a length of the roof panel 128.

Referring now to FIG. 26, the assembling step and/or attaching step 220 may include one or more steps 240 of attaching or installing the halo and backlight frame 74 to a back of the rear enclosure assembly 60. The halo and backlight frame 74 may comprise one or more of the same components that was/were previously removed or disassembled from the frame 14 at an upper and/or rear portion of the vehicle cockpit 52, for example during method steps 212, 214, and/or 214′. In this manner, the halo and backlight frame 74 may be reused and attached to one or more of the side panels 126, one or more roof panels 128, the frame 14, and/or the roll bar assembly 78 via one or more fasteners. In other configurations, a new halo and backlight frame 74 may be provided and installed.

This step may further include electrically coupling the backlight supported by the halo and backlight frame 74 (e.g., a center high-mounted stop lamp (CHMSL), third brake light, or similar lighting device) to the vehicle 10. Electrical power may be supplied, for example, from the roll bar assembly 78, which may include one or more pre-existing electrical connections, wiring harnesses, and/or connectors. In other configurations, electrical power may be routed from another portion of the vehicle electrical system, and one or more electrical connectors, terminals, or wiring extensions may be used to complete the electrical connection.

Referring now to FIG. 27, the assembling step and/or attaching step 220 may include one or more steps 242 of attaching or installing one or more side windows 130 to the vehicle 10, the frame 14, the roll bar assembly 78, and/or one or more rear side panels 126. The one or more side windows 130 may include one or more side window attachment devices 132. The one or more side window attachment devices 132 may be configured to cooperate or co-act with one or more corresponding frame fastening devices, roll bar fastening devices, and/or side panel fastening devices to attach and secure the one or more side windows 130 to the vehicle 10. For example, the one or more side windows 130 may be secured relative to the frame 14, the roll bar assembly 78, the rear side panels 126, and/or one or more rear roof panels 128.

In some configurations, the one or more side window attachment devices 132 may include one or more levers, latches, cam locks, and/or quarter-turn fasteners configured to engage corresponding structure of the rear side panels 126 from an interior side of the vehicle. Such attachment devices may permit one or more of the side windows to be removed to provide an open air configuration and/or to be replaced with other types of side windows or panels 130.

The one or more side windows 130 may include one or more transparent or semi-transparent panels, such as glass or polymeric windows. In other configurations, the one or more side windows 130 may include one or more nets, screens, mesh structures, or other coverings configured to at least partially enclose the side opening while permitting airflow and/or visibility. In other configurations, the one or more side windows may instead be side panels 130 that are not transparent or translucent and are instead solid panels. Such panels 130 may color match the rest of the rear enclosure assembly for example.

Referring now to FIGS. 28A and 28B, the assembling step and/or attaching step 220 may include a step 244 of assembling and/or attaching a rear window assembly 134. The rear window assembly 134 may include a rear glass or window assembly 66 that was previously removed from the vehicle during one or more of steps 212, 214, and/or 214′. In some configurations, step 244 may include applying a heater or defrost applique 136 to a rear glass or window 70, attaching or installing one or more shocks or struts 138 to a rear glass or window frame 68, and attaching or installing one or more hinges 140 to the rear glass or window frame 68.

Step 244 may further include attaching the shocks or struts 138 and the hinges 140 to one or more structural portions of the vehicle, such as the frame 14, one or more roof panels 128, one or more side panels 126, and/or the halo and backlight frame 74, to thereby mount the rear window assembly 134 to the vehicle 10. Step 244 may also include electrically coupling the heater or defrost applique 136 to the vehicle electrical system. Electrical power may be supplied, for example, from the roll bar assembly 78, which may include one or more pre-existing electrical wires, connectors, and/or wiring harnesses that were previously connected to the vehicle in one or more preceding steps.

In other configurations, the rear window assembly 134 may be a new component rather than a reused component from the pick-up truck configuration. In some configurations, the rear window assembly 134 may be provided as a pre-assembled unit including one or more of the hinges 140, shocks or struts 138, and/or the heater or defrost applique 136.

Referring to FIGS. 29A, 29B, and 29C, the assembling step and/or attaching step 220 may include a step 246 of installing a center console 142 within the vehicle 10. The center console 142 may be positioned between the front seats in the vehicle cockpit 52 and adjacent to and/or beneath the vehicle dashboard 144.

The center console 142 may include one or more console ducts 146 at the front portion configured to fluidly couple with one or more mating supply ducts 148 located in and/or beneath the vehicle dashboard 144. The step may include removing one or more plugs or covers to expose the one or more mating supply ducts 148 in order for temperature controlled air to be supplied to the center console 142.

The console 142 may include one or more locking and/or attachment devices configured to couple the one or more console ducts 146 to the one or more supply ducts 148 located at or beneath the dashboard 144. The locking and/or attachment devices may be configured to maintain a sealed or substantially sealed connection between the supply ducts 148 and the console ducts 146 and to reduce or inhibit separation and/or air leakage during vehicle operation, including under vibration, movement, and/or thermal expansion conditions.

During vehicle operation, heating, cooling, and/or ambient airflow generated by the vehicle HVAC system may be supplied from the supply ducts 148 into the console ducts 146 and directed toward a rear portion of the console 142 via the ducts. The airflow may then be delivered to a rear region of the vehicle, for example where rear seats are located, via one or more outlet ducts, vents, or grills 150 in the console.

The center console 142 may further include one or more additional features, such as one or more cup holders, charging ports, power outlets, armrests, HVAC controls, buttons, knobs, and/or storage compartments. In some configurations, the center console 142 may include one or more air movers (e.g., fans) and/or one or more thermoelectric devices configured to modify (e.g., heat and/or cool) and/or increase airflow directed to the rear region of the vehicle.

The center console 142 may also include one or more electrical connectors configured to electrically couple the console 142 and/or one or more components thereof to the vehicle electrical system without requiring manual splicing into existing wiring or harnesses.

The center console 142 may include one or more attachment devices configured to secure the console 142 to the vehicle 10, such as to one or more vehicle, frame, floor and/or frame fastening structures.

Referring now to FIG. 30, the vehicle 10 may be operable in an open-air vehicle configuration or safari mode 152. The open-air vehicle configuration 152 may correspond to a configuration of the vehicle based on the SUV configuration 12 in which one or more rear side panels 126 and/or one or more roof panels 128 of the rear enclosure assembly 60 are removed or separated from the vehicle 10, the vehicle frame 14, and/or the roll bar assembly 78. In this configuration, a rear portion of the vehicle, including the rear passenger seats 118, may be at least partially exposed to the surrounding environment.

A user or operator may operate the vehicle 10 in the open-air configuration 152 to increase ventilation and/or to facilitate transport of larger items, such as ladders, lumber, or recreational equipment. The vehicle 10 may be convertible between the open-air configuration 152 and the SUV configuration 12 by attaching and/or removing one or more panels of the rear enclosure assembly 60, such as the rear side panels 126 and/or roof panels 128, via engagement and disengagement of corresponding attachment devices provided on the panels and the vehicle 10 and/or the frame 14.

The vehicle 10 may also be operable in a modified open-air vehicle configuration. In this configuration, fewer than all of the rear enclosure panels may be removed or separated from the vehicle 10. For example, one or more rear roof panels 128 may be removed while one or both of the rear side panels 126 remain attached to the vehicle 10 and/or the roll bar assembly 78. In another configuration, the rear window assembly 134 may be removed while the rear side panels 126 and/or one or more roof panels 128 remain attached to the vehicle 10. Such selective removal of one or more panels may permit multiple open-air arrangements while maintaining portions of the rear enclosure assembly 60.

In some configurations, one or more of the rear seats 118 may be removable from the vehicle 10 when the vehicle is operated in the open-air configuration 152. This may enable an owner or operator to transport larger cargo, such as lumber, ladders, kayaks, or other equipment.

The method disclosed herein may further include one or more steps of installing weather stripping and/or sealing elements at one or more regions of the vehicle 10 to reduce ingress of water, snow, air, dust, and/or other environmental elements. For example, when converting the vehicle 10 to the SUV configuration 12, weather stripping and/or sealing elements may be installed at or around the rear window assembly 134, a tailgate, and/or at one or more interfaces between exterior panels supported by the roll bar assembly 78 that form part of the rear enclosure assembly 60. Additional locations may include one or more floor panels, a region where the rear enclosure assembly 60 meets a rear portion of the cockpit 52 and/or a B-pillar region, and/or one or more roof panels 128.

In addition, weather stripping and/or sealing elements may be installed at a rear region of the vehicle cab where one or more halo and/or backlight frame 74 components were removed, at regions where one or more roof panels 128 were removed or reconfigured, and/or at regions of one or more B-pillars where B-pillar appliques were removed, or any combination thereof.

The weather stripping and/or sealing elements may comprise one or more resilient materials, such as plastic, rubber, foam, or combinations thereof. In some configurations, the weather stripping and/or sealing elements may include a molded or formed gasket (e.g., a “mucket”). The weather stripping and/or sealing elements may be configured as one or more elongated strips of compressible material. In other configurations, the weather stripping and/or sealing elements may be provided as one or more localized patches, barriers, or deflection structures configured to catch, redirect, and/or shed fluid, dust, and/or debris away from regions through which such elements could otherwise enter the cockpit 52 or cabin.

The weather stripping and/or sealing elements may also be configured to reduce noise and/or wind intrusion into the vehicle 10. In some configurations, the weather stripping and/or sealing elements may further absorb, dampen, and/or minimize noise, vibration, and harshness (NVH), including buzz, squeak, and rattle (BSR) conditions.

A method of reconfiguring the vehicle 10 from the SUV configuration 12 to a pick-up truck configuration is also disclosed. The method may include performing one or more of the previously described assembly and/or attachment steps in reverse order. In some configurations, the method may be performed sequentially. In other configurations, one or more steps may be omitted, reordered, and/or performed concurrently depending on the desired configuration and available components.

For example, the method may include removing one or more outer panels of the rear enclosure assembly 60, such as one or more roof panels 128 and/or one or more rear side panels 126. The method may further include removing and/or disassembling the rear window assembly 134, including disconnecting any associated electrical connections (e.g., defroster, lighting). One or more additional roof panels of the rear enclosure assembly 60 may be removed, and one or more rear seats 118 may be removed or separated from the vehicle frame 14 and/or the roll bar assembly 78 (e.g., a hoop structure). The method may also include removing one or more interior panels associated with the rear enclosure assembly 60 and disassembling the roll bar assembly 78.

The method may further include removing and/or separating one or more frame rails (e.g., longitudinal rails 102) from the vehicle frame 14 and/or the roll bar assembly 78, and removing and/or separating the roll bar assembly 78 (e.g., hoop structure) from the vehicle frame 14. The method may then include reinstalling one or more components associated with the pick-up truck configuration, such as a rear cab bulkhead panel, a spoiler, and/or one or more roof panels associated with the cockpit 52. In addition, the method may include reinstalling the halo and backlight frame 74, one or more B-pillar appliques, and the rear window assembly.

In some configurations, the reconfiguration method may include any combination of the foregoing steps, including removing, disassembling, separating, and/or reinstalling components of the rear enclosure assembly 60, the roll bar assembly 78, and/or the vehicle frame 14, to transition the vehicle 10 between the SUV configuration 12 and the pick-up truck configuration. The method may further include reusing one or more components removed from the SUV configuration and reinstalling such components in corresponding locations for the pick-up truck configuration, or alternatively replacing one or more components with new or different components.

FIG. 31 illustrates a vehicle chassis 154. The chassis 154 may support and/or be supported by the vehicle frame 14. The chassis 154 may include one or more batteries 156 configured to provide electrical power to one or more motors 161 for driving the front wheels 48 and/or the rear wheels 62.

The chassis 154 may further include a front end unit 158 including a suspension system and supporting the front wheels 48, and a rear end unit 160 including a suspension system and supporting the rear wheels 62. In some configurations, the chassis 154 (including the one or more batteries 156, the front end unit 158, and the rear end unit 160) may be mounted to, supported by, integrated with, and/or positioned beneath the vehicle frame 14.

The vehicle 10 may include one or more plugs or receptacles 163. The one or more plugs or receptacles 163 may be electrically connected to the one or more batteries 156 via one or more cables and/or wiring harnesses 165. The one or more plugs or receptacles 163 may be configured to connect the one or more batteries 156 to an external power source, such as a charger or charging station.

The one or more cables and/or wiring harnesses 165 may be routed within the vehicle 10 to position the one or more plugs or receptacles 163 at one or more accessible locations. For example, the one or more plugs or receptacles 163 may be positioned at a rear passenger-side region, a rear driver-side region, a front passenger-side region, a front driver-side region, a rear end of the vehicle, and/or a front end of the vehicle. The one or more plugs or receptacles 163 may be supported at, on, or by the vehicle frame 14 and/or one or more body panels.

The front wheels 48 and/or rear wheels 62 may be of the type illustrated and/or described in U.S. Provisional Application No. 63/786,776, filed on Apr. 10, 2025, the entirety of which is hereby incorporated by reference herein for all purposes.

By way of illustration, in one preferred configuration, a wheel (e.g., a steel wheel) may include a wheel face having at least one wall (e.g., a generally planar wall) that is dimensioned and configured to support a graphic design element. The wheel face may include one or more walls (e.g., planar, inwardly sloping, and/or outwardly sloping) that are substantially free of openings or cutouts, such that the wheel face defines a substantially continuous surface.

The graphic design element may be directly attached to the wheel face via an adhesive, without the use of mechanical fastening structures. This configuration may facilitate application, removal, and/or replacement of the graphic design element while maintaining an uninterrupted exterior appearance.

The one or more wheels 48 and/or 62 may further include an ornamental configuration, for example as shown in U.S. Design Application No. Ser. No. 29/997,668, filed on Apr. 9, 2025, the entirety of which is hereby incorporated by reference herein for all purposes.

FIGS. 32A and 32B illustrate a rear end unit 160 of the vehicle. The rear end unit 160 may include an axle 162, a rear suspension including one or more coil springs 164, one or more motors 161, and a braking system. In some configurations, the braking system may include a regenerative braking system.

The coil springs 164 may be supported by one or more coil spring arms 172. The coil spring arms 172 may be positioned on one side of the axle 162, while one or more struts 167 may be positioned on an opposite side of the axle. For example, the coil springs 164 and coil spring arms 172 may be positioned rearward of the axle 162 relative to a normal vehicle orientation, while the one or more struts 167 may be positioned forward of the axle 162 in vehicle position.

The one or more coil spring arms 172 may have a generally pan-shape. The coil spring arm 172 may include a rounded or oval end configured to support a corresponding coil spring 164 and an opposing end that is narrower and connected to the axle 162 via a bracket or flange. In other words, the coil spring 164 is not located on the axle 162 but rather attached on a lower link or arm 172.

The axle 162 may be a de Dion solid axle that extends between a first end and a second end. A first end plate 166 may be integrally connected to the first end of the axle 162. A hub carrier 168 may be fastened to the first end plate 166 via a plurality of mechanical fasteners. A half shaft 170 having an end extending through the first half shaft aperture defined in the hub carrier 168 to provide power from an electric drive unit to a first rear wheel of the vehicle. In some configurations, the rear suspension system does not include any leaf springs.

The front suspension may include a MacPherson Strut system.

The rear suspension may include a de Dion axle with coil springs. The front suspension may be free of leaf springs.

FIGS. 33 and 34 illustrate an article carrier 300. The article carrier 300 may be attached to the vehicle 10, the vehicle frame, and/or one or more body panels of the vehicle.

In some configurations, the article carrier 300 may incorporate one or more of the teachings described in U.S. 63/786,778 filed on Apr. 10, 2025, the entirety of which is hereby incorporated by reference herein for all purposes.

The article carrier 300 may be attached to the vehicle 10 when the vehicle is configured in either the pickup truck configuration or the SUV configuration. In some configurations, the article carrier 300 may be supported on a roof portion of the vehicle and may be secured to the vehicle frame via one or more body panel fasteners 36 (see also FIGS. 1A and 1B). The article carrier 300 may additionally or alternatively be attached to or supported by one or more frame cross members or rails 5 and/or 51.

The article carrier 300 in FIG. 33 is shown in a first article carrier configuration. The article carrier 300 includes a first pair of longitudinally aligned spaced apart rails (e.g., a first left rail 302a and a first right rail 302b) each having a first length, each having a longitudinally extending slot 304 that includes a slot opening along the longitudinal direction that faces toward the longitudinal axis of the vehicle, and being mounted on the vehicle roof or one or more roof panels 16. The article carrier 300 includes a rear transverse end bar 306. Such end bar 306 may have a first end corner region 308a on its left side and a second end corner region 308b on its right side. The end bar 306 is connected at the left corner region 308a to the left rail 302a. The end bar 306 is connected at the right corner region 308b to the right rail 302b.

The rear transverse end bar 306 may be elevated and spaced apart from a roof surface or the one or more roof panels 16 of the vehicle. Two stanchions 310 are located on the roof of the vehicle and connect to the left corner region 308a and the right corner region 308b, respectively, of the rear transverse end bar 306 to maintain the elevation and spacing. Each stanchion 310 has a lower portion that is secured to the vehicle roof or frame (e.g., via fasteners 36) and an upper portion that receives the rear transverse end bar 306. The upper portions of the stanchions 310 also receive rails 302a and 302b respectively.

The article carrier system 300 includes an adjustable cross bar 312 located forward of the transverse end bar 306 and being longitudinally adjustable between at least two positions. The transverse cross bar 312 may be securable to the rails 302a, 302b and configured for longitudinal adjustment between at least two positions via the slots 304. By way of example, the adjustable cross bar 312 may have an associated structure that provides a mechanism to permit a mechanical locking attachment to the rails 302a, 302b. As possible with other mechanical locking attachments herein, the bracket may include includes a clamp that can be tightened to bear against the inner wall defining the slot 304 in the rail 302a, 302b, and can be loosened to allow fore and aft adjustment. The rails 302a, 302b, the rear transverse end bar 306, and the adjustable cross bar 312 share a common plane.

The end caps 310 are employed to cover at least the forward end of each of the rails 302a, 302b The end caps 310 are fastened to the vehicle roof or roof frame of the vehicle. Each end cap 310 includes a forward portion that slopes downward. The forward portion has an outer surface that is below the planar roof toward the wind screen of the vehicle. The end cap 310 may include a rearward portion that enables its associated rail to be elevated and spaced apart from an exterior surface of the vehicle. The end cap 310 is/are fastened to the vehicle roof and engages with each of the rails 302a, 302b to maintain the rails elevated and spaced apart from the roof of the vehicle. The article carrier 300 can be located or supported on the roof of the vehicle in either the pickup configuration, the SUV configuration, or both.

The article carrier 300 is convertible or transformable into a second configuration. Referring now to FIG. 12, where the vehicle is in the SUV configuration (e.g., has the rear enclosure assembly 60 attached to the vehicle or frame), the second configuration article carrier 300′ includes a second pair of longitudinally aligned spaced apart rails (e.g., a second left rail 314a and a second right rail 54b) each having a second length, longer than the first length, each having a longitudinally extending slot 316 that includes a slot opening along the longitudinal direction that faces toward the longitudinal axis of the vehicle, and being mounted on the vehicle roof.

The second configuration article carrier 300′ includes a rear transverse end bar 306. Such end bar 306 may have a first end corner region 308a on its left side and a second end corner region 308b on its right side. The end bar 306 is connected at the left corner region 308a to the second left rail 314a. The end bar 306 is connected at the right corner region 308b to the second right rail 314b.

The rear transverse end bar 306 is elevated and spaced apart from a roof surface of the vehicle. Four stanchions 318 (compared to 2 stanchions 318 in FIG. 33) are located on the roof of the vehicle and two of the stanchions 318 connect to the left corner region 308a and the right corner region 308b, respectively, of the rear transverse end bar 306 to maintain the elevation and spacing. These two stanchions 318 have a lower portion that is secured to the vehicle roof and an upper portion that receives the rear transverse end bar 306. The upper portions of these two stanchions 318 also receive rails 314a and 314b respectively. The other two stanchions 318 are located on a more forward portion of the roof have a lower portion that is secured to the vehicle roof and an upper portion that receives rails 314a and 314b respectively.

The second configuration article carrier 300′ includes three adjustable cross bars 312, each located forward of the transverse end bar 306 and each being longitudinally adjustable between at least two positions. The three transverse cross bars 312 may be securable to the rails 314a, 314b and configured for longitudinal adjustment between at least two positions via the slot 316. By way of example, the adjustable cross bars 312 may have an associated structure that provides a mechanism to permit a mechanical locking attachment to the rails 314a, 314b. The rails 314a, 314b the rear transverse end bar 306, and the adjustable cross bars 312 share a common plane.

The article carrier 300, 300′ is reversibly transformable from a first state in which the article carrier is attached to a roof of a vehicle configured as a pickup truck (e.g., having no rear seat and no cargo area enclosure; FIG. 33) to a second state when the vehicle is configured as a sport utility vehicle (e.g., having a rear seat and/or a cargo area enclosure; FIG. 34).

FIG. 35 illustrates a left rail 302a, 314a which has a profile geometry that provides a track on three portions of the profile. Specifically, the profile geometry defines three T-shaped slot profiles. One of the T-shaped slot profiles is slot 304, 316. The other two T-shaped slot profiles are located on the top and bottom of the left rail 302a, 314a. The right rail has a similar profile or geometry.

Turning to FIG. 36, there is depicted a cross bar 312 which has a profile geometry that provides a track on two portions of the profile. Specifically, the profile geometry defines two T-shaped slot profiles located on the top and bottom of the cross bar 312. The cross bar 410 may have the same profile as the cross bar 312 illustrated here.

Turning to FIGS. 37 and 38, there is depicted a rack assembly 400 that supports articles overhead of a truck bed or cargo area when the vehicle is in a pickup truck configuration. The rack assembly 400 includes a pair of longitudinally aligned slotted bed rails (e.g., a left bed rail 402a and a right bed rail 402b) for attachment to an upper portion of a bed wall (e.g., an upper portion or surface of the left bed wall of the frame and an upper portion or member 55 of the right bed wall of the frame) of a vehicle. The rails 402a, 402b, may extend along an entire length of the bed walls, or partially along a length thereof. The rails 402a, 402b may be slotted, for example a C-or U-slot or channel to receive fastening devices.

The rack assembly 400 may include a pair of longitudinally aligned slotted bed rails (e.g., a left bed rail 403a and a right bed rail, not illustrated) for attachment to an inside wall or portion of a bed wall of a vehicle when in the pickup truck configuration. These inner bed rails 403a may be used for securing cargo or other rail assemblies to the vehicle.

The rack assembly 400 includes two upright assemblies 404 secured to the slotted bed rails 402a, 402b. The upright assembly 404 includes a left upright arm 406a attached to the left slotted bed rail 402a via a bracket 408 and a connection piece 410, and a right upright arm 406b attached to the right slotted bed rail 402b via bracket 408 and connection piece 410. The left upright arm 406a and the right upright arm 406b are joined together by a cross bar 410 via a left corner bracket 412a and a right corner bracket 412b. The upright assembly 404 is longitudinally adjustable and securable between at least two different longitudinal positions.

FIGS. 39 and 40 illustrate an article carrier 500. The article carrier 500 may include a stowage container configured to be positioned on or within a backside (B-side) region of a wheel rim hub. The article carrier may be mounted to a vehicle frame assembly rather than to a bumper. The article carrier may include one or more hinged portions and a latching portion. Such a wheel carrier and stowage container are illustrated and described in U.S. Provisional Patent Application No. 63/786,788, filed Apr. 10, 2025, and U.S. Design Patent Application No. Ser. No. 29/997,669, filed Apr. 9, 2025, the entireties of which are hereby incorporated by reference herein.

The vehicle may include a spare wheel or tire that may be carried on an article carrier assembly configured for mounting to a rear portion of the vehicle or vehicle frame (e.g., to a longitudinal frame rail).

The article carrier 500 generally includes a carrier portion 502 attached to an upwardly oriented arm portion 504. The carrier portion 502 is configured to receive and support a stowage enclosure 506 and a wheel assembly, which may include a spare front wheel and/or rear wheel 62, 48 of the vehicle 10. The wheel 62, 48 may be attached to the arm portion 504 such that a front side (A-side) of the wheel or rim faces toward the vehicle 10, while a rear side (B-side) faces outwardly. The stowage enclosure 506 may be configured to fit within the B-side region of the wheel or rim.

The article carrier 500 may include a removable cover 508 configured to cooperate with a receptacle of the stowage enclosure 506 and/or the wheel of the spare tire assembly to define an enclosed storage region capable of carrying articles, such as tools, emergency equipment, warning indicators, or a first aid kit.

The article carrier 500 may include a vehicle mount portion 518 configured to be secured to the vehicle 10 or frame 14, such as within a frame rail 14a (e.g., a left or right frame rail). The vehicle mount portion 518 may include a forward-projecting beam 520 configured to extend into an open end of the frame rail 14a to define a mechanical connection. One or more fasteners 522 may extend through apertures in the forward-projecting beam 520 and corresponding apertures 524 in the frame rail 14a. In some configurations, the fasteners 522 may extend at an angle that is transverse to a longitudinal axis of the frame rail 14a and the forward-projecting beam 520.

The article carrier 500 may be configured to swing away from the vehicle 10 via a hinge assembly or subassembly. An example hinge assembly suitable for use with the article carrier 500 is illustrated and described in U.S. Provisional Patent Application No. 63/786,788, filed Apr. 10, 2025, the entirety of which is hereby incorporated by reference herein for all purposes.

FIG. 41 illustrates a front region 40 of the vehicle frame 14 with a vehicle frame subassembly 13 defined by a bumper beam 15, crush cans 17, blockers 19, longitudinal frame rails 21, a crossmember 23, shotguns 25, shock tower reinforcements 27, and cradle 29. These elements are further illustrated and/or described in U.S. 63/786,920 filed on Apr. 10, 2025, the entirety of which is hereby incorporated by reference herein for all purposes.

The bumper beam 15 may be designed with a radius to provide for a gliding action against a barrier 31. The crush cans 17 absorb energy translated through the bumper beam 15 and translate the energy to the blockers 19 and the shotguns 25. Energy translated to the shotguns 25 causes deformation thereof and also propagate the energy along the length thereof. The blockers 19 pivot toward a centerline C of the vehicle and influences a deformation of the longitudinal frame rails 21 while translating energy, via the crossmember 23 toward the centerline C. The blockers 19 are fastened to the longitudinal frame rails 21 (e.g., via bolts, with e.g., six M12 bolts, oriented relative to a first axis and three M6 bolts oriented relative to a second axis that is perpendicular to the first axis). The crossmember 23 protrudes into the longitudinal frame rails 21 and maintain a continuous load transfer between the blocker 19 and the crossmember 23. The crossmember 23 transfers the load transversely across the vehicle frame subassembly 13. The crossmember 23 is 2T and 3T welded to the longitudinal frame rails 21.

The shock tower reinforcements 27 connect, at one end, to the longitudinal frame rails 21 and at the other end, to the shotgun 25. Thus, energy is translated from the longitudinal frame rails 21, through the shock tower reinforcements 27 to the shotguns 25. The shock tower reinforcements 27 provide sufficient resistance to prevent the barrier 31 from moving inboard and maintains the structural integrity of the shotguns 25. The shotguns 25 link the blockers 19 to pillars (e.g., hinge pillars) and functions to maintain the shotgun 25 geometries throughout an impact sequence, to facilitate the gliding action.

The longitudinal frame rails 21 and cradle 29 are connected. The longitudinal frame rails 21 function to deform (e.g., with two bends, such as in a Z-shape) in a pre-defined manner to absorb energy. Such deformation may be influenced by stress concentrators, which may be one or more indentations, grooves, or weakened areas of the frame or sub frame or member.

FIGS. 42A and 42B illustrate a portion of a vehicle panel or panel substrate having a wrap edge receiving channel 33. The vehicle panel can be any of the vehicle panels disclosed herein, including a hood, roof panel, fender, door panel, tailgate, rear enclosure structure (e.g., side panel, roof panel, or any combination thereof).

A wrap edge receiving channel 33 may extend at least partially, or entirely, along a length or along a width of a panel substrate. The wrap edge receiving channel 33 may separate the panel substrate 33 into a first panel portion 35 on one side of the channel 33 and a second panel portion 37 on another side of the channel 33. The first panel portion 36 and the second panel portion 37 may be integral parts or portions of the structure of the panel. In other words, the first panel portion 35 and the second panel portion 37 may not be separate or individual parts or pieces of the panel.

The outer panel substrate and/or one or more portions of a panel substrate may be configured to be at least partially covered by one or more wraps, sheets, covers, layers, wrap sheets, or a combination thereof. The one or more wraps, sheets, covers, layers, wrap sheets, or a combination thereof may be a cover, film, layer, or other covering that is intended to at least partially cover an outer or A-surface of a vehicle body panel. Such a wrap, sheet, cover, layer, wrap sheet, or a combination thereof may function to provide a decorative, customized, and/or protective barrier on the panel.

The wrap edge receiving channel 33 may comprise a channel into which one or more edges of one or more wrap sheets are received.

A wrap edge receiving channel 33 may be defined by a first wall 39, a second wall 41, and a connecting wall 43 extending therebetween. The first wall 39 may be connected to or integral with the first panel portion 35, and the second wall 41 may be connected to or integral with the second panel portion 37.

When the panel and/or the wrap edge receiving channel 33 is viewed in cross section, the channel may have a C-shape, a V-shape, or a U-shape. When the panel and/or the wrap edge receiving channel 33 is viewed in cross section, the walls 39, 41, 43 may have a substantially constant or uniform wall thickness. When the panel and/or the wrap edge receiving channel 33 is viewed in cross section, a thickness of the panel is substantially constant or the same in a region above and/or below the wrap edge receiving channel 33. More specifically, the first panel portion 35, the walls 39, 41, 43 of the wrap edge receiving channel 33, and the second panel portion 37 may have a substantially constant, uniform, or the same wall thickness.

An angle A of the first wall 39 relative to a center or horizontal plane H may be approximately 0 degrees or more, 5 degrees or more, 10 degrees or more, 20 degrees or more, 30 degrees or more, 40 degrees or more, 45 degrees or more. An angle A of the first wall 41 relative to a horizontal plane H may be approximately 60 degrees or less, 45 degrees or less, 30 degrees or less, 20 degrees or less, 15 degrees or less, 10 degrees or less, 5 degrees, or less. Preferably, the angle A of the first wall 34 relative to a horizontal plane H may be about 20 degrees or more or less than about 30 degrees.

An angle B of the second wall 41 relative to a horizontal plane may be approximately 0 degrees or more, 5 degrees or more, 10 degrees or more, 20 degrees or more, 30 degrees or more, 40 degrees or more, 45 degrees or more. An angle B of the second wall 41 relative to a horizontal plane may be approximately 60 degrees or less, 45 degrees or less, 30 degrees or less, 20 degrees or less, 15 degrees or less, 10 degrees or less, 5 degrees, or less. Preferably, the angle B of the second wall 36 relative to a horizontal plane may be about 20 degrees or more or less than about 30 degrees.

The connecting wall 43 may be substantially planar, angled, sloped, or curved. The connecting wall 38 may be orthogonal to the first and/or second wall.

A slope of the first wall 39 may be less than a slope of the second wall 41, as measured or observed relative to a horizontal plane extending through the channel 33.

Referring now to FIGS. 43A-43C, one or more of the vehicle panels or panel portions may be covered by one or more or more wrap sheets.

A wrap sheet 45 may have one or more edges. An edge may be a terminal edge, region, portion, area, or boundary that defines a size and/or shape of a wrap sheet 45. Depending on the size and shape of the wrap sheet, a wrap sheet may have a plurality of edges. A wrap sheet may be applied onto the outer panel substrate of a panel so that one or more edges of a wrap sheet 45 is/are received into one or more wrap edge receiving channels 33. The wrap sheet 45 may include an A-side and an opposing B-side. After the wrap sheet 45 is attached to and/or supported on the outer panel substrate of the panel, the A-side may be visible or laterally facing outward. The opposing B-side may include an adhesive that may be used to attach or secure the wrap sheet 45 to the outer panel substrate of the panel.

A tool may be used to press, push, or wet out the wrap sheet 40 against the panel substrate 26. The tool may be used to press, push, or wet out the edge of the wrap sheet 40 into the wrap edge receiving channel 28 so that the adhesive on the wrap sheet 40 bonds to the panel substrate 26.

For example, with specific reference to FIG. 43A a wrap sheet 45 may be a lower wrap sheet 45 that is applied onto the second panel portion of the panel substrate. An upper edge 47 of the lower wrap sheet 45 is received into the wrap edge receiving channel 33. The upper edge 47 of the lower wrap sheet may be located in or may cover the lower wall, the connecting wall, and/or the upper wall. The first wall may function as a roof or ledge that covers the upper edge from view and/or exposure to the elements (sun, rain, salt spray, car wash, etc.). Accordingly, when the panel is viewed by an observer, upper edge 47 of the lower wrap sheet 45 is not in the observer's line of sight due to the edge 47 being received into the channel 33 and blocked by the structure of the channel 2338 (e.g., the extending walls 39, 41, 43) thereby providing an aesthetically pleasing appearance. Moreover, the edge 47 is not directly exposed to the surrounding environment (e.g., sun rain, car wash environment), which may prevent the edge 47 from separating from the panel 12.

Furthermore, rain, water, salt spray, etc. may drip or travel downwardly from the first panel portion to the second panel portion and omit or skip over the channel 33. Accordingly, the edge(s) of the wrap sheet(s) within the channel 33 are protected from the rain, water, salt spray, etc. and less prone to having the edge lift away from the outer panel substrate.

Referring now to FIG. 43B, an upper wrap sheet 49 may be applied onto the outer panel substrate. The upper wrap sheet 49 may be a completely separate sheet or element from the lower wrap sheet. The upper wrap sheet 49 may be applied onto the first panel portion of the panel substrate. A lower edge 51 of the upper wrap sheet 49 is received into the wrap edge receiving channel 33. The lower edge 51 of the upper wrap sheet may be located in or may cover the lower wall, the connecting wall, and/or the upper wall. The edges 47, 51 may be spaced apart within the channel 33 such that a gap is defined therebetween. The gap may be an exposed portion of the substrate 33 and/or channel 33 where no wrap sheet is located. With both edges 47, 51 located within the channel 33, when the panel is viewed by an observer, the upper and lower edges of the wrap sheets is/are not in the observer's line of site due to the edges being blocked by the structure of the channel 33 (e.g., the inwardly extending walls 39, 41, 43) thereby providing an aesthetically pleasing appearance. Moreover, the edges 47, 51 is/are not directly exposed to the surrounding environment (e.g., sun rain, car wash environment), which may prevent the edges 47, 51 from separating from the panel.

With reference now to FIG. 43C, when a panel or outer panel substrate is covered by both a lower wrap sheet and an upper wrap sheet, one edge 47, 51 may overlap another edge 51, 47 within the channel 33. For example, the lower edge of the upper wrap sheet may overlap the upper edge of the lower wrap sheet, or vice versa (e.g. the upper edge of the lower wrap sheet may overlap the lower edge 46 of the upper wrap sheet). The overlap region of the wrap sheets may be located in or over the upper wall, the lower wall and/or the connecting wall of the channel.

Further aspects of the wrap edge receiving channel are illustrated and described in U.S. 63/786,768 filed on Apr. 10, 2025, the entirety of which is hereby incorporated by reference herein for all purposes.

Referring to FIGS. 44-48, the rearward sub assembly 44 comprises at least two spaced apart frame rails 14a. The frame rails 14a may be longitudinally oriented toward the rear of the vehicle. The frame rails 14a may have an open hollow rear end. The open hollow rear end may be configured to receive one or more accessories, such as one or more hitches or article carriers disclosed herein. The rearward sub assembly 44 has a rear region 53 that is located proximate, and preferably over, a pair of rear wheels of the vehicle. The rear region 53 includes a pair of opposing bed walls 54 and a rear floor 56.

The forward sub assembly 40 comprises at least two spaced apart frame rails 21. The frame rails 21 may be longitudinally oriented, toward the front of the vehicle. The frame rails 21 may be optionally configured to be detachably coupled with at least one collapsible cradle assembly, and preferably over, a pair of front wheels of the vehicle.

One or more batteries 156 (FIGS. 31, 48) may be coupled to, or are supported by, on, under, or with, the vehicle frame 14, preferably to at least the intermediate subassembly 42 of the vehicle frame. The one or more batteries 156 are adapted to provide power to one or more motors 161 that are supported by, on, or with the forward subassembly 40 and/or the rearward subassembly 44.

Two or more of the forward subassembly 40, the intermediate subassembly 42, and the rearward subassembly 44 may be an integrated structure. This means that the elements of two or all three sub assemblies 40, 42, 44 are an integrally formed structure.

Two or more of the forward subassembly 40, the intermediate subassembly 42, and the rearward subassembly 44 may be discrete structures that are connected together with one or more fasteners or fastening methods such as bolts, welding, brackets, flanges, etc.

The rearward subassembly 44 and/or one or both of the pair of opposing bed walls 54 may comprise a support or reinforcing structure for strengthening or reinforcing the bed walls 54. The support or reinforcing structure may provide support or reinforcement for attaching additional structure to the vehicle, like one or more accessories. The support or reinforcing structure may provide support or reinforcement for attaching structure to the vehicle such as the roll bar assembly, hoop structure, one or more rear seats, one or more article carriers, etc.

The rearward subassembly and/or one bed wall support or reinforcing structure may comprise an upper member 55 and two side members 57 (e.g., a front side member 57 and a rear side member 57′, in vehicle position). The front side member 57 may be adjacent and rewards of the B-pillars 50. One or both of the pair of opposing bed walls 54 may comprise a pair of angled support members 59, one of which extends from one of the two side members 57, 57′ to the upper member 55 and the other of which extends from the other of the two side members 57 to the upper member 55. One or both of the pair of opposing bed walls 54 may comprise a connecting member 61 that extends between and connects the pair of angled support members 59 in a region below the upper member 55. The rearward subassembly and/or one bed wall support or reinforcing structure may include one or more frame fastening devices 64. The rear side member 57′ may include the pocket or slot 110 (e.g., a rear attachment location) into which the rear end 106 of the frame rails 102 of the roll bar assembly are received when attaching the roll bar assembly to the vehicle. The pocket or slot 110 may be located in an upright member that extends at a rear end region of the vehicle or frame.

The rearward subassembly 44 comprises a floor structure 56 having a plurality of cross bars 61 that extend between and connect a pair of two spaced apart longitudinal members 63. The floor structure 56 and/or the at least two longitudinal members 63 are adapted to connect to the at least two spaced apart frame rails 14a of the rearward subassembly 44. The floor structure may have a connecting member 91 that connects adjacent cross bars 61. For example, the connecting member 91 may have an H-or X-shape.

The rearward subassembly 44 may include one or more steps 107. A step 107 may provide structure and integrity to the rear bumper cover of the vehicle. The step 107 may allow a user or passenger a region to step on the bumper to be structurally supported by the frame and not damage the bumper. The step 107 may be connected to a cross bar or member that extends between the two longitudinal members. The step 107 may be connected to the floor 56. The step 107 may be part of or support a rear bumper beam.

The intermediate subassembly 42 comprises a floor 63 that has an upper side 65 and a lower side 67. The upper side 65 may be located within the vehicle cabin or cockpit. The upper side 65 may be covered by carpet, a plastic floor, or a combination thereof inside of the cockpit. The lower side 67 may face or be arranged closer to the ground in vehicle position. The floor 63 of the intermediate region has a step 69 that forms a pocket 71 on the lower side 67 and a corresponding elevated portion 73 on the upper side 65. The step 69 is located at a rear portion of the floor 63, closer to the rear wheels of the vehicle than the front wheels. The step 69 may be located rearward of the B-pillar 50.

The intermediate subassembly 42 may include at least two spaced apart frame rails 75, that are, preferably longitudinally oriented, between the front and the rear of the vehicle. The two spaced apart frame rails 75 are adapted to attach the one or more batteries 156 to the intermediate subassembly 42 or frame.

The two spaced apart frame rails 75 have a bottom surface or region 77 that is spaced below the floor 63 of the intermediate sub assembly 42. The bottom surface or region 77 of the two spaced apart frame rails 75 are configured to receive or attach the one or more batteries 156. The one or more batteries 156 may have one or more attaching members 79 that extend laterally outward and are adapted to be attached to the spaced apart frame rails 75 of the intermediate sub assembly 42 or bottom surfaces or region 77 thereof. The one or more batteries 156 comprise an elevated portion 81 that fits into the pocket 71 on the lower side 67 of the floor 63 of the intermediate subassembly 42.

The intermediate subassembly 42 may include a roof support structure that is defined by a forward member 5 and a rearward member 51. The forward member 5 may be located on or attached to the downwardly sloping portions of the A-pillars 47. The rearward member 51 may be located or attached to the B-pillars 50. A through passage may be defined between the two members 51, 5. The through passage may be adapted to provide an open air, sun roof, or moon roof vehicle configuration. One or both of the members 51, 5 may include one or more frame fastening devices for attaching or securing one or more accessories or panels to the vehicle frame, such as elements of the roof rack or article carrier disclosed herein.

The following description further applies to all embodiments and teachings herein.

The description herein pertains to automotive vehicles. Preferably it pertains to a vehicle that can be reconfigured from a first vehicle configuration to a second vehicle configuration. The vehicle can be reconfigured back to the first vehicle configuration. In other words, the vehicle has a reversible configurable structure.

The vehicle may be a passenger vehicle for transporting passengers. The vehicle may be a cargo vehicle for transporting cargo. The vehicle may be a passenger and cargo vehicle for transporting both passengers and cargo. In some configurations the teachings herein may be applied to other vehicles such as a motor home, train, airplane, boat, golf cart, all-terrain vehicle (ATV), personal mobility vehicle, and/or off-road vehicle.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a pickup truck or pickup truck configuration. In the context of the present description, the other vehicle configuration (e.g., first vehicle configuration or second vehicle configuration) may be a sport utility vehicle (SUV) or SUV configuration.

In the context of the present description, a “pickup truck” includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing and/or transporting cargo. The bed or cargo area may have a size that is less than 8 foot, less than 7 foot, preferably less than 6 feet, more preferably about 5 feet long. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of occupants), a cargo area enclosed by an enclosure, and a space behind a driver seat for or providing optional additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added. In some configurations, a sport-utility vehicle may include a vehicle in a safari mode that does not include one or more rear enclosure side panels and/or roof panels. In some configurations, a sport-utility vehicle may include a vehicle that includes a rear enclosure assembly but does not include additional passenger seating. In other words, the rear seat may be optionally installed or removed. Such a sport utility vehicle may enable or allow a user to transport larger goods or cargo in a covered or protected space.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. The suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein has a frame. Unless otherwise stated a “frame” of a vehicle herein refers generally to a vehicle portion, shell, or skeleton that imparts structural integrity to the vehicle, whether to the entire vehicle and/or a portion only of the vehicle. The frame may be a blended construction of body-on-frame, skateboard, unibody, body in white, or ac combination thereof.

A frame typically is a part of the vehicle that provides support for one or more vehicle body panels, interior components, and/or a part of the vehicle to which other vehicular components can be attached. For example, one or more interior vehicle components (e.g., interior panels, vehicle seats, dashboard, etc.) of the vehicle may be attached or supported on the frame. For example, one or more exterior vehicle components (e.g., exterior panels, doors, lights, windows, etc.) of the vehicle may be attached or supported on the frame. A frame may include one or more (e.g., a pair of spaced apart longitudinally extending) frame rails that extend from a rear end portion of the vehicle at least partially along the length of the vehicle towards the front end of the vehicle. A frame may include one or a plurality of subframes. The subframes may be configured to absorb energy and a controlled impact response in the event of a small overlap frontal impact and/or a direct frontal impact.

The frame may include structural components such as A-pillars, B-pillars, floor, cargo area walls. In some configurations, one or more elements of the frame may be permanently connected together such as via welding, riveting, and/or adhesive bonding. The vehicle frame or structural components of the vehicle frame may be made of a high strength architecture made of metal, aluminum, and/or steel. The frame may include a plurality of fastener elements (e.g., weld nuts, self-clinching nuts, blind rivet nuts, rivets or other threaded inserts) located at predefined locations and configured to receive another fastener element for attaching vehicle components (e.g., body panels, article carriers, or the like) to the frame.

By way of example, an article carrier such the article carrier illustrated and described in U.S. 63/786,778 filed on Apr. 10, 2025, the entirety of which is hereby incorporated by reference herein for all purposes, can be attached to the vehicle. The article carrier is optionally reversibly configurable between a pickup truck configuration and a sport utility vehicle configuration. The article carrier system is capable of being reversibly modified among a plurality of different operational states (e.g., a first state for use on the vehicle is in its pickup truck configuration and a second state for use on the vehicle when it is in its sport utility vehicle configuration).

The article carrier may generally have a first pair of longitudinally aligned spaced apart rails (e.g., a first left rail and a first right rail) each having a first length and being configured for attachment to the vehicle (e.g., to a roof of the vehicle); a rear transverse end bar having a first end region (e.g., a left end region) and a second end region (e.g., a right end region), and being connected at the first end region to one of the longitudinally aligned spaced apart rails (e.g., the left rail) and being connected at the second end region to the other one of the longitudinally aligned spaced apart rails (e.g., the right rail); an adjustable cross bar located forward of the transverse cross bar and being longitudinally adjustable between at least two positions, and being securable (e.g., mechanically (e.g., a friction fit, an interlock, a cam lock, a locking pin through an opposing aperture, a clamp, or the like)) to the rails, between at least two positions; and optionally, an end cap that covers the forward end of each of the rails.

A unique aspect of the article carrier is realized by which the article carrier can be reversibly transformable from a first state in which the article carrier is attached to a roof of vehicle configured as a pickup truck (e.g., having no rear seat and no cargo area enclosure) to a second state when the vehicle is configured as a sport utility vehicle (e.g., having a rear seat and/or a cargo area enclosure). To achieve this, the article carrier may have at least one second pair of longitudinally aligned spaced apart rails (e.g., a second left rail and a second right rail) each having a second length and being configured for attachment (e.g., using original equipment hardware provided on the vehicle frame, such as frame fastening devices, accessory fastening devices, weld nuts, a threaded opening, and/or a threaded fastener that is exposed and visible to an observer located outside of the vehicle and within 3 meters of the hardware) to a roof of a vehicle on a respective side of a longitudinal axis of the vehicle, each rail of the second pair of longitudinally aligned spaced apart rails having a forward end and a rearward end, and the second length is longer than the first length by at least 120%, preferably at least 150% and more preferably at least 200% and/or the second length is longer than the first length by less than 400%, preferably less than 350% and more preferably less than 300%.

The article carrier includes one or more stanchions for supporting either or both of the rear transverse end bar, or one of the rails, and preferably the stanchion is configured with a lower portion that secures to a vehicle (e.g., to a roof) using original equipment hardware provided on the vehicle frame, such as frame fastening devices, accessory fastening devices, weld nuts, a threaded opening and/or a threaded fastener that is exposed and visible to an observer located outside of the vehicle and within 3 meters of the hardware, and an upper portion that wraps partially or entirely around an outer end bar and/or outer rail surface, preferably only partially and exhibiting a c-shape.

The vehicle may also include one or more attachment devices in the bed or cargo region of the vehicle. The attachment devices can be attached to the upper surfaces of the bed walls of the cargo area, such as the upper walls and/or the inside walls that define the cargo area, and/or to the inside surface of the bed walls that face inwardly towards the cargo area.

By way of example, an article carrier such the article carrier illustrated and described in U.S. 63/786,788 filed on Apr. 10, 2025, the entirety of which is hereby incorporated by reference herein for all purposes, can be attached to the vehicle.

The frame disclosed herein may include one or more vehicle frame subassemblies. To more fully understand the present teachings, it is understood that the vehicle frame may have one or more characteristics of some combination of a body-on-frame, a skateboard, and a unibody. That is, the design philosophy of the vehicle frame, and accordingly the vehicle frame subassemblies, may be mixed, providing unique challenges in impact performance, which may not have heretofore been realized.

Some of the elements of the vehicle frame described herein are present in the vehicle in duplicate and are arranged generally symmetrically relative to the centerline of the vehicle. For example, a first blocker may be located on a left side of the vehicle and a second blocker may be located on a right side of the vehicle. Unless otherwise stated, any function, impact sequence, or otherwise referring to one of these duplicate elements are understood as being attributable to the other of these duplicate elements. In the context of the present teachings, a small-offset collision occurs on one side of the vehicle, but it is understood that if a small-offset collision occurred on the other side of the vehicle the duplicate elements would perform the same or at least substantially the same, given comparable impact conditions. So, where one duplicate element is referred to herein, it will be understood that the disclosure applies to both of the duplicate elements, unless otherwise stated.

As referred to herein, the centerline of the vehicle may extend from a front of the vehicle to the rear of the vehicle. The centerline may divide two halves of the vehicle, the left half and the right half. The centerline may define an axis of symmetry of the vehicle.

As referred to herein, unless otherwise stated, lateral may mean along an axis that is perpendicular to the centerline of the vehicle with respect to energy, forces, etc. Where lateral is referred to with respect to the geometry or configuration of any individual element of a vehicle frame subassembly, lateral may be relative to a longitudinal axis of said individual element. For example, an element having a longitudinal axis may have sub-elements extending laterally therefrom (e.g., perpendicularly or generally perpendicularly from said longitudinal axis).

Further aspects of the frame and/or subframe assemblies are illustrated and/or described in U.S. 63/786,920 filed on Apr. 10, 2025, the entirety of which is hereby incorporated by reference herein for all purposes.

The frame may be a frame assembly that includes a forward subassembly, a rearward subassembly, and an intermediate subassembly coupled with the forward subassembly and the rearward subassembly. The vehicle frame assembly is configured to support both a pickup truck configuration and a sport utility (SUV) configuration and allow reconfiguration between both.

The intermediate subassembly including a support for, preferably a chassis at least partially enclosing, comprising one or more batteries to supply power to one or more motors, the intermediate subassembly being supported by, on or with at least one of the forward subassembly and/or the rearward subassembly, the motors being adapted to propel the vehicle.

The forward subassembly including at least two spaced apart frame rails preferably longitudinally oriented toward the front of the vehicle, and optionally being configured to be detachably coupled with at least one collapsible cradle assembly, and also including a front region that is located proximate, and preferably over, a pair of front wheels of the vehicle. The rearward subassembly including at least two spaced apart frame rails preferably longitudinally oriented toward the rear of the vehicle, the at least two spaced apart frame rails including an open and hollow rear end, and also including rear region that is located proximate, and preferably over, a pair of rear wheels of the vehicle, the rear region having a pair of opposing bed walls and a rear floor, wherein frame comprises one or more preexisting fasteners;

To convert the vehicle from the pickup truck configuration to the SUV configuration, one or more components may be added to the frame. The one or more components may include, for example, a rear enclosure that is configured to cover or enclose the rear portion or cargo area of the pickup truck, a roll bar assembly comprising a hoop structure and one or more frame rails, one or more rear passenger seats in the rear portion or cargo area of the pickup truck, one or more interior panels, one or more electronic components or accessories, one or more air bags, one or more seat belts, one or more HVAC elements (e.g., ductwork, vents, and/or thermal systems for heating and/or cooling), a center console, or a combination thereof. The hoop structure may comprise an enclosed or annular structure that can be attached to the floor of the frame and to the side wall of the frame. The hoop structure includes pillars that become C-pillar of the vehicle. One or more rear passenger seats are attached to the hoop structure to convert the vehicle into the second vehicle configuration. It is also possible that the hoop structure is not fully enclosed (e.g., it may include a pair of upright spaced apart elements that define respective side pillars, and an upper cross bar); and/or it provides at the base of the upright spaced apart elements a structure configured for mounting vehicle seats thereto.

To convert the vehicle from the pickup truck configuration to the SUV configuration, one or more components of the pickup truck may be reused. Reusing one or more components for the conversion from the pickup truck configuration to the SUV configuration may include using all or a portion of the component. For example, when converting from the pickup truck configuration to the SUV configuration, one or more portions of the passenger cab or cockpit may be reused and moved to a different region of the SUV configuration. For example, a rear halo and backlight assembly may be removed from the pickup truck configuration and moved to a different region of the vehicle to make the SUV configuration. For example, one or more vehicle body panels (such as B-pillar claddings) may be removed from the pickup truck configuration and moved to a different region of the vehicle to make the SUV configuration. Re-using a component for the conversion may advantageously reduce waste and impact on the environment and reduce overall cost of reconfiguring the vehicle into the SUV configuration.

To convert the vehicle from the pickup truck configuration to the SUV configuration, one or more components of the pickup truck may be removed or separated and not reused. As an example, the rear bulkhead may be separated from the pickup truck configuration and not used in the SUV configuration.

To convert the vehicle from the pickup truck configuration to the SUV configuration, one or more components of the pickup truck may be removed and reconfigured for a different purpose or location. As an example, the rear bulkhead may be separated from the pickup truck configuration and used as a cargo divider in the SUV configuration.

The vehicle may have a length that is less than 200 inches, less than 190 inches, preferably less than 180 inches, and more preferably about 175 or 175.5 inches.

The vehicle may have a height that is less than 70 inches, preferably less than 68 inches, and more preferably about 67.8 inches.

The vehicle may include a wheel base of less than 120 inches, less than 115 includes, preferably less than 110 inches, and more preferably about 109 inches.

In the pickup configuration, the vehicle may have a passenger volume of less than about 60 cu ft, less than about 50 cu ft, preferably less than about 45 cu ft, or most preferably about 42 cu ft. In the SUV configuration, the vehicle may have less than about 100 cu ft, less than about 80 cu ft, preferably less than about 70 cu ft, or most preferably about 64 cu ft.

The curb weight of the vehicle may be less than about 4,000 lbs, preferably less than about 3750 lbs, or most preferably about 3602 lbs.

The frame may include one or more frame fastening devices. A frame fastening device may be a device that is used to attach or support one or more of the interior vehicle components and/or exterior vehicle components to the frame.

The one or more frame fastening devices may be provided on the frame by the original equipment manufacturer (OEM). In other words, the one or more frame fastening devices may be made available on the frame by the original equipment manufacturer (OEM) or dealer before the vehicle is put into service or acquired by a dealer or user. Frame fastening devices that are added by the OEM or original manufacturer of the rear enclosure assembly may be preexisting. For example, the vehicle frame may be provided with a plurality of fastener elements (e.g., weld nuts, self-clinching nuts, blind rivet nuts, rivets or other threaded inserts) located at predefined locations and configured to receive another fastener element for attaching vehicle components to the frame.

In some configurations, one or more frame fastening devices may be added by a user or dealer after the vehicle has left the original equipment manufacturer (OEM). Preferably, such later added frame fastening devices may be made in accordance with instructions from the OEM or aftermarket instructions. For example, the OEM may provide instructions or templates for adding one or more frame fastening devices to the vehicle frame for attaching or securing one or more vehicle components. Such frame fastening devices may therefore also be referred to herein as preexisting in the context of a preexisting intent by the OEM or manufacturer of the rear enclosure assembly to include the frame fastening devices in a specific location or orientation on the frame. Therefore, such preexisting fasteners are in contrast to frame fastening devices that are added to the frame by an end user in locations that are not expressly contemplated by the original vehicle manufacturer or original manufacturer of the rear enclosure assembly.

The one or more frame fastening devices may be or may include one or more male fastening elements and/or female fastening elements. For example, the one or more frame fastening devices may be, or may comprise, one or more bolts, screws, pegs, projections, clips, U-clips, C-clips, pins, posts, latches, clamps, hooks, quick connect fasteners, quarter turn fasteners, bores, slots, apertures, threaded bores or slots, weld nuts, self-clinching nuts, blind rivet nuts, rivets, flanges, or any combination thereof.

As discussed herein, the rear enclosure assembly may include the structure necessary to convert the vehicle from the pickup truck configuration to the SUV configuration. The rear enclosure assembly may be obtained from the original equipment manufacturer or from an aftermarket source. The rear enclosure assembly may be shipped to the user via standard residential shipping companies (e.g., FEDEX, UPS, USPS, etc.).

Preferably, the rear enclosure assembly need not be shipped to the user via a freight shipping service. The rear enclosure assembly may be shipped or packaged in one or more boxes or packages. The one or more boxes may be an elongated packing container or box. The one or more boxes or packages may be recyclable material like cardboard. In other configurations than one or more boxes or packages may be made from returnable plastic containers that can be returned back to the manufacturer after the rear enclosure assembly has been installed on the vehicle. The one or more boxes or packages may be used during the installation process. For example, the one or more boxes or packages can be adapted as an assembly aid during reconfiguration of the vehicle from the pickup truck configuration to the SUV configuration (or vice vera). For example, the one or more boxes may be configured into a workstation for a user to stage parts for adding to the vehicle and or for removing from the vehicle during the reconfiguration process. The one or more boxes or packages may be used as a stepping structure for the user to climb or step onto when installing or attaching certain components to the rear enclosure assembly or vehicle, such as the roof panel and or the side enclosure panels, and or the rear glass assembly. The one or more boxes or packages may be used to store certain components of the vehicle that are removed from the pickup truck configuration and are not reused for the SUV configuration. This may allow a user to safely and securely store the removed structure for a later time if the user decides to reconfigure the vehicle back to the original pickup truck configuration.

The one or more frame fastening devices may engage, cooperate, and/or co-act with other mating fastening devices to attach the one or more interior and/or exterior components of the frame. For example, the one or more frame fastening devices may engage, cooperate, and/or coact with one or more fastening devices disclosed herein including but not limited to the one or more: rear glass or window fastening devices, roof panel fastening devices, B-pillar panel fastening devices, halo and back light fastening devices, rear cab bulkhead fastening devices, hoop structure fastening devices, frame rail fastening devices, interior panel fastening devices, roll bar assembly fastening devices, interior panel fastening devices, rear side panel fastening devices, or any combination thereof.

In a non-limiting example, a frame fastening device may comprise a threaded bore or weld nut self-clinching nuts, blind rivet nuts, and a mating fastening device may comprise a bolt or other threaded fastener.

The vehicle disclosed herein may be powered by an electrified powertrain (e.g., the vehicle may be free of an internal combustion engine). The electrified powertrain may comprise one or more energy storage devices, such as one or more rechargeable batteries (e.g., lithium-ion, solid-state, or other electrochemical storage devices). The one or more batteries may be configured to supply electrical energy to one or more electric motors for propelling the vehicle. The one or more batteries may be charged via an external power source, such as by plugging the vehicle into a charging station or other electrical supply equipment, and/or via on-board energy recovery systems, such as regenerative braking or other kinetic energy recovery systems during vehicle operation. In some embodiments, the electrified powertrain may further include one or more power electronics modules (e.g., inverters, converters), thermal management systems, battery management systems, and associated control systems configured to manage energy distribution, efficiency, and performance.

In some configurations, the vehicle may be powered by other forms of propulsion, either alone or in combination with the electrified powertrain. For example, the vehicle may comprise a hybrid powertrain including both an internal combustion engine and one or more electric motors. The internal combustion engine may be configured to operate on gasoline, diesel, natural gas, hydrogen, biofuels, or other combustible fuels. In other configurations, the vehicle may be powered by a fuel cell system (e.g., a hydrogen fuel cell) configured to generate electrical energy for one or more electric motors. The propulsion system may be configured to selectively operate in different modes (e.g., electric-only mode, hybrid mode, engine-only mode) based on operating conditions, user inputs, or control strategies.

The vehicle may include a 1-pedal drive system.

The vehicle may comprise one or more regenerative brake systems.

The motor may be a 150 kW motor generating about 200 horsepower (preferably about 201 horsepower)

The front suspension may include a MacPherson Strut system.

The rear suspension may include a de Dion axle with coil springs. The front suspension may be free of leaf springs.

The powertrain may include one or more rear motors, front motors, middle motors, or a combination thereof. The motor may be or include a permanent-magnet synchronous with hairpin winding, combined water and oil cooling. The powertrain may include a 12.44 ratio single speed/open differential gearbox.

The one or more batteries may have a size or capacity of about 52.7 kWh or 84.3 kWh. The one or more batteries may be removable or serviceable. A vehicle owner may purchase a one battery (e.g., the 52.7 kWh battery and then replace it with a larger capacity battery (e.g. the 84.3 kWh battery). The one or more batteries may have a size or capacity of less than about 100 kWh, less than about 90 kWh, less than about 80 kWh, less than about 70 kWh, less than about 60 kWh.

The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise a motor, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

The vehicle may have an electrical wiring system (EWS). The EWS may extend throughout the vehicle and may include sockets for connecting one or more electrically powered accessories to the vehicle after the vehicle has been in service. The one or more sockets may be or may include one or more male and/or female mating components. The one or more sockets may include one or more interlocks for ensuring the connection is fixed or sturdy to prevent separation during vehicle operation. Having sockets throughout the vehicle may advantageously allow a user to use plug-and-play technology to power electrically powered accessories, without a need for damaging or destroying electrical wiring by splicing. For example, electrically powered accessories including but not limited to audio devices, seat heating devices, and/or seat cooling devices may be powered through connection to one or more sockets without splicing. The rear enclosure assembly may have electrical wiring with one or more sockets or connectors that are configured to plug into the EWS. This connection may provide electrical power to the SUV configuration to power components such as one or more airbags, power receptacle, audio devices, the rear brake light or center high mounted stop light (“CHIMSL”) after it is repositioned to the back of the vehicle, the rear window heater or defroster, or a combination thereof.

The vehicle may include one or more vehicle panels (e.g., exterior and/or interior panels). Preferably, the vehicle panels may be made of a polymeric material (e.g., a thermoset and/or thermoplastic), and preferably it is a thermoplastic such as a polyolefinic (e.g., it includes polypropylene), where the polypropylene may include fillers or additives (e.g., glass fibers, woven or unwoven carbon fiber, talc, flame retardant, other inorganic fibers and/or particles, etc.). Other possible polymeric materials include, without limitation, one or more polyurethanes polyesters, epoxy and/or vinyl esters, acrylonitrile butadiene styrene (ABS), polycarbonates, or any combination thereof with or without a filler (e.g. fibers and/or particulates).

Preferably, the one or more panels are made of a plastic of glass-filed injection molded components. Therefore, a paint shop may be avoided or not needed during assembly or manufacture of the vehicle.

The one or more vehicle panels may be made via a suitable manufacturing process such as injection molding, thermal forming, vacuum forming, 3D printing, reaction injection molding, compression molding, etc. One preferred approach is to employ vacuum forming. One or more of the vehicle panels may be coupled to the vehicle frame or inner support structure via one or more body panel fastening devices and/or frame fastening devices (e.g., bolts, screws, etc.) and without the use of adhesive to enable the vehicle panels to be easily removable and replaceable. Other vehicle panels may be coupled to the vehicle frame or inner support structure via one or more permanent fasteners, such as adhesives, which may prevent the one or more vehicle panels from being separated from the frame without mechanically destroying the frame and/or vehicle panel. Examples of such vehicle panels include of vehicle body panels may include one or more roof panels, a front hood panel, front fenders, door panels, rear fenders, a tailgate, front and rear bumper covers (fascia), B-pillar panels or appliques, a vehicle cab spoiler, a rear cab bulkhead panel, front grille, spoiler, bulkhead panel, or otherwise.

The one or more panels may be painted. The one or more panels may be at least partially or entirely covered by one or more wrap sheet elements (e.g., a decorative polymeric film that is provided as a continuous sheet or body that is then adhered to a panel with an adhesive). The one or more panels may include one or more wrap edge receiving channels into which one or more edges of a wrap sheet element are positioned. A wrap edge receiving channel may be defined by an upper wall, a lower wall, and a connecting wall extending therebetween. Exemplary wrap sheet elements and vehicle panels having one or more wrap edge receiving channels are illustrated and described in U.S. 63/786,768 filed on Apr. 10, 2025 and U.S. Ser. No. 29/997,602 filed on Apr. 8, 2025, the entireties of both are hereby incorporated by reference herein for all purposes.

A wrap edge receiving channel may be a channel, trench, trough, canal, gouge, indentation, gutter, recess, depression, or similar feature that is formed into a surface or thickness of the outer panel substrate of the vehicle panel. The channel may be formed into a surface or thickness of the vehicle panel such that the channel is integral with the panel.

Aa wrap edge receiving channel may be on an inside panel (interior of the vehicle) or an exterior panel (outside of the vehicle).

A wrap edge receiving channel may extend at least partially or entirely along a length or width of a panel. A wrap edge receiving channel may have a length that extends continuously along a length of width of a panel. A wrap edge receiving channel may have a length that is interrupted along a length of width of a panel. In other words, a wrap edge receiving channel may start and stop along a length of width of a panel. A wrap edge receiving channel may have a length that extends substantially across an entire length of the vehicle, for example from a location that is forward of or at the front wheels to a location that is rearward of or at the rear wheels. The wrap edge receiving channel may extend along a horizontal plane that intersects the vehicle at the front headlight assemblies. The wrap edge receiving channel may extend along an entire length or width of a panel with no gaps or spaces between the outer most edges of the panel and the beginning of the wrap edge receiving channel. The wrap edge receiving channel may extend at or along a top edge or region of a door handle.

A wrap edge receiving channel may separate a panel into two or more adjacent panel portions, such as a first panel portion and a second panel portion. Depending on the orientation of the panel and/or the wrap edge receiving channel in vehicle position, the first panel portion and the second panel portion may also or may instead be referred to as an upper panel portion and a lower panel portion, a left panel portion and a right panel portion, a forward panel portion and a rearward panel portion, etc., or any combination thereof.

A wrap edge receiving channel may be located at an upper region of a panel, a lower region of a panel, or in a central region of a panel. An upper region may be defined as a top ⅓ of the overall panel height or width below an upper most edge of the panel, a central region may be defined within a middle ⅓ of the overall height or width of a panel, and a lower region may be defined as or within a bottom ⅓ of the overall height or width of a panel below the lower most edge of the panel.

A wrap edge receiving channel may be defined by one or more walls. For example, a wrap edge receiving channel may be defined by a first wall, a second wall, and a connecting wall extending therebetween. Depending on the orientation of the channel in vehicle position, the first wall and the second wall may also or may instead be referred to herein as an upper wall and a lower wall, a left wall and a right wall, a forward wall and a rearward wall, etc., or any combination thereof.

The walls of the wrap edge receiving channel including the connecting wall may be substantially planar, curved, sloped, angled, horizontal, vertical, or a combination thereof. The walls of the wrap edge receiving channel including the connecting wall may have a wall component or region that is planar, curved, sloped, angled, horizontal, vertical, drafted, or a combination thereof.

The material thickness of the channel and the region of the panel surrounding the channel may be substantially uniform or constant. This means that the channels is not a thinned out region of the panel that may reduce the structural integrity of the panel. Instead, the channel may be molded or formed directly into the panel.

A wrap edge receiving channel may function to receive an edge of one or more wraps or wrap sheets. A wrap edge receiving channel may function to conceal an edge of one or more wraps or wrap sheets from view, when an observer is positioned inside the vehicle or outside of the vehicle. A wrap edge receiving channel may function to conceal or block an edge of one or more wraps or wrap sheets from outdoor conditions, such as sunlight, rain, car wash, salt spray, the like or a combination thereof. A wrap edge receiving channel may be an ornamental feature in the one or more vehicle panels that provides an ornamental or aesthetic appearance to the body panel. The wrap edge receiving channel may function to break up the entire surface of a body panel so that smaller sheets of wrap or wrap sheets can be used to cover the body panel. This may advantageously make it easier to handle a wrap or wrap sheet during application, as opposed to handling a very large wrap or wrap sheet to cover an entire body panel.

The material of the vehicle panels and the underlying structure to which it is attached may be selected to avoid substantial differences in coefficients of thermal expansion of the respective materials over a range of useful temperatures of the vehicle, to thereby help minimize warpage or other dimensional distortions following repeated thermal cycling.

Structures, steps, and/or functional features of one embodiment may be substituted for corresponding structures, steps, and/or functional features of another embodiment, unless the description herein indicate that they are mutually exclusive alternatives and/or such substitution would require a substantial modification of the non-substituted subject matter.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference in each of their entirety for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps. The term “consists essentially of” means excluding other elements that contribute in a material way to the recited function, unless otherwise defined herein; nonetheless, such other elements may be present, collectively or individually, provided that, in their absence, the recited function would otherwise be achieved.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Unless otherwise explicitly stated herein, reference to attachment and/or connection of two or more structures to one another contemplates both a direct and indirect connection; it being understood further that, unless otherwise explicitly stated herein, a “direct connection” or “direct attachment” also includes within its scope the inclusion of a thin element (e.g., an element with a maximum thickness at a location in contact with both joined structures of less than 10 millimeters, preferably less than 7 millimeters, and more preferably less than 3 millimeters) between the joined structures. Thus, unless explicitly stated, a direct connection between two elements may include the elements and an intermediate element, such as a seal, a washer, an adhesive layer, a primer layer, or the like.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

1. A vehicle reconfigurable between a pickup truck configuration and a sport utility vehicle (SUV) configuration, comprising:
a) a vehicle frame configured to support both the pickup truck configuration and the SUV configuration and to allow reconfiguration therebetween without permanently modifying the vehicle frame, the vehicle frame including:
a. at least two spaced-apart frame rails extending longitudinally toward a rear of the vehicle;
b. a rear region proximate a pair of rear wheels, the rear region including opposing bed walls and a rear floor; and
c. a plurality of preexisting frame fastening devices that are installed on the vehicle frame during original manufacture of the vehicle;
b) one or more batteries supported by or coupled to the vehicle frame and configured to provide power to one or more motors; and
c) a rear enclosure assembly for reconfiguring the vehicle from the pickup truck configuration to the SUV configuration without permanently modifying the vehicle frame, the rear enclosure assembly comprising:
a. a roll bar assembly comprising a hoop structure including a pair of spaced-apart pillars and a cross bar extending between and connecting the pair of spaced-apart pillars, wherein the pair of spaced-apart pillars are attached to the vehicle frame via one or more of the plurality of preexisting frame fastening devices;
b. a lower cross bar, wherein the lower cross bar is attached to the vehicle frame via one or more of the plurality of preexisting frame fastening devices; and
c. one or more rear passenger seats configured for attachment to the lower cross bar.

2. The vehicle of claim 1, wherein the plurality of preexisting frame fastening devices comprise threaded fasteners, weld nuts, threaded bores, or combinations thereof that are installed on the vehicle frame during original manufacture of the vehicle.

3. The vehicle of claim 2, wherein the rear enclosure assembly and the roll bar assembly is attachable to the vehicle frame without welding, bonding, cutting, drilling, or grinding the vehicle frame, and the rear enclosure assembly and the roll bar assembly is removable from the vehicle frame to return the vehicle to the pickup truck configuration without welding, bonding, cutting, drilling, or grinding the vehicle frame.

4. The vehicle of claim 1, wherein each of the pillars include:
a) a first attachment interface configured for attaching to at least one of the plurality of preexisting frame fastening devices located at or near a top surface of the bed walls; and
b) a second attachment interface configured for attaching to at least one of the plurality of preexisting frame fastening devices at the rear floor of the vehicle frame,
wherein the hoop structure transfers structural loads into both the bed walls and the rear floor of the vehicle frame.

5. The vehicle of claim 1, wherein each of the pillars include a lower region, an upper region, and a bend along an upright portion thereof between the lower region and the upper region such that each of the pillars extend outwardly as the pillars extend upwardly.

6. The vehicle of claim 5, wherein in vehicle position, the lower regions of the opposing pillars are spaced closer together than the upper regions of the opposing pillars.

7. The vehicle of claim 1, wherein the one or more rear passenger seats are coupled to the lower cross bar such that loads from the one or more rear passenger seats are transferred to the vehicle frame.

8. The vehicle of claim 7, wherein the rear enclosure assembly comprises a replacement floor panel that is exchanged with an existing floor panel during the reconfiguration from the pickup truck configuration to the SUV configuration, wherein the replacement floor panel comprises a raised portion that extends partially or entirely across a width of the replacement floor panel and is configured to elevate a front portion of the one or more rear passenger seats at a predetermined angle relative to the floor panel and/or vehicle frame.

9. The vehicle of claim 1, wherein the roll bar assembly further comprises a pair of longitudinal rails extending between a forward attachment location of the vehicle frame adjacent a B-pillar region of the vehicle frame and a rear attachment location at at least one of the bed walls, wherein each attachment location utilizes at least one of the plurality of preexisting frame fastening devices.

10. The vehicle of claim 9, wherein the rear attachment location comprises a pocket in the vehicle frame configured to receive a rear end of a respective longitudinal rail.

11. The vehicle of claim 10, wherein the forward attachment location comprises a bracket attached to the B-pillar of the vehicle frame configured to attach to a forward end of a respective longitudinal rail.

12. The vehicle of claim 11, wherein a middle region of each of the longitudinal rails is attached to the cross bar of the hoop structure such that loads are distributed between the longitudinal rails and the hoop structure.

13. A method of reconfiguring the vehicle of claim 1 from the pickup truck configuration to the SUV configuration, the method comprising:
a) removing one or more components associated with the pickup truck configuration to expose at least a portion of the vehicle frame;
b) positioning the roll bar assembly relative to the vehicle frame;
c) attaching the roll bar assembly to at least one of the plurality of preexisting frame fastening devices without permanently modifying the vehicle frame;
d) installing the one or more rear passenger seats in structural association with the vehicle frame;
e) attaching the rear enclosure assembly to at least one of the roll bar assembly and the vehicle frame using the plurality of preexisting frame fastening devices; and
f) enclosing a rear passenger area of the vehicle with one or more panels of the rear enclosure assembly,
wherein the roll bar assembly and the one or more rear passenger seats are installed such that seat loads from the one or more rear passenger seats are transferred to the vehicle frame via the plurality of preexisting frame fastening devices, and
wherein the rear enclosure assembly and the roll bar assembly is attachable to the vehicle frame without welding, bonding, cutting, drilling, or grinding the vehicle frame, and the rear enclosure assembly and the roll bar assembly is removable from the vehicle frame to return the vehicle to the pickup truck configuration without welding, bonding, cutting, drilling, or grinding the vehicle frame.

14. The method of claim 13, wherein attaching the roll bar assembly comprises engaging threaded fasteners with factory-installed threaded apertures of the vehicle frame.

15. The method of claim 13, wherein installing the one or more rear passenger seats comprises coupling seat brackets directly to a lower cross bar of the roll bar assembly.

16. The method of claim 13, further comprising attaching one or more longitudinal rails to the vehicle frame and the hoop structure.

17. The method of claim 16, wherein attaching the rear enclosure assembly comprises securing one or more rear side panels and a roof panel to the roll bar assembly.

18. The method of claim 13, further comprising replacing a front floor panel.

19. The method of claim 18, wherein the floor panel comprises a raised structure configured to support a portion of the rear vehicle seat assembly to inhibit forward sliding of an occupant.

20. A kit for converting a vehicle having a frame with one or more preexisting frame fastening devices from a first configuration to a second configuration, the kit comprising:
a) a roll bar assembly comprising a pair of spaced-apart pillars and at least one cross bar extending between the pillars;
b) a rear enclosure assembly comprising one or more panels configured to at least partially enclose a rear passenger area;
c) one or more mounting interfaces coupled to at least one of the roll bar assembly or the rear enclosure assembly, the one or more mounting interfaces being configured to engage the one or more preexisting frame fastening devices; and
d) one or more rear passenger seats configured to be mounted to the frame;
wherein the kit is configured such that, when installed on the vehicle:
i) the roll bar assembly and the rear enclosure assembly are secured to the frame using the one or more preexisting frame fastening devices without permanently modifying the frame; and
ii) seat loads from the one or more rear passenger seats are transferred to the frame via the one or more preexisting frame fastening devices, and
wherein the rear enclosure assembly and the roll bar assembly is attachable to the vehicle frame without welding, bonding, cutting, drilling, or grinding the vehicle frame, and the rear enclosure assembly and the roll bar assembly is removable from the vehicle frame to return the vehicle to the first configuration without welding, bonding, cutting, drilling, or grinding the vehicle frame.
